(19) United States
(12) Patent Application Publication
(10) Pub. No.: US 2018/0118590 A1
(43) Pub. Date: May 3, 2018

(54) OXIDATION METHOD

(71) Applicant: AUCKLAND UNISERVICES LIMITED, Auckland (NZ)

(72) Inventor: Leonard James WRIGHT, Auckland (NZ)

(73) Assignee: AUCKLAND UNISERVICES LIMITED, Auckland (NZ)

(21) Appl. No.: 15/568,689

(22) PCT Filed: Apr. 22, 2016
(86) PCT No.: PCT/NZ2016/050066

§ 371 Date: Oct. 23, 2017

(30) Foreign Application Priority Data
Apr. 24, 2015 (NZ) 707392

(51) Int. Cl. C02F 1/72; B01J 31/18

(52) U.S. Cl. CPC C02F 1/725; C02F 2101/305; B01J 31/1805

(57) ABSTRACT

Disclosed is a method of oxidizing a substrate comprising contacting the substrate, an oxidant, and a solid phase comprising a plurality of pendant groups having affinity for a substrate to be oxidised and an oxidation catalyst. Also disclosed is a solid phase and membrane for use in the method. Also disclosed is a method for preparing the solid phase, and system for oxidizing a substrate.

### FIELD OF THE INVENTION

The present invention relates to a method of oxidizing a substrate comprising contacting the substrate, an oxidant, and a solid phase comprising a plurality of pendant groups having affinity for a substrate to be oxidised and an oxidation catalyst, and to a solid phase and membrane for use in the method. The present invention also relates to a method for preparing the solid phase, and system for oxidizing a substrate.

### BACKGROUND TO THE INVENTION

Water streams including source water for water treatment plants, industrial waste streams and municipal wastewater is frequently contaminated with undesirable compounds such as endocrine disruptors, pesticides and pharmaceuticals.

Many of these compounds are known to have detrimental effects on aquatic species, even at sub-nanogram concentrations. Some compounds have been reported to interfere with human and animal hormone systems resulting in adverse developmental and reproductive effects, causing concern among regulatory agencies and the public.

One method for remediating source water or waste streams is oxidation of undesirable compounds. Oxidation catalysts can be used to catalyse oxidation of a substrate in the presence of an oxidant. However, the ongoing replenishment of the oxidation catalyst and oxidant required for large scale oxidation reactions can be costly. Furthermore, the oxidative catalyst and oxidant may contaminate the remediated water stream.

For oxidation targets present at dilute or very dilute concentrations, high concentrations of catalyst and oxidant may be required to achieve a satisfactory rate of reaction.

Similar issues exist for other applications requiring oxidation reactions, such as the production of food grade products or pharmaceutical intermediates.

There is a need for a method for oxidising a substrate that ameliorates and/or overcomes one or more of these problems. It is an object of the present invention to go some way to meeting this need and/or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect, the present invention relates to a method of oxidising a substrate, the method comprising:
(i) providing a substrate to be oxidised,
(ii) providing an oxidant, and
(iii) providing a solid phase comprising a plurality of pendant groups having affinity for the substrate, and an oxidation catalyst, and
(iv) contacting the substrate to be oxidised, the oxidant, and the solid phase to oxidize the substrate.

In a second aspect, the present invention relates to a solid phase comprising a plurality of pendant groups having affinity for a substrate to be oxidised, and an oxidation catalyst.

In a third aspect, the present invention relates to a membrane comprising a plurality of pendant groups having affinity for a substrate to be oxidised, and an oxidation catalyst.

In a fourth aspect, the present invention relates to the use of a solid phase comprising a plurality of pendant groups having affinity for a substrate to be oxidised, and an oxidation catalyst, or a membrane comprising a plurality of pendant groups having affinity for a substrate to be oxidised, and an oxidation catalyst for oxidising the substrate.

In a fifth aspect, the present invention relates to a composition comprising an oxidised substrate produced by a method of the present invention.

In a sixth aspect, the present invention relates to a method for preparing a solid phase comprising a plurality of pendant groups having affinity for the substrate, and an oxidation catalyst, the method comprising:
(i) providing a solid phase comprising a plurality of pendant groups having affinity for an oxidisable substrate, and an oxidation catalyst, and
(ii) immobilizing a catalyst on the solid phase.

In seventh aspect, the present invention relates to a system for oxidizing a substrate, the system comprising:
(i) a source of a substrate to be oxidised,
(ii) a source of an oxidant, and
(iii) a solid phase comprising a plurality of pendant groups having affinity for the substrate, and an oxidation catalyst.

The following embodiments and preferences may relate alone or in any combination of any two or more to any of the above aspects.

In various embodiments, the solid phase is a film, membrane, plurality of particles, or body. In preferred embodiments, the solid phase is a film or membrane. In preferred embodiments, the solid phase is a membrane.

In various embodiments, the solid-phase comprises a polymer. In various embodiments, the polymer comprises an inorganic or organic polymer. In various embodiments of the polymer comprises an organic polymer.

In various embodiments, the solid phase is a membrane permeable to the oxidant.

In various embodiments, the membrane separates a source of the oxidant from the substrate to be oxidised.

In various embodiments, the substrate is oxidised by the oxidation catalyst to form a reduced catalyst and the reduced catalyst is oxidised by the oxidant. In various embodiments, the reduced catalyst is oxidised by oxidant that passes through the membrane.

In various embodiments, pressure is applied to cause oxidant to pass through the membrane.

In various embodiments, the affinity of the pendant groups for the substrate to be oxidised is such that the substrate is concentrated at the solid phase.

In various embodiments, the substrate is provided in the form of a solution and the substrate has a greater affinity for the pendant groups than for the other components of solution, such as a solvent or combination of solvents of the composition.

In various embodiments, one or more of the pendant groups define a first zone or zones adjacent a surface of the solid-phase for concentrating the substrate, wherein the first zone or zones comprise at least a portion of the one or more pendant groups.

In various embodiments, the plurality of pendant groups coats a surface of the solid-phase. In various embodiments, the coating defines a first zone or zones. In various embodiments, the substrate is concentrated at or within the coating.

In various embodiments, the substrate to be oxidised is concentrated at or on one or more pendant groups.

In various embodiments, the substrate is oxidised at or on one or more pendant groups.

In various embodiments, the pendant groups have less affinity for a substrate that has been oxidised than the corresponding substrate to be oxidised.

In various embodiments, substrate that has been oxidised diffuses away from the solid-phase.

In various embodiments, the catalyst is immobilised on a pendant group (that is, the catalyst is immobilised on at least one pendant group). In various embodiments, the catalyst is immobilised on two or more pendant groups.

In various embodiments, the catalyst is immobilised at the proximal end, distal end, or along the length of one or more pendant groups, preferably at the proximal end of one or more pendant groups.

In various embodiments, the catalyst is immobilised on a surface of the solid-phase.

In various embodiments, the catalyst is immobilised between a surface of the solid-phase and a first zone or zones, or within or on a first zone or zones. In various embodiments, the catalyst is immobilised between a surface of the solid-phase and a first zone or zones, or within a first zone or zones.

In various embodiments, the pendant groups are covalently attached to the solid-phase. In various embodiments, the pendant groups are covalently attached to a surface of the solid-phase.

In various embodiments the pendant groups are attached to particles on or in the solid-phase. In some embodiments, the particles are deposited on or embedded, for example partially embedded, in the solid-phase such that a surface of the solid-phase comprises a plurality of pendant groups.

In various embodiments, the particles comprising the pendant groups comprise an inorganic material.

In various embodiments, a surface of the particles is functionalised with the pendant groups.

In various embodiments, the particles comprise a plurality of reactive functional groups to which the pendant groups are attached.

In various embodiments, the particles comprise a plurality of hydroxyl groups.

In various embodiments, the pendant groups are covalently or non-covalently, for example supra-molecularly, attached to the particles.

In various embodiments, the particles comprise titania, silica, alumina, iron oxide (for example Fe₃O₄), or zirconium dioxide. In various embodiments, the particles comprise titania, silica, or alumina.

In various embodiments, the particles have an average diameter from about 0.5 to 1000 nm, 1 to 500 nm, or 1 to 100 nm.

In various embodiments, the particles are nanoparticles.

In various embodiments, a particle on the solid phase comprises one or more functional groups capable of immobilizing the catalyst.

In various embodiments, a surface of the solid-phase or a pendant group comprises one or more functional groups capable of immobilizing the catalyst. Preferably, the catalyst is immobilised by the one or more functional groups.

In various embodiments, the one or more functional groups define a second zone or zones adjacent a surface of the solid-phase for immobilizing the catalyst. In various embodiments, the second zone comprises the one or more functional groups and optionally a portion of one or more pendant groups. Preferably, the second zone comprises catalyst immobilised by the one or more functional groups.

In various embodiments, the first zone or zones has a different polarity to the second zone or zones.

In various embodiments, the first zone or zones is less hydrophilic than the second zone or zones. In various embodiments, the second zone or zones is less hydrophilic than the first zone or zones.

In various embodiments, the first zone or zones is more hydrophobic than the second zone or zones. In various embodiments, the second zone or zones is more hydrophobic than the first zone or zones.

In certain preferred embodiments, the first zone or zones is more hydrophobic than the second zone or zones and/or the second zone or zones is more hydrophilic than the first zone or zones.

In certain preferred embodiments, a second zone is disposed between a surface of the solid phase and a first zone.

In various embodiments, the pendant groups are attached to the solid phase via one or more functional groups capable of immobilizing the catalyst.

In various embodiments, the pendant groups are attached to particles on or in the solid phase via one or more functional groups capable of immobilizing the catalyst.

In various embodiments, the oxidation catalyst is organic, inorganic or organometallic. In various embodiments, the catalyst is a coordination complex.

In various embodiments, the oxidation catalyst is molecular, macromolecular, supramolecular, metallic, elemental, or polymeric.

In various embodiments, the catalyst comprises a metal or metal ion.

In various embodiments, the catalyst comprises a macromolecular metal complex, a metal oxide or mixed metal oxide, metal chalcogenide or mixed metal chalcogenide, preferably a metal sulfide or mixed metal sulfide, or a metal pnictogenide or mixed metal pnictogenide, preferably a metal nitride or mixed metal nitride or metal phosphide or mixed metal phosphide. In certain preferred embodiments, the catalyst comprises a macromolecular metal complex, or a metal oxide or mixed metal oxide.

In certain preferred embodiments, the metal oxide or mixed metal oxide is an oxometallate or polyoxometalate (POM).

In various embodiments, the metal oxide or mixed metal oxide is molybdate, tungstate, or a polyoxometalate. In various embodiments, the metal oxide or mixed metal oxide is molybdate, tungstate, vanadate, or a polyoxometalate.

In various embodiments, the polyoxometalate is tungstosilicic acid.

In various embodiments, the oxometallate or polyoxometalate comprises a molybdate, tungstate or vanadate. In certain preferred embodiments, the oxometallate or polyoxometalate comprises a molybdate or tungstate. In certain preferred embodiments, macromolecular metal complex comprises a tetradentate macrocyclic ligand and a transition metal.

In certain particularly preferred embodiments, the complex is an iron-tetraamido macrocyclic ligand (TAML) complex.

In one embodiment the complex comprises a compound of Formula (IA)

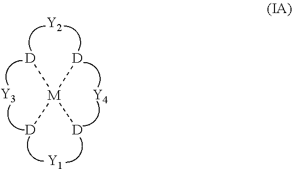

wherein
   M is a transition metal,
   each hashed line represents a coordination bond between D and M,
   each D is independently selected from the group consisting of O, N, and NX, wherein X is selected from the group consisting of alkyl, alkenyl, alkynyl, aryl, alkoxy, phenoxy, halogen, haloalkyl, haloalkenyl, haloalkynyl, haloaryl, cycloalkyl, cycloalkenyl, and a saturated or unsaturated heterocyclic ring, and
   Y₁, Y₂, Y₃, and Y₄ are each independently selected from

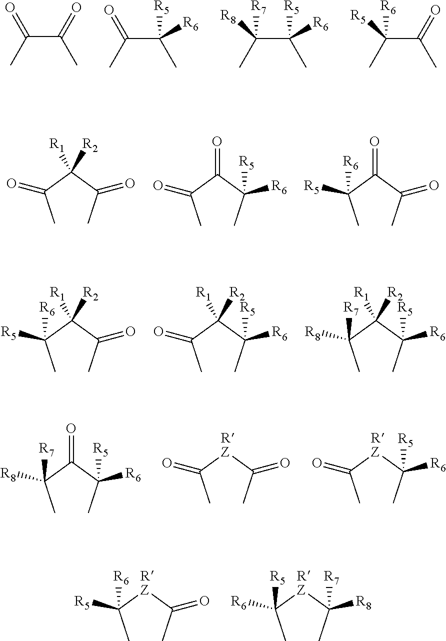

wherein
   Z is selected from the group consisting of N, P, and As;
   R′ is selected from the group consisting of hydrogen, alkyl, alkenyl, alkynyl, aryl, alkoxy, phenoxy, halogen, haloalkyl, haloalkenyl, haloalkynyl, haloaryl, cycloalkyl, cycloalkenyl, and a saturated or unsaturated heterocyclic ring,
   R₅, R₆, R₇, and R₈
      (i) are independently selected from the group consisting of alkyl, aryl, halogen, haloalkyl, haloaryl, cycloalkyl, cycloalkenyl, alkynyl, alkylaryl, alkoxy, phenoxy, oxylic, or
      (ii) together with an R substituent on an adjacent carbon in the same Y unit, form a mono-, di-, tri-, or tetra-substituted or unsubstituted benzene ring of which two carbons in the ring are adjacent carbons in the same Y unit, or
      (iii) together with an R substituent bound to the same carbon atom form a cycloalkylene or cycloalkenylene ring, and
   R₁ and R₂ are the same or different, linked or unlinked, unreactive, form a strong intramolecular bond with the carbon of the Y unit to which each is bound, are sterically hindered, and are conformationally hindered, such that oxidative degradation of the complex is restricted when the complex is in the presence of an oxidizing medium, or
   R₁ and R₂ together with an R substituent on an adjacent carbon in the same Y unit, form a mono-, di-, tri- or tetra-substituted or unsubstituted benzene ring of which two carbons in the ring are adjacent carbons in the same Y unit,
or a tautomer, salt, or solvate thereof.

Preferably, D is N.

Preferably, R₁ and R₂ are each independently selected from the group consisting of hydrogen, alkyl, alkenyl, alkynyl, aryl, alkylaryl, arylalkyl, alkoxy, phenoxy, halogen, haloalkyl, haloalkenyl, haloalkynyl, haloaryl, cycloalkyl, cycloalkenyl, and a saturated or unsaturated heterocyclic ring, or R₁ and R₂ together with the carbon atom to which they are attached form a cycloalkylene or cycloalkenylene ring.

In one embodiment the complex comprises a compound of Formula (IIA)

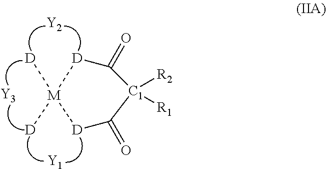

wherein
   M is a transition metal,
   each hashed line represents a coordination bond between D and M,
   each D is N,
   R₁ and R₂ are the same or different, linked or unlinked, unreactive, form a strong intramolecular bond with the carbon C₁ to which each is bound, are sterically hindered, and are conformationally hindered, such that oxidative degradation of a metal complex of the compound is restricted when the complex is in the presence of an oxidizing medium, and
   Y₁, Y₂, and Y₃ are as defined above,
or a tautomer, salt, or solvate thereof.

Preferably, R₁ and R₂ are each independently selected from the group consisting of hydrogen, alkyl, alkenyl, alkynyl, aryl, alkylaryl, arylalkyl, alkoxy, phenoxy, halogen, haloalkyl, haloalkenyl, haloalkynyl, haloaryl, cycloalkyl, cycloalkenyl, and a saturated or unsaturated heterocyclic ring, or R₁ and R₂ together with the carbon atom to which they are attached form a cycloalkylene or cycloalkenylene ring.

In one embodiment the complex comprises a compound of Formula (IIIA)

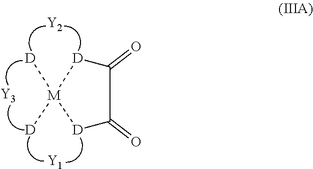

wherein
   M is a transition metal,
   each hashed line represents a coordination bond between D and M,
   each D is N, and
   Y₁, Y₂, and Y₃ are as defined above,
or a tautomer, salt, or solvate thereof.

In another embodiment the complex comprises a compound of Formula (IVA) or (VA)

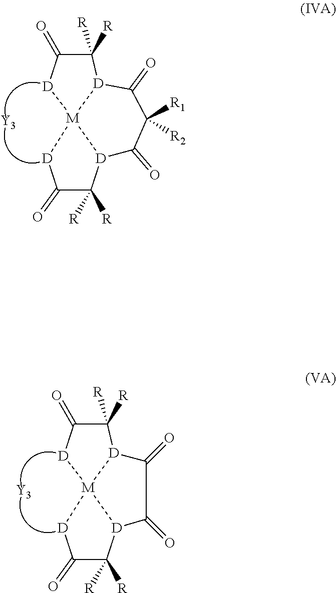

wherein
   M is a transition metal,
   each hashed line represents a coordination bond between D and M,
   each D is N,
   Y₃ is as defined above,
   each R is independently selected from the group consisting of hydrogen, alkyl, alkenyl, alkynyl, aryl, alkylaryl, arylalkyl, alkoxy, phenoxy, halogen, haloalkyl, haloalkenyl, haloalkynyl, haloaryl, cycloalkyl, cycloalkenyl, and a saturated or unsaturated heterocyclic ring, or
   each R together with the carbon atom to which it is attached and the other R bound to the same carbon form a cycloalkylene or cycloalkenylene ring, and
   R₁ and R₂ are each independently selected from the group consisting of hydrogen, alkyl, alkenyl, alkynyl, aryl, alkylaryl, arylalkyl, alkoxy, phenoxy, halogen, haloalkyl, haloalkenyl, haloalkynyl, haloaryl, cycloalkyl, cycloalkenyl, and a saturated or unsaturated heterocyclic ring, or
   R₁ and R₂ together with the carbon atom to which they are attached form a cycloalkylene or cycloalkenylene ring,
or a tautomer, salt, or solvate thereof.

Preferably, R₁ and R₂ are each independently selected from the group consisting of alkyl, halogen, haloalkyl, and cycloalkyl, or R₁ and R₂ together with the carbon atom to which they are attached form a cycloalkylene ring. More preferably, R₁ and R₂ are independently selected from the group consisting of methyl, ethyl, and fluoro, or R₁ and R₂ together with the carbon atom to which they are attached form a cyclopropylene or cyclobutylene ring.

Preferably, R at each instance is selected from the group consisting of alkyl, haloalkyl, and cycloalkyl. More preferably, R at each instance is alkyl. More preferably, R at each instance is methyl.

In another embodiment the complex comprises a compound of Formula (VIA)

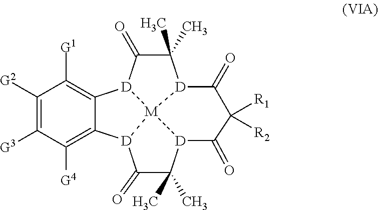

wherein
   M is a transition metal,
   each hashed line represents a coordination bond between D and M,
   each D is N,
   G¹, G², G³, and G⁴ are each independently selected from the group consisting of hydrogen, halogen, alkyl, cycloalkyl, alkenyl, cycloalkenyl, alkynyl, aryl, alkylaryl, arylalkyl, amino, amido, acylamino, nitro, alkoxy, cycloalkoxy, alkenyloxy, cycloalkenyloxy, aryloxy, acyl, acyloxy, and carboxy, or
   two or more of G¹, G², G³, and G⁴, together with the carbon atoms to which they are attached, form a cycloalkylene or cycloalkenylene ring, which may contain at least one atom that is not carbon, and
   R₁ and R₂ are as defined above,
or a tautomer, salt, or solvate thereof.

Preferably, G¹, G², G³, and G⁴ are each independently selected from the group consisting of hydrogen, alkyl, halogen, amino, amido, acylamino, nitro, alkoxy, and carboxy.

In one preferred embodiment G¹ and G⁴ are hydrogen and G² and G³ are each independently selected from the group consisting of hydrogen, bromine, amino, nitro, alkylcarboxy, and —CO₂H.

In another preferred embodiment G¹ and G⁴ are hydrogen and G² and G³ are alkyl; preferably methyl.

In another preferred embodiment G¹, G³, and G⁴ are hydrogen and G² is alkyl; preferably methyl.

In another preferred embodiment G¹ and G⁴ are hydrogen and G² and G³ are alkoxy; preferably methoxy.

In another preferred embodiment G¹, G³, and G⁴ are hydrogen and G² is nitro.

In another preferred embodiment G¹, G³, and G⁴ are hydrogen and G² is carboxy; preferably alkylcarboxy; more preferably methylcarboxy.

In another preferred embodiment G¹, G³, and G⁴ are hydrogen and G² is carboxy; preferably —CO₂H.

In another preferred embodiment G¹, G³, and G⁴ are hydrogen and G² is amido; preferably -(═O)NH(alkyl); more preferably —C(═O)NH(CH₂)₂NMe₃⁺.

In another preferred embodiment G¹ and G⁴ are hydrogen and G² and G³ are halogen; preferably chlorine.

Preferably, R₁ and R₂ are independently selected from the group consisting of alkyl, halogen, haloalkyl, and cycloalkyl, or R₁ and R₂ together with the carbon atom to which they are attached form a cycloalkylene ring. More preferably, R₁ and R₂ are independently selected from the group consisting of methyl, ethyl, and fluoro, or R₁ and R₂ together with the carbon atom to which they are attached form a cyclopropylene or cyclobutylene ring.

In another embodiment the complex comprises a compound of Formula (VIIA)

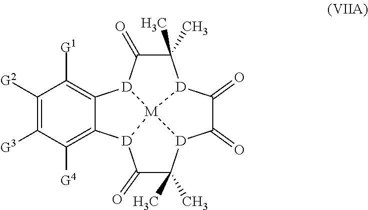

wherein
   each D is N, and
   G¹, G², G³, and G⁴ are each independently selected from the group consisting of hydrogen, halogen, alkyl, cycloalkyl, alkenyl, cycloalkenyl, alkynyl, aryl, alkylaryl, arylalkyl, amino, amido, acylamino, nitro, alkoxy, cycloalkoxy, alkenyloxy, cycloalkenyloxy, aryloxy, acyl, acyloxy, and carboxy, or
   two or more of G¹, G², G³, and G⁴, together with the carbon atoms to which they are attached, form a cycloalkylene or cycloalkenylene ring, which may contain at least one atom that is not carbon,
or a tautomer, salt, or solvate thereof.

Preferably, G¹, G², G³, and G⁴ are each independently selected from the group consisting of hydrogen, alkyl, halogen, amino, nitro, and carboxy. More preferably, G¹, G², G³, and G⁴ are each independently selected from the group consisting of hydrogen, methyl, bromine, —NH₂, nitro, alkylcarboxy, and —CO₂H.

Preferably, G¹ and G⁴ are hydrogen and G² and G³ are each independently selected from the group consisting of hydrogen, alkyl, halogen, amino, nitro, and carboxy. Preferably, G² and G³ are each independently selected from the group consisting of hydrogen, methyl, bromine, —NH₂, nitro, alkylcarboxy, and —CO₂H.

In one preferred embodiment G¹, G², G³, and G⁴ are hydrogen.

In another preferred embodiment G¹ and G⁴ are hydrogen and G² and G³ are bromine.

In another preferred embodiment G¹, G³, and G⁴ are hydrogen and G² is nitro.

In another preferred embodiment G¹, G³, and G⁴ are hydrogen and G² is amino; preferably —NH₂.

In another preferred embodiment G¹ and G⁴ are hydrogen and G² and G³ are alkyl; preferably methyl.

In another preferred embodiment G¹, G³, and G⁴ are hydrogen and G² is carboxy; preferably alkylcarboxy; more preferably methylcarboxy.

In another preferred embodiment G¹, G³, and G⁴ are hydrogen and G² is carboxy; preferably —CO₂H.

In another embodiment the complex comprises a compound of Formula (VIIIA).

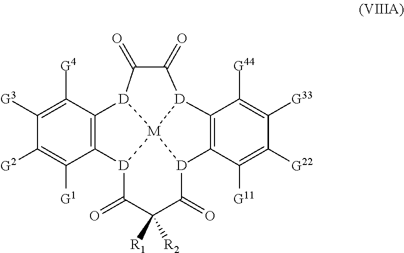

wherein
   M is a transition metal,
   each hashed line represents a coordination bond between D and M,
   each D is N,
   G¹, G², G³, G⁴, G¹¹, G²², G³³, and G⁴⁴ are each independently selected from the group consisting of hydrogen, halogen, alkyl, cycloalkyl, alkenyl, cycloalkenyl, alkynyl, aryl, alkylaryl, arylalkyl, amino, acylamino, amido, nitro, alkoxy, cycloalkoxy, alkenyloxy, cycloalkenyloxy, aryloxy, acyl, acyloxy, and carboxy, or
   two or more of G¹, G², G³, and G⁴, together with the carbon atoms to which they are attached, form a cycloalkylene or cycloalkenylene ring, which may contain at least one atom that is not carbon, or
   two or more of G¹, G²², G³³, and G⁴⁴, together with the carbon atoms to which they are attached, form a cycloalkylene or cycloalkenylene ring, which may contain at least one atom that is not carbon, and
   R₁ and R₂ are as defined above,
or a tautomer, salt, or solvate thereof.

Preferably, G¹, G², G³, G⁴, G¹¹, G²², G³³, and G⁴⁴ are each independently selected from the group consisting of hydrogen, alkyl, halogen, amino, amido, acylamino, nitro, alkoxy, and carboxy.

In one preferred embodiment G¹, G², G³, G⁴, G¹¹, G²², G³³, and G⁴⁴ are each hydrogen.

In another preferred embodiment G¹, G², G⁴, G¹, G²², and G⁴⁴ are each hydrogen and G³ and G³³ are each nitro.

Preferably, R₁ and R₂ are independently selected from the group consisting of alkyl, halogen, haloalkyl, and cycloalkyl, or R₁ and R₂ together with the carbon atom to which they are attached form a cycloalkylene ring. More preferably, R₁ and R₂ are independently selected from the group consisting of methyl, ethyl, and fluoro, or R₁ and R₂ together with the carbon atom to which they are attached form a cyclopropylene or cyclobutylene ring.

In one embodiment the transition metal is selected from the transition metals in groups 3 to 12 of the periodic table.

In another embodiment the transition metal is selected from the transition metals in groups 6 to 11 of the periodic table.

In another embodiment the transition metal is selected from the first transition metal series.

Preferably, the transition metal is chromium, manganese, cobalt, nickel, copper, or iron. More preferably, the transition metal is iron, cobalt, or manganese. Even more preferably, the transition metal is iron or cobalt. Even more preferably, the transition metal is iron.

In various embodiments, the catalyst is immobilised on the solid phase, for example covalently or non-covalently.

In various preferred embodiments, the catalyst is non-covalently immobilised. In various preferred embodiments, the catalyst is immobilised by supramolecular bonding interactions.

Preferably, the catalyst is immobilised by one or more functional groups capable of immobilizing the catalyst. Such functional groups may be referred to herein as immobilizing functional groups.

In various embodiments, the functional group capable of immobilizing the catalyst is a non-polar, polar or ionic group.

In various preferred embodiments, the functional group capable of immobilizing the catalyst is a polar or ionic group, preferably an ionic group. In various embodiments, the functional group is a cationic group.

In various embodiments, the functional group is a cationic group and the catalyst is anionic or the functional group is anionic and the catalyst is cationic.

In various embodiments, the functional group is a polar or ionic group comprising at least one oxygen, nitrogen, sulfur, phosphorus, boron, or halogen atom.

In various embodiments, the functional group is a polar or ionic group selected from a quaternary ammonium, organohalide, tetraorganoborate, phosphate, phosphonate, sulfonate, or thioether, a tetraorganophosphonium ion, or carboxy group. Preferably, the functional group is a polar or ionic group selected from a quaternary ammonium, phosphate, sulfonate, tetraorganophosphonium ion, or carboxy group, preferably a quaternary ammonium, phosphate, sulfonate, or carboxy group. Preferably, the functional group is a quaternary ammonium or tetraorganophosphonium group. Preferably, the functional group is a quaternary ammonium group.

Preferably, the one or more polar or ionic immobilizing functional groups are selected from the group comprising halogen, organohalo, —CN, —NC, —CNO, —NCO, —OCN, —CNS, —NCS, —SCN, —NCNR¹, —BR¹R², —NR¹R², —OR¹, —SiR¹R²R³, —PR¹R², —SR¹, —BR¹R²R³⁺X⁻, —NR¹R²R³⁺X⁻, —PR¹R²R³⁺X⁻, —SR¹R²⁺X⁻, —C(═BR¹)R², —N═BR¹, —P═BR¹, —B═CR¹R², —N═CR¹R², —Si(═CR¹R²)R³, —P═CR¹R², —B═NR¹, —C(═NR¹)R², —N═NR¹, —P═NR¹, —B═O, —C(═O)R¹, —N═O, —NO₂, —N(═O)R¹R², —P═O, —P(═O)R¹R², —S(═O)R¹, —S(═O)₂R¹, —C(═SiR¹R²)R³, —Si(═SiR¹R²)R³, —B═PR¹, —C(═PR¹)R², —N═PR¹, —P═PR¹, —B═S, —C(═S)R¹, —N═S, —P═S, and —P(═S)R¹R²; wherein R¹, R², and R³ at each instance are independently selected from the group consisting of hydrogen, alkyl, alkenyl, alkynyl, cycloalkyl, cycloalkenyl, aryl, heterocyclyl, heteroaryl, hydroxyl, alkoxy, cycloalkoxy, alkenyloxy, cycloalkenyloxy, aryloxy, heterocyclyloxy, heteroaryloxy, thiol, sulfenyl, amino, acyl, acyloxy, and carboxy; or any two of R¹, R², and R³, together with the atom to which they are attached form cycloalkyl, cycloalkylene, cycloalkenyl, cycloalkenylene, aryl, arylene, heterocyclyl, heterocyclylene, heteroaryl, or heteroarylene ring; and X⁻ is a suitable anion; or a salt thereof.

In various embodiments, the functional group is a cationic functional group, preferably a quaternary ammonium functional group, and the catalyst comprises an anionic macromolecular metal complex or metal oxide, preferably a transition metal-tetraamido macrocyclic ligand (TAML) complex, preferable an iron-TAML complex, or a metal oxide, preferably tungstate or molybdate.

In various embodiments, the pendant groups comprise a linear sequence of at least 2 atoms, for example at least 3, 4, 5, 6, 7, 8, 9, 10, 15, 20, 25, or 30 atoms.

In various embodiments, the pendant groups have a molecular weight of at least about or 0.1, 0.2, 0.3, 0.5, 1, 2, 3, 4, 5, 50, 100, 200, 300, 500, 600, 700, 800, 900, 1,000, 1,500, 2,000, 2,500 or about 5,000 kDa, and useful ranges may be selected between any two of these values. For example, in various embodiments, the pendant groups have a molecular weight from about 0.1 to about 5 kDa, 0.1 to 2, 0.1 to 1, 0.1 to 0.5, 0.2 to 5, 0.2 to 1, 0.2 to 0.5, 0.3 to 5, 0.3 to 1, or 0.3 to 0.5 kDa.

In certain embodiments, the pendant groups have a molecular weight from about 0.1 to about 1 kDa.

In certain embodiments, the pendant groups have a molecular weight from about 0.5 to about 1 kDa.

The pendant group may be a linear or branched group.

In various embodiments, the pendant group comprises a polymer, polymer brush, or molecular brush.

In certain embodiments, the pendant group comprises a polymer or molecular brush. In certain preferred embodiments, the pendant comprises a molecular brush.

In various embodiments, pendant group comprises a polymer selected from the group comprising proteins, polyamides, silicone polymers, or aminoborane polymers. In various embodiments, pendant group comprises a polymer selected from the group comprising proteins, polyamides, or silicone polymers. In various embodiment, the polymer is a hydrophobic polymer.

In various embodiments, the hydrophobic polymer is selected from saturated or unsaturated polyesters e.g. polylactic acid (PLA) or polyhydroxybutyrate (PHB); cellulose acetates e.g. cellulose triacetate; polyacrylonitriles e.g. polyacrylonitrile; polyamides e.g. aromatic polyamides such as polymer made from paraphenylenediamine and terephthalic acid, nylon 66; polyolefins, e.g. polyisobutylene, polypropylene; polysulfones including aromatic polysulfones, e.g. polymer produced from 1,4-dihydroxybenzene and bis(4-chlorophenyl)sulfone; aromatic polyphenylene-sulfones, e.g. polyphenylene sulfone; polyether ketones, e.g. PEEK formed by reaction of 4,4′-difluorobenzophenone with the disodium salt of hydroquinone; polyvinylidene fluorides, eg copolymer poly(vinylidene fluoride-trifluoroethylene); polyvinylchlorides and other chlorinated polyethylenes, e.g. chlorinated polyethylene elastomer with chlorine content of ca 42%; polystyrenes e.g. poly(4-methylstyrene); polytetrafluorethylenes, e.g. polytetrafluorethylene; polycarbonates, e.g. polymer made from bisphenol A and diphenyl carbonate; polyamines, e.g. spermine (C₁₀H₂₆N₄); phenolic polymers, e.g. polymer made from p-t-butylphenol and formaldehyde; polyamic acids, eg poly(pyromellitic dianhydride-co-4,4′-oxydianiline); polyazomethines, e.g. poly(3′,4′-dibutyl-α-terthiopheneazomethine-1,4-phenylene-azomethine); polybenzimidazoles, e.g. poly[2,2′-(m-phenylen)-5,5′-bisbenzimidazole]; polybenzoxazoles, e.g. poly(p-phenylene benzobisoxazole); polyethers and aromatic polyethers, e.g. polyethylene glycol; polyhydrazides, e.g. poly(isophthalic dihydrazide); polyimide e.g. poly (4,4′-oxydiphenylene-pyromellitimide); polyionenes e.g. poly[oxycarbonylmethylene-1,6-hexamethylenebis(dimethyliminio)methylenecarbonyloxy-2-[(9-anthryl)methyllpropylene dichloride]; polyisocyanurates; polyketones e.g. polypropanone; polyphenyls e.g. polyphenylether; polyquinoxalines e.g. polyquinoxaline formed by reaction between 1,4-diglyoxalylbenzene and 3,3′-diaminobenzidine; polyurethanes e.g. polyurethane formed by reaction between 4,4-diisocyanatodiphenylmethane and ethylene glycol; polysiloxanes e.g. polydimethylsiloxane, polysulfonamides e.g. polysulfonamide formed by reaction between m-phenylenediamine and 1,3-benzenedisulfonyl chloride; polythioesters e.g. poly(3-mercaptopropionate); polythioethers e.g. poly(butylenesulfide); polyureas e.g. polyuria formed by reaction between 4,4-diisocyanatodiphenylmethane and ethylene diamine; vinyl polymers e.g. polyvinylacetate; acrylic polymers e.g. poly(methyl methacrylate); fluoro polymers; chloro polymers; poly(N-vinylcarbazoles); polyvinylbenzylchlorides; polyanilines; polypyrroles; polyacetylenes; and polythiophenes, and the like.

In various embodiments, the polymer brushes comprise a polyelectrolyte. In various embodiments, the polyelectrolyte comprises a polycationic or polyanionic polymer. In various embodiments, the polyelectrolyte is a polyanionic polyacrylates or a polycationic quaternary ammonium polymer.

In various embodiments, the pendant groups are hydrophilic or hydrophobic. In certain preferred embodiments, the pendant groups are hydrophobic. In various embodiments, the pendant groups are substantially hydrophilic or substantially hydrophobic. In certain preferred embodiments, the pendant groups are substantially hydrophobic.

In various embodiments, the pendant group comprises head group and a tail group, wherein the pendant group is attached to the surface of the solid phase via the head group. Preferably, the tail group extends away from the surface of the solid phase. In some embodiments, the pendant group comprises a hydrophobic or hydrophilic tail group, preferably a hydrophobic tail group. In some embodiments, the head group is hydrophilic. In some embodiments, the pendant group comprises a hydrophobic tail group and a hydrophilic head group or a hydrophilic tail group and a hydrophobic head group, preferably a hydrophobic tail group and a hydrophilic head group. Preferably, the hydrophilic head group comprises one or more immobilizing functional groups (that is, one or more groups capable of immobilising the oxidation catalyst), preferably one or more polar or ionic immobilizing functional groups.

In various embodiments, the tail group comprises a polymer. In various embodiments, the hydrophobic tail group comprises a hydrophobic polymer.

In various embodiments, the tail group comprises a non-polymeric group. In various embodiments, the hydrophobic tail group comprises a C₂-C₂₀alkyl group, for example a C₈-C₂₀alkyl group. In various embodiments, the hydrophobic tail group is non-polymeric and comprises a C₂-C₂₀alkyl chain, for example a C₈-C₂₀alkyl group.

In certain preferred embodiments, the polymer comprises from 2 to 25 monomeric units. In certain preferred embodiments, the polymer has a molecular weight from about 0.5 to 1 kDa.

In some embodiments, the pendant group comprises one or more carbon atoms and optionally one or more boron, nitrogen, oxygen, halogen, silicon, phosphorous, or sulfur atoms or any combination of any two or more thereof.

Preferably, the pendant group comprises 1, 2, 3, 4, 5, 6, 7, 8, 9, 10, 11, 12, 13, 14, 15, 16, 17, or 18 or more carbon atoms. In various embodiments the pendant groups comprise 2 to 100, 5 to 100, 10 to 100, 18 to 100, 2 to 50, 5 to 50, 10 to 50, 18 to 50, 2 to 30, 5 to 30, 10 to 30, or 18 to 30 carbon atoms.

In one embodiment the pendant group comprises a substituted or unsubstituted linear chain of covalently linked atoms selected from the group consisting of hydrogen, boron, carbon, nitrogen, oxygen, halogen, silicon, phosphorus, and sulfur that comprises one or more carbon atoms and optionally one or more boron, nitrogen, oxygen, halogen, silicon, phosphorous, or sulfur atoms or any combination of any two or more thereof. The linear chain may comprise one or more ring structures, for example, a phenylene ring.

In some embodiments, the linear chain comprises 2 to 150, 2 to 100, 5 to 100, 10 to 100, 18 to 100, 2 to 75, 5 to 75, 10 to 75, 18 to 75, 2 to 50, 5 to 50, 10 to 50, 18 to 50 atoms, or 5 to 50 atoms.

Preferably, the atoms of the linear chain are selected from the group consisting of hydrogen, carbon, nitrogen, oxygen, halogen, silicon, phosphorus, and sulfur.

Preferably, the linear chain comprises one or more alkyl, alkylene, alkenyl, alkenylene, alkynyl, alkynylene, cycloalkyl, cycloalkylene, cycloalkenyl, cycloalkenylene, aryl, arylene, heterocyclyl, heterocyclylene, heteroaryl, or heteroarylene groups.

In various embodiments, the substituted or unsubstituted linear chain comprises a group selected from a quaternary ammonium, organohalide, tetraorganoborate, phosphate, phosphonate, sulfonate, or thioether, a tetraorganophosphonium ion, or carboxy group. Preferably, the group is selected from a quaternary ammonium, phosphate, sulfonate, tetraorganophosphonium ion, or carboxy group, preferably a quaternary ammonium, phosphate, sulfonate, or carboxy group. Preferably, the group is a quaternary ammonium group.

Preferably, the substituted or unsubstituted linear chain comprises one or more groups selected from the group comprising halogen, organohalo, —CN, —NC, —CNO, —NCO, —OCN, —CNS, —NCS, —SCN, —NCNR¹, —BR¹R², —NR¹R², —OR¹, —SiR¹R²R³, —PR¹R², —SR¹, —BR¹R²R³⁺X⁻, —NR¹R²R³⁺X⁻, —PR¹R²R³⁺X⁻, —SR¹R²⁺X⁻, —C(═BR¹)R², —N═BR¹, —P═BR¹, —B═CR¹R², —N═CR¹R², —Si(═CR¹R²)R³, —P═CR¹R², —B═NR¹, —C(═NR¹)R², —N═NR¹, —P═NR¹, —B═O, —C(═O)R¹, —N═O, —NO₂, —N(═O)R¹R², —P═O, —P(═O)R¹R², —S(═O)R¹, —S(═O)₂R¹, —C(═SiR¹R²)R³, —Si(═SiR¹R²)R³, —B═PR¹, —C(═PR¹)R², —N═PR¹, —P═PR¹, —B═S, —C(═S)R¹, —N═S, —P═S, and —P(═S)R¹R²; wherein R¹, R², and R³ at each instance are independently selected from the group consisting of hydrogen, alkyl, alkenyl, alkynyl, cycloalkyl, cycloalkenyl, aryl, heterocyclyl, heteroaryl, hydroxyl, alkoxy, cycloalkoxy, alkenyloxy, cycloalkenyloxy, aryloxy, heterocyclyloxy, heteroaryloxy, thiol, sulfenyl, amino, acyl, acyloxy, carboxy, and a bond to another atom of the substituted or unsubstituted linear chain; or any two of R¹, R², and R³, together with the atom to which they are attached form cycloalkyl, cycloalkylene, cycloalkenyl, cycloalkenylene, aryl, arylene, heterocyclyl, heterocyclylene, heteroaryl, or heteroarylene ring; and X⁻ is a suitable anion; or a salt thereof. Preferably, no more than one of R¹, R², and R³ in any of the above groups is a bond.

In various embodiments the pendant group is a group of Formula (IX)

[symbol]

A (IX)
wherein
   [symbol] is a covalent bond to the solid phase;
   A is —[(Z)ₐ—(L)_{b}]_{c};
   a and b at each instance are integers independently selected from 0 and 1;
   c is an integer selected from 1 to 50;
   Z at each instance is independently selected from the group consisting of hydrogen, alkyl, alkylene, alkenyl, alkenylene, alkynyl, alkynylene, cycloalkyl, cycloalkylene, cycloalkenyl, cycloalkenylene, aryl, and arylene;
   L at each instance is independently selected from the group consisting of halogen, heterocyclyl, heterocyclylene, N-heterocyclyl carbene, N-heterocyclylene carbene, heteroaryl, heteroarylene, —CN, —NC, —CNO, —NCO, —OCN, —CNS, —NCS, —SCN, —NCNR¹, —BR¹R², —NR¹R², —OR¹, —SiR¹R²R³, —PR¹R², —SR¹, —BR¹R²R³⁺X⁻, —NR¹R²R³⁺X⁻, —PR¹R²R³⁺X⁻, —SR¹R²⁺X−, —C(═BR¹)R², —N═BR¹, —P═BR¹, —B═CR¹R², —N═CR¹R², —Si(═CR¹R²)R³, —P═CR¹R², —B═NR¹, —C(═NR¹)R², —N═NR¹, —P═NR¹, —B═O, —C(═O)R¹, —N═O, —NO₂, —N(═O)R¹R², —P═O, —P(═O)R¹R², —S(═O)R¹, —S(═O)₂R¹, —C(═SiR¹R²)R³, —Si(═SiR¹R²)R³, —B═PR¹, —C(═PR¹)R², —N═PR¹, —P═PR¹, —B═S, —C(═S)R¹, —N═S, —P═S, and —P(═S)R¹R²;
   R¹, R², and R³ at each instance are independently selected from the group consisting of a bond, hydrogen, alkyl, alkenyl, alkynyl, cycloalkyl, cycloalkenyl, aryl, heterocyclyl, heteroaryl, hydroxyl, alkoxy, cycloalkoxy, alkenyloxy, cycloalkenyloxy, aryloxy, heterocyclyloxy, heteroaryloxy, thiol, sulfenyl, amino, acyl, acyloxy, and carboxy; or
   any two of R¹, R², and R³, together with the atom to which they are attached form cycloalkyl, cycloalkylene, cycloalkenyl, cycloalkenylene, aryl, arylene, heterocyclyl, heterocyclylene, heteroaryl, or heteroarylene ring; and
   X⁻ is a suitable anion;
provided that
   A comprises at least two atoms, wherein at least one of the at least two atoms is a carbon atom; and
   no more than one of R¹, R², and R³ in any L is a bond to Z or another L;
or a salt or tautomer thereof.

In some embodiments, b is 1 in at least one instance.

A person skilled in the art will appreciate that when c is an integer greater than 1, there can be more than one Z and/or L present in a pendant group. Z, L, a, and b at each instance can be different. For example, if a pendant group comprises two Z groups, one of the Z groups could be propyl and the other ethyl.

The options for Z and L include both monovalent and divalent groups. A person skilled in the art will appreciate that only the terminal Z or L in a pendant group can be monovalent; Z and/or L at every other instance in the pendant group must be divalent. Monovalent Z groups include hydrogen, alkyl, alkenyl, and aryl. Monovalent L groups include halogen, heteroaryl, heterocyclyl, and groups, such as —NR¹R², wherein none of R¹, R², and R³ represents a bond to another Z or L group. Divalent Z groups include alkylene, alkenylene, and arylene. Divalent L groups include heteroarylene, heterocyclylene, and groups, such as —NR¹R², wherein one of R¹, R², and R³ represents a bond to another Z or L group.

In various embodiments, c is an integer selected from 1 to 25, 1 to 15, 1 to 10, 1 to 5, or 1 to 3.

Preferably, A comprises one or more Z groups. Preferably, Z at each instance is independently selected from the group consisting of hydrogen, alkyl, alkylene, cycloalkyl, cycloalkylene, aryl, and arylene. More preferably, Z at each instance is independently selected from the group consisting of hydrogen, alkyl, alkylene, aryl, and arylene. More preferably, Z at each instance is independently selected from the group consisting of hydrogen, alkyl, and alkylene.

More preferably, L at each instance is independently selected from the group consisting of halogen, heterocyclyl, heterocyclylene, N-heterocyclyl carbene, N-heterocyclylene carbene, heteroaryl, heteroarylene, —CN, —NC, —CNO, —NCO, —OCN, —CNS, —NCS, —SCN, —NR¹R², —OR¹, —SiR¹R²R³, —BR¹R²R³⁺X⁻, —NR¹R²R³⁺X⁻, —PR¹R²R³⁺X⁻, —N═CR¹R², —C(═NR¹)R², —C(═O)R¹, —P(═O)R¹R², —S(═O)R¹, —S(═O)₂R¹, and —C(═S)R¹.

Preferably, Z at each instance is independently selected from the group consisting of hydrogen, alkyl, and alkylene and L at each instance is —NR¹R², —OR¹, —SiR¹R²R³, —BR¹R²R³⁺X⁻, —NR¹R²R³⁺X⁻, —PR¹R²R³⁺X⁻, —C(═O)R¹, —P(═O)R¹R², —S(═O)R¹, —S(═O)₂R¹, and —C(═S)R¹, preferably —NR¹R², —OR¹, —SiR¹R²R³, —NR¹R²R³⁺X⁻, —PR¹R²R³⁺X⁻, —C(═O)R¹, —P(═O)R¹R², —S(═O)R¹, and —S(═O)₂R¹.

In certain embodiments, c is 1; a is 0 or 1; b is 1; L is NR¹R²R³⁺X⁻ or —PR¹R²R³⁺X⁻, wherein R¹, R², and R³ are each independently alkyl; and Z is alkylene. In certain embodiments, c is 1; a is 0 or 1; b is 1; L is NR¹R²R³⁺X⁻, wherein R¹, R², and R³ are each independently alkyl; and Z is alkylene. Preferably, at least one of R¹, R², and R³ is C₂-C₂₀alkyl, for example C₂-C₁₈, C₆-C₂₀, C₈-C₂₀, C₁₀-C₂₀, or C₁₂-C₂₀alkyl.

Preferably, c is 1; a is 0; b is 1; and L is NR¹R²R³⁺X⁻ or —PR¹R²R³⁺X⁻, wherein R¹, R², and R³ are each independently alkyl. Preferably, at least one of R¹, R², and R³ is C₂-C₂₀alkyl, for example C₂-C₁₈, C₆-C₂₀, C₈-C₂₀, C₁₀-C₂₀, or C₁₂-C₂₀alkyl.

Preferably, c is 1; a is 0; b is 1; and L is NR¹R²R³⁺X⁻, wherein R¹, R², and R³ are each independently alkyl. Preferably, at least one of R¹, R², and R³ is C₂-C₂₀alkyl, for example C₂-C₁₈, C₆-C₂₀, C₈-C₂₀, C₁₀-C₂₀, or C₁₂-C₂₀alkyl. Preferably, R¹ and R² are each methyl and R³ is hexadecyl.

In certain embodiments, c is 2; a at the first instance of c is 0; b at the first instance of c is 0 or 1; when b is 1 at the first instance of c, L is —SiR¹R²R³ wherein R¹ and R² are each independently a bond to the solid phase, alkyl, or alkoxy, and R³ is a bond to Z at the second instance of c when a at the second instance of c is 1 or a bond to L at the second instance of c when a at the second instance of c is 0; a at the second of c is 0 or 1; when a is 1 at the second instance of c, Z is alkylene (preferably C₁-C₆alkylene); b at the second instance of c is 1; and L at the second instance of c is NR¹R²R³⁺X⁻ or —PR¹R²R³⁺X⁻ (preferably NR¹R²R³⁺X), wherein R¹, R², and R³ are each independently alkyl. Preferably, at least one of R¹, R², and R³ in the NR¹R²R³⁺X⁻ or —PR¹R²R³⁺X⁻ is C₂-C₂₀alkyl, for example C₂-C₁₈, C₆-C₂₀, C₈-C₂₀, C₁₀-C₂₀, or C₁₂-C₂₀alkyl.

In various embodiments, the pendant group comprises, consists essentially of, or is a quaternary ammonium or tetraorganophosphonium group comprising at least one C₂-C₂₀alkyl group, for example a C₂-C₁₈, C₆-C₂₀, C₈-C₂₀, C₁₀-C₂₀, or C₁₂-C₂₀alkyl group. In certain preferred embodiments, the pendant group comprises, consists essentially of, or is a quaternary ammonium group comprising at least one C₂-C₂₀alkyl group, for example a C₂-C₁₈, C₆-C₂₀, C₈-C₂₀, C₁₀-C₂₀, or C₁₂-C₂₀alkyl group.

In certain preferred embodiments, the C₂-C₂₀alkyl group is a C₈-C₂₀alkyl group.

In various embodiments, the pendant group comprises at least one long chain alkyl group, for example a C₈-C₂₀alkyl group.

In various embodiments, the pendant group is of the formula -Q-G-NR¹R²R³⁺X⁻ or -Q-G-PR¹R²R³⁺X⁻; wherein R¹, R², and R³ are each independently alkyl, wherein at least one of R¹, R², and R³ is C₂-C₂₀alkyl, preferably C₈-C₂₀alkyl; X⁻ is a suitable anion; Q is a linker group covalently attached to the solid phase or a bond, and G is C₁-C₆alkylene or a bond. In various embodiments, Q is —SiR^{x}R^{y}— or a bond, wherein R^{x} and R^{y} are each independently a bond to the solid phase, alkyl, or alkoxy (preferably a bond, C₁-C₄alkyl, or C₁-C₄alkoxy).

In various embodiments, the pendant group is —NR¹R²R³⁺X⁻, wherein R¹, R², and R³ are each independently alkyl, wherein at least one of R¹, R², and R³ is C₂-C₂₀alkyl, preferably C₈-C₂₀alkyl; and X⁻ is a suitable anion.

In various embodiments, the pendant group is —C₁-C₆alkylene-NR¹R²R³⁺X⁻, wherein R¹, R², and R³ are each independently alkyl, wherein at least one of R¹, R², and R³ is C₂-C₂₀alkyl, preferably C₈-C₂₀alkyl; and X⁻ is a suitable anion.

In various embodiments, the pendant group is —SiR^{x}R^{y}—C₁-C₆alkylene-NR¹R²R³⁺X⁻, wherein R¹, R², and R³ are each independently alkyl, wherein at least one of R¹, R², and R³ is C₂-C₂₀alkyl, preferably C₈-C₂₀alkyl; and X⁻ is a suitable anion, and R^{x} and R^{y} are each independently a bond to the solid phase, alkyl, or alkoxy.

In various embodiments, the substrate is an oxidisable organic compound or an inorganic compound. In certain preferred embodiments, the substrate is an oxidisable organic compound. In various embodiments, the oxidisable organic compound is a pollutant.

In certain embodiments, the oxidisable inorganic compound is a sulphide or sulphite, or other sulphur containing ion.

In various embodiments, the substrate is provided in the form of a composition. Preferably the composition is a liquid. Preferably the composition is a solution.

In various embodiments, the substrate is provided in a composition comprising one or more additional substrates to be oxidised.

In various embodiments, the pendant groups have greater affinity for one or more of the substrates (in the composition) than for one or more other substrates in the composition.

In various embodiments, the pendant groups have an affinity selective for one or more of the substrates in the composition over one or more other substrates in the composition.

In various embodiments, the catalytic film comprises a plurality of two or more different pendant groups (that is, a plurality of a first pendant group and a plurality of a second pendant group).

In various embodiments, each different pendant group has greater affinity for one or more substrates in the composition than for one or more other substrates in the composition.

In various embodiments, the different pendant groups have affinity for different substrates in the composition.

In various embodiments, the different pluralities of pendant groups are located at different areas on the solid-phase. In certain embodiments, the solid-phase comprises a plurality of pendant groups located at a first area on a surface of the solid-phase and a plurality of pendant groups different to those at the first area located at a second area on a surface of the solid-phase.

In various embodiments, the solid-phase is in the form of a membrane or film comprising a plurality of layers, each layer comprising a plurality of pendant groups different to the plurality of pendant groups on one or more other layers.

In various embodiments, the oxidant is selected from an inorganic or organic peroxide; organic hydroperoxides; organic peroxyacids; hydrogen peroxide or a conjugate base thereof; oxygen; ozone; percarbonate; perborate; potassium monoperoxysulfate; nitrous oxide; bromine; iodine; chlorine; an oxide, oxyanion or the corresponding acid of an oxyanion of chlorine or any of the other halogens; or any combination of two or more thereof.

In various embodiments, the oxidant is selected from organic peroxides; organic hydroperoxides; organic peroxyacids; hydrogen peroxide or a conjugate base thereof; oxygen; ozone; percarbonate; perborate; potassium monoperoxysulfate; nitrous oxide; bromine; bromates; periodates; chlorine; chlorine oxides; and any combination of two or more thereof.

Preferably, the oxidant is hydrogen peroxide (or a conjugate base thereof).

In certain embodiments, the oxidant is provided in the form of a composition, preferably a liquid, preferably a solution, comprising the oxidant.

Preferably, the substrate is provided as a solution and/or the oxidant is provided as a solution. Preferably, the solution(s) are aqueous.

In various embodiments, the method is for oxidising one or more oxidisable pollutants in water. In various embodiments, the method is for oxidising one or more oxidisable organic pollutants in water.

In certain embodiments, the method is a water purification or treatment method, for example a method of purifying or treating water or waste water comprising oxidising one or more undesirable substrates therein.

In various embodiments, the method is for oxidising one or more oxidisable pollutants and water and the pendant groups are substantially hydrophobic, the oxidant is hydrogen peroxide, and the catalyst is an iron-tetraamido macrocyclic ligand (TAML) complex or metal oxide or mixed metal oxide.

In various embodiments, the method is for oxidising one or more oxidisable pollutants and water and the pendant groups are hydrophobic, the oxidant is hydrogen peroxide, and the catalyst is an iron-tetraamido macrocyclic ligand (TAML) complex.

In various embodiments, the solid-phase is a film or membrane attached to a support. In various embodiments, the support is porous.

In various embodiments, the solid-phase is a film or membrane comprising two or more polymer layers.

In various embodiments, the solid-phase is a film or membrane comprising two or more polymer layers attached to a support.

In various embodiments, the method comprises providing a solid phase comprising a plurality of pendant groups having affinity for the substrate, providing an oxidation catalyst, and immobilizing a catalyst on the solid phase.

In various embodiments, the catalyst is provided in the form of liquid composition comprising the catalyst, preferably a solution comprising the catalyst.

In various embodiments, providing the solid phase comprising a plurality of pendant groups comprises providing a solid phase and functionalizing the solid phase with a plurality of pendant groups.

In various embodiments less than about 0.0001%, 0.0005%, 0.001%, 0.005%, 0.01%, 0.05%, 0.1%, 0.5%, 1%, 2%, 3%, 4%, 5%, 6%, 7%, 8%, 9%, 10%, 15% or about 20% of the oxidation catalyst is leached from the solid phase during the oxidation reaction.

In various embodiments the oxidation catalyst is ionic and the rate of ion exchange between the catalyst and ions present in the composition in which the oxidant, substrate, and solid phase are contacted is less than about 0.5%, 1%, 2%, 3%, 4%, 5%, 6%, 7%, 8%, 9%, 10%, 12%, 15%, 18%, or about 20% of the oxidation catalyst on the solid phase. In various embodiments the catalyst is ionic and there is substantially no ion exchange between the catalyst and ions present in the composition in which the oxidant, substrate, and solid phase are contacted.

In various embodiments the rate of reaction is maintained or decreases by less than about 5%, 6%, 7%, 8%, 9%, 10%, 12%, 15%, 18%, 20% or about 25% after about 1, 2, 3, 4, 5, 6, 7, 8, 9, 10, 11 or 12 hours of use of the solid phase for oxidising the substrate. In various embodiments the time to completion of the reaction is maintained or increases by less than about 1%, 2%, 3%, 4%, 5%, 6%, 7%, 8%, 9%, 10%, 12%, 15%, 18%, 20% or about 25% after about 1, 2, 3, 4, 5, 6, 7, 8, 9, 10, 11 or 12 hours of use of the solid phase for oxidising the substrate.

In various embodiments the oxidation catalyst is stable in the presence of the oxidant for at least about 1, 2, 3, 4, 5, 6, 7 or about 8 hours.

In one embodiment a composition comprising the substrate is contacted with the solid phase in a turbulent flow or state. In various embodiments the turbulent flow or state is such that the rate of reaction is increased, including increased by at least about 1%, 2%, 3%, 4%, 5%, 6%, 7%, 8%, 9%, 10%, 15%, 20%, 25%, 30%, 35%, 40%, 45%, 50%, 60%, 70%, or 80% relative to the rate of reaction when the flow is not turbulent. In various embodiments the turbulent flow or state is such that the time to completion of the reaction is reduced, including reduced by at least about 5%, 6%, 7%, 8%, 9%, 10%, 15%, 20%, 25%, 30%, 35%, 40%, 45%, 50%, 60%, 70%, or 80% relative to the rate of reaction when the flow is not turbulent.

In various embodiments the method comprises contacting the substrate to be oxidised, the oxidant, and the solid phase to oxidize the substrate using a cross-flow device comprising a membrane permeable to the oxidant. In various embodiments at least about 50%, 55%, 60%, 65%, 70%, 75%, 80%, 85%, 90%, 95%, 98% or about 99% of the substrate is oxidized on exiting the device.

In various embodiment the pH of the composition comprising the substrate is at least about pH 4, 4.5, 5, 5.5, 6, 6.5, 7, 7.5, 8, 8.5, 9, 9.5, 10, 10.5, 11, 11.5 or about pH 12. In various embodiments the oxidant is hydrogen peroxide and the pH of the composition comprising the substrate is at least about pH 7.0, 7.5, 8, 8.5, 9, 9.5, 10, 10.5, 11, 11.5 or about pH 12. In some embodiments the hydrogen peroxide is in the form of a solution having a pH of at least about 7.5, 8, 8.5, 9, 9.5, 10, 10.5, 11, 11.5 or about pH 12.

In various embodiments, the method comprises treating a liquid to provide an oxidised substrate.

In various embodiments, the method comprises treating water, drinking water, water for recycling, or waste water to oxidize an undesirable substrate, such as an organic compound.

In another embodiment, the method is for bleaching a liquid, preferably water, comprising a dye or other coloured matter.

In another embodiment, the method is for removing sulfur from a fuel, such as oil or coal.

In another embodiment, the method is for oxidising a poison, toxin, or pesticide.

In another embodiment, the method is for manufacturing a chemical, such as a fine chemical, an oxidised lignin, or polymer.

In another embodiment, the method is for treating contaminated soil, such as soil contaminated with organic materials.

In another embodiment, the method is for wet-air oxidation or the catalysis of carbene or nitrene transfer.

In another embodiment, the method is for pre-treating a material for microbial digestion.

The compounds and groups described herein may form or exist as salts. As used herein, the term “salt” is intended to include acid addition salts of any basic moiety that may be present in the compounds or groups, base addition salts of any acidic moiety that may be present in the compounds or groups, and quaternary salts of any basic nitrogen-containing moiety that may be present in the compounds or groups. Addition salts are generally prepared by reacting the compound or group with a suitable organic or inorganic acid or base. Quaternary salts of basic nitrogen-containing moieties can be prepared by reacting the compound or group with reagents, such as, alkyl halides, dialkyl sulfates, arylalkyl halides, and the like. Examples of salts of basic moieties include: sulfates; methanesulfonates; acetates; hydrochlorides; hydrobromides; phosphates; toluenesulfonates; citrates; maleates; succinates; tartrates; lactates; and fumarates. Examples of salts of acidic moieties include: ammonium salts; alkali metal salts such as sodium salts and potassium salts; and alkaline earth metal salts such as calcium salts and magnesium salts. Examples of quaternary salts of basic nitrogen-containing moieties include: N-alkyl pyridinium salts; N-aryl pyridinium salts; N-alkyl imidazolium; N-aryl imidazolium salts; and quaternary ammonium salts. Other salts will be apparent to those skilled in the art.

The compounds and groups described herein, and their salts or other derivatives, may form or exist as hydrates or solvates with various solvents. Such hydrates and solvates as well as the corresponding unsolvated forms are contemplated herein.

The compounds and groups described herein may exist in any reasonable tautomeric form. Examples of tautomers include enol-keto and imine-enamine tautomers. All such tautomers and any mixture thereof are contemplated herein.

The compounds and groups described herein may also exist as stereoisomers. Stereoisomers include, for example, enantiomers; diastereoisomers; and geometrical isomers, such as (E)- and (Z)-isomers. All such stereoisomers and any mixture thereof are contemplated herein.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a schematic view of an apparatus for use in the method described herein;

FIG. 2 is a perspective view of a cross-flow apparatus for use in the method described herein;

FIG. 3 is a perspective view of the bottom part of a cross-flow apparatus of FIG. 2;

FIG. 4 is an exploded cross sectional view through the longitudinal axis of the cross-flow apparatus shown in FIG. 2;

FIG. 5 is a cross sectional view of an assembled cross-flow apparatus shown in FIG. 4;

FIG. 6 is a perspective view of a first mesh insert for use in a cross-flow apparatus with an enlargement inset;

FIG. 7 is a perspective view of a second mesh insert for use in a cross-flow apparatus with an enlargement inset; and

FIG. 8 is a perspective view of a third mesh insert for use in a cross-flow apparatus with an enlargement inset.

### DETAILED DESCRIPTION OF PREFERRED EMBODIMENTS

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The general chemical terms used in the formulae herein have their usual meanings.

The term “acyl” means a —C(═O)R³³ group, wherein R³³ is selected from the group consisting of alkyl, alkenyl, alkynyl, cycloalkyl, cycloalkenyl, aryl, heteroaryl, and heterocyclyl.

The term “acyloxy” means an —O-acyl group, wherein “acyl” is as defined herein.

The term “aliphatic” employed alone or in combination with other terms is intended to include saturated and unsaturated, nonaromatic, straight chain, branched, acyclic, and cyclic hydrocarbons. Those skilled in the art will appreciate that aliphatic groups include, for example, alkyl, alkenyl, alkynyl, cycloalkyl, and cycloalkenyl groups.

The term “alkenyl” means a monovalent straight or branched chain hydrocarbon radical having at least one carbon-carbon double bond. Examples of alkenyl groups include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl, 3-decenyl, and the like. The double bond of an alkenyl group can be unconjugated or conjugated with another unsaturated group. Preferred alkenyl groups comprise 2 to 20 carbon atoms; 2 to 18 carbon atoms; more preferably, 2 to 12 carbon atoms; more preferably, 2 to 6 carbon atoms.

The term “alkenylene” means a divalent straight or branched chain hydrocarbon radical having at least one carbon-carbon double bond. Preferred alkenylene groups comprise 2 to 20 carbon atoms; 2 to 18 carbon atoms; more preferably, 2 to 12 carbon atoms; more preferably, 2 to 6 carbon atoms.

The term “alkenyloxy” means and —O-alkenyl group, wherein “alkenyl” as is defined herein.

The term “alkoxy” means an —O-alkyl group, wherein “alkyl” is as defined herein. Examples of alkoxy groups include methoxy, ethoxy, and the like.

The term “alkyl” means a monovalent saturated straight or branched chain hydrocarbon radical. Examples of saturated straight chain alkyl groups include methyl, ethyl, n-propyl, n-butyl, n-pentyl, n-hexyl, and the like. Examples of saturated branched chain alkyl groups include isopropyl, isobutyl, sec-butyl, tert-butyl, isopentyl, and the like. Preferred alkyl groups comprise 1 to 20 carbon atoms; more preferably 1 to 18 carbon atoms; more preferably, 1 to 12 carbon atoms; more preferably, 1 to 6 carbon atoms.

The term “alkylaryl” means an alkyl group bound to the parent moiety through an arylene group, wherein “alkyl” and “arylene” are as defined herein. Examples of alkylaryl groups include 4-ethylphenyl, 4-tert-butylphenyl, and the like.

The term “alkylene” means a divalent saturated straight or branched chain hydrocarbon radical. Preferred alkylene groups comprise 1 to 20 carbon atoms; more preferably 1 to 18 carbon atoms; more preferably, 1 to 12 carbon atoms; more preferably, 1 to 6 carbon atoms.

The term “alkynyl” means a monovalent straight or branched chain hydrocarbon radical having at least one carbon-carbon triple bond. Examples of alkynyl groups include ethynyl, 1-propynyl, 1-methyl-2-propynyl, 2-propynyl, 1-butynyl, 2-butynyl, and the like. The triple bond of an alkynyl group can be unconjugated or conjugated with another unsaturated group. Preferred alkynyl groups comprise 2 to 20 carbon atoms; more preferably 2 to 18 carbon atoms; more preferably, 2 to 12 carbon atoms; more preferably, 2 to 6 carbon atoms.

The term “alkynylene” means a divalent straight or branched chain hydrocarbon radical having at least one carbon-carbon triple bond. Preferred alkynylene groups comprise 2 to 20 carbon atoms; more preferably 2 to 18 carbon atoms; more preferably, 2 to 12 carbon atoms; more preferably, 2 to 6 carbon atoms.

The term “amino” means a —NR¹¹R²² group, wherein R¹¹ and R²² are each independently selected from the group consisting of hydrogen, alkyl, alkenyl, alkynyl, cycloalkyl, cycloalkenyl, aryl, heteroaryl, and heterocyclyl.

The term “amido” means a —C(═O)-amino group, wherein “amino” is as defined herein.

The term “acylamino” means a —NR³³-acyl group, wherein “acyl” is as defined herein; and R³³ is selected from the group consisting of hydrogen, alkyl, alkenyl, alkynyl, cycloalkyl, cycloalkenyl, heteroaryl, and heterocyclyl.

The term “aryl” means a monovalent aromatic ring or an aromatic or partially aromatic ring system composed of carbon and hydrogen atoms. An aryl group may comprise multiple rings bound or fused together. Examples of aryl groups include anthracenyl, azulenyl, biphenyl, fluorenyl, indan, indenyl, naphthyl, phenanthrenyl, phenyl, 1,2,3,4-tetrahydro-naphthalene, and tolyl. Preferred aryl groups comprise 6 to 14 carbon atoms; more preferably, 6 to 12 carbon atoms; more preferably, 6 to 10 carbon atoms.

The term “arylalkyl” means an aryl group bound to the parent moiety through an alkylene group, wherein “aryl” and “alkylene” are as defined herein. Examples of suitable arylalkyl groups include benzyl, naphthalenylmethyl, and the like.

The term “arylene” means a divalent aromatic ring or an aromatic or partially aromatic ring system composed of carbon and hydrogen atoms. Preferred arylene groups comprise 6 to 14 carbon atoms; more preferably, 6 to 12 carbon atoms; more preferably, 6 to 10 carbon atoms.

The term “aryloxy” means an —O-aryl group, wherein “aryl” is as defined herein.

The term “carboxy” means a —C(═O)OR⁵⁵ group, wherein R⁵⁵ is selected from the group consisting of hydrogen, alkyl, alkenyl, alkynyl, cycloalkyl, cycloalkenyl, aryl, heteroaryl, heterocyclyl, and a metal cation.

The term “cycloalkenyl” means a monovalent monocyclic or polycyclic hydrocarbon ring, wherein the ring comprises at least one carbon-carbon double bond. Preferably, the cycloalkenyl group is monocyclic or bicyclic. Examples of cycloalkenyl groups include cyclopentenyl, cyclohexenyl, and the like. Preferred cycloalkenyl groups comprise 3 to 12 ring carbon atoms; more preferably, 3 to 7 ring carbon atoms.

The term “cycloalkenylene” means a divalent monocyclic or polycyclic hydrocarbon ring, wherein the ring comprises at least one carbon-carbon double bond. Preferred cycloalkenylene groups comprise 3 to 12 ring carbon atoms; more preferably, 3 to 7 ring carbon atoms.

The term “cycloalkenyloxy” means an —O-cycloalkenyl group, wherein “cycloalkenyl” is as defined herein.

The term “cycloalkoxy” means an —O-cycloalkyl group, wherein “cycloalkyl” is as defined herein.

The term “cycloalkyl” means a monovalent saturated monocyclic or polycyclic hydrocarbon ring. Preferably, the cycloalkyl group is monocyclic or bicyclic. Examples of cycloalkyl groups include cyclopentyl, cyclohexyl, 1-cyclohexenyl, 3-cyclohexenyl, cycloheptyl, and the like. Preferred cycloalkyl groups comprise 3 to 12 ring carbon atoms; more preferably, 3 to 7 ring carbon atoms.

The term “cycloalkylene” means a divalent saturated monocyclic or polycyclic hydrocarbon ring. Preferred cycloalkylene groups comprise 3 to 12 ring carbon atoms; more preferably, 3 to 7 ring carbon atoms.

The terms “halo” or “halogen” means a fluorine, chlorine, bromine, or iodine atom.

The term “haloalkyl” means an “alkyl” group as defined herein, wherein at least one hydrogen atom is replaced with a halogen atom, for example trifluoromethyl, and the like.

The term “haloalkenyl” means an “alkenyl” group as defined herein, wherein at least one hydrogen atom is replaced with a halogen atom.

The term “haloalkynyl” means an “alkynyl” group as defined herein, wherein one or more of the hydrogen atoms are replaced with a halogen atom.

The term “haloaryl” means an “aryl” group as defined herein, wherein at least one hydrogen atom is replaced with a halogen atom, for example, 2-bromophenyl, and the like.

The term “heteroaryl” means an “aryl” group as defined herein, wherein one or more of the ring carbon atoms are replaced with a heteroatom. Preferred heteroatoms include nitrogen, oxygen, and sulfur. Preferred heterocyclic rings comprise from one to six ring heteroatoms; more preferably, from one to four ring heteroatoms; even more preferably, from one to three ring heteroatoms. Examples include benzimidazolyl, benzofuranyl, benzoisothiazolyl, benzoisoxazolyl, benzoquinazolinyl, benzothiazolyl, benzoxazolyl, furyl, imidazolyl, indolyl, isothiazolyl, isoxazolyl, oxadiazolyl, oxazolyl, phthalazinyl, pyrazinyl, pyrazolyl, pyridazinyl, pyridinyl, pyrimidinyl, pyrimidyl, pyrrolyl, quinazolinyl, quinolinyl, tetrazolyl, thiazolyl, and triazinyl.

The term “heteroarylene” means an “arylene” group as defined herein, wherein one or more of the ring carbon atoms are replaced with a heteroatom.

The term “heteroaryloxy” means a —O-heteroaryl group, wherein “heteroaryl” is as defined herein.

The term “heterocyclyl” or “heterocyclic” means a monovalent saturated, unsaturated, non-aromatic monocyclic or polycyclic hydrocarbon ring, wherein one or more of the ring carbon atoms are replaced with a heteroatom. Preferred heteroatoms include nitrogen, oxygen, and sulfur. Preferred heterocyclic rings comprise from one to six ring heteroatoms; more preferably, from one to four ring heteroatoms; even more preferably, from one to three ring heteroatoms. Preferred heterocyclic rings comprise from three to twelve ring atoms; more preferably, from three to ten ring atoms; more preferably, from three to six ring atoms. Examples of heterocyclic groups include, but are not limited to, azetidinyl; azepanyl; aziridinyl; diazepanyl; 1,3-dioxanyl; 1,3-dioxolanyl; 1,3-dithiolanyl; 1,3-dithianyl; imidazolinyl; imidazolidinyl; isothiazolinyl; isothiazolidinyl; isoxazolinyl; isoxazolidinyl; morpholinyl; oxadiazolinyl; oxadiazolidinyl; oxazolinyl; oxazolidinyl; piperazinyl; piperidinyl; pyranyl; pyrazolinyl; pyrazolidinyl; pyrrolinyl; pyrrolidinyl; tetrahydrofuranyl; tetrahydrothienyl; thiadiazolinyl; thiadiazolidinyl; thiazolinyl; thiazolidinyl; thiopyranyl; trithianyl; sulfolanyl; 1,3-benzodioxolyl; 1,3-benzodithiolyl; 2,3-dihydro-1,4-benzodioxinyl; 2,3-dihydro-1-benzofuranyl; 2,3-dihydro-1-benzothienyl; 2,3-dihydro-1H-indolyl; and 1,2,3,4-tetrahydroquinolinyl.

The term “heterocyclylene” means a divalent saturated, unsaturated, non-aromatic monocyclic or polycyclic hydrocarbon ring, wherein one or more of the ring carbon atoms are replaced with a heteroatom. Preferred heteroatoms include nitrogen, oxygen, and sulfur. Preferred heterocyclylene rings comprise from one to six ring heteroatoms; more preferably, from one to four ring heteroatoms; even more preferably, from one to three ring heteroatoms. Preferred heterocyclylene rings comprise from three to twelve ring atoms; more preferably, from three to ten ring atoms; more preferably, from three to six ring atoms.

The term “heterocyclyloxy” means an —O-heterocyclyl group, wherein “heterocyclyl” is as defined herein.

The term “N-heterocyclyl carbene” means a monovalent saturated or unsaturated monocyclic or polycyclic hydrocarbon ring, wherein one or more of the ring carbon atoms are replaced with a heteroatom, and wherein at least one heteroatom is a nitrogen atom. Preferred N-heterocyclyl carbenes are derived from imidazolium salts.

The term “N-heterocyclylene carbene” means a divalent saturated or unsaturated monocyclic or polycyclic hydrocarbon ring, wherein one or more of the ring carbon atoms are replaced with a heteroatom, and wherein at least one heteroatom is a nitrogen atom. Preferred N-heterocyclylene carbenes are derived from imidazolium salts.

The term “phenoxy” means an —O-phenyl group.

The term “carbamate” means an amino-C(O)O— or carboxy-NR¹⁶— group, wherein “amino” and “carboxy” are as defined herein; and R¹⁶ is selected from the group consisting of hydrogen, alkyl, alkenyl, alkynyl, cycloalkyl, cycloalkenyl, aryl, heteroaryl, and heterocyclyl.

The term “carbonate” means a carboxy-O— group, wherein “carboxy” is as defined herein.

The term “urea” means an amino-C(O)NR¹⁹— group, wherein “amino” is as defined herein; and R¹⁹ is selected from the group consisting of hydrogen, alkyl, alkenyl, alkynyl, cycloalkyl, cycloalkenyl, aryl, heteroaryl, and heterocyclyl.

The term “phosphate” means a —OP(O)(OR³⁷)(OR³⁸) group, wherein R³⁷ and R³⁸ are each independently selected from the group consisting of hydrogen, alkyl, alkenyl, alkynyl, cycloalkyl, cycloalkenyl, aryl, heteroaryl, heterocyclyl, and a metal cation.

The term “phosphinate” means a —OP(O)R⁴¹R⁴² or —P(O)(OR⁴³)R⁴⁴ group, wherein R⁴¹, R⁴², R⁴³, and R⁴⁴ are each independently selected from the group consisting of hydrogen, alkyl, alkenyl, alkynyl, cycloalkyl, cycloalkenyl, aryl, heteroaryl, heterocyclyl, and a metal cation.

The term “phosphine” means a —PR⁴⁹R⁵⁰ group, wherein R⁴⁹ and R⁵⁰ are each independently selected from the group consisting of hydrogen, alkyl, alkenyl, alkynyl, cycloalkyl, cycloalkenyl, aryl, heteroaryl, and heterocyclyl.

The term “phosphite” means a —OP(OR⁵³)(OR⁵⁴) group, wherein R⁵³ and R⁵⁴ are each independently selected from the group consisting of hydrogen, alkyl, alkenyl, alkynyl, cycloalkyl, cycloalkenyl, aryl, heteroaryl, heterocyclyl, and a metal cation.

The term “phosphonate” means a —P(O)(OR⁵⁷)(OR⁵⁸) or —OP(O)(OR⁵⁹)R⁶⁰ group, wherein R⁵⁷, R⁵⁸, R⁵⁹, and R⁶⁰ are each independently selected from the group consisting of hydrogen, alkyl, alkenyl, alkynyl, cycloalkyl, cycloalkenyl, aryl, heteroaryl, heterocyclyl, and a metal cation.

The term “phosphine oxide” means a —P(O)R⁸³R⁸⁴ group, wherein R⁸³ and R⁸⁴ are each independently selected from the group consisting of hydrogen, alkyl, alkenyl, alkynyl, cycloalkyl, cycloalkenyl, aryl, heteroaryl, and heterocyclyl.

The term “phosphinite” means a —P(OR⁵¹)R⁵² or —OPR⁵⁵R⁵⁶ group, wherein R⁵¹, R⁵², R⁵⁵, and R⁵⁶ are each independently selected from the group consisting of hydrogen, alkyl, alkenyl, alkynyl, cycloalkyl, cycloalkenyl, aryl, heteroaryl, and heterocyclyl.

The term “phosphonite” means a —P(OR⁶¹)(OR⁶²) or —OP(OR⁶³)R⁶⁴ group, wherein R⁶¹, R⁶², R⁶³, and R⁶⁴ are each independently selected from the group consisting of hydrogen, alkyl, alkenyl, alkynyl, cycloalkyl, cycloalkenyl, aryl, heteroaryl, and heterocyclyl.

The term “silane” means a —SiR⁸⁷R⁸⁸R⁸⁹ group, wherein R⁸⁷, R⁸⁸, and R⁸⁹ are each independently selected from the group consisting of hydrogen, alkyl, alkenyl, alkynyl, cycloalkyl, cycloalkenyl, aryl, heteroaryl, and heterocyclyl.

The term “siloxane” means a —SiR⁷⁰R⁸⁰R⁹⁰ or —OSiR¹⁰R²⁰R³⁰ group, wherein R⁷⁰, R⁸⁰, R⁹⁰, R¹⁰, R²⁰, and R³⁰ are each independently selected from the group consisting of hydrogen, alkyl, alkenyl, alkynyl, cycloalkyl, cycloalkenyl, aryl, heteroaryl, heterocyclyl, alkoxy, alkenyloxy, cycloalkoxy, cycloalkenyloxy, aryloxy, heteroaryloxy, and heterocyclyloxy; provided that at least one of R⁷⁰, R⁸⁰, and R⁹⁰ is alkoxy, alkenyloxy, cycloalkoxy, cycloalkenyloxy, aryloxy, heteroaryloxy, or heterocyclyloxy.

The term “sulfate” means a —OS(O)₂OR⁷¹ group, wherein R⁷¹ is selected from the group consisting of hydrogen, alkyl, alkenyl, alkynyl, cycloalkyl, cycloalkenyl, aryl, heteroaryl, heterocyclyl, and a metal cation.

The term “sulfenyl” means a —SR⁷³ group, wherein R⁷³ is alkyl, alkenyl, alkynyl, cycloalkyl, cycloalkenyl, aryl, heteroaryl, and heterocyclyl.

The term “sulfonyl” means a —S(O)₂R⁷⁴ group, wherein R⁷⁴ is alkyl, alkenyl, alkynyl, cycloalkyl, cycloalkenyl, aryl, heteroaryl, and heterocyclyl.

The term “sulfonate” means a —S(O)₂OR⁷⁹ group, wherein R⁷⁹ is selected from the group consisting of hydrogen, alkyl, alkenyl, alkynyl, cycloalkyl, cycloalkenyl, aryl, heteroaryl, heterocyclyl, and a metal cation.

The term “sulfoxide” means a —S(O)R⁸¹ group, wherein R⁸¹ is selected from the group consisting of alkyl, alkenyl, alkynyl, cycloalkyl, cycloalkenyl, aryl, heteroaryl, and heterocyclyl.

The term “sulfinate” means a —S(O)OR⁸² or —O-sulfoxide group, wherein R⁸² is selected from the group consisting of alkyl, alkenyl, alkynyl, cycloalkyl, cycloalkenyl, aryl, heteroaryl, and heterocyclyl.

The term “sulfonamide” means an amino-S(O)₂— or sulfonyl-NR⁷⁶— group, wherein “amino” is as defined herein; and R⁷⁶ is selected from the group consisting of hydrogen, alkyl, alkenyl, alkynyl, cycloalkyl, cycloalkenyl, aryl, heteroaryl, and heterocyclyl.

Unless specified otherwise, any of the groups defined herein may be optionally substituted. The term “substituted” as used herein with reference to any of the groups defined herein means a group wherein at least one hydrogen atom is replaced by a substituent selected from the group consisting of halogen, hydroxyl, thiol, —NO₂, —CN, —NC, —CNO, —NCO, —OCN, —CNS, —NCS, —SCN, alkyl, cycloalkyl, alkenyl, cycloalkenyl, alkynyl, aryl, heterocyclyl, heteroaryl, alkoxy, cycloalkoxy, alkenyloxy, cycloalkenyloxy, aryloxy, heterocyclyloxy, heteroaryloxy, amino, amido, acylamino, acyl, acyloxy, carboxy, carbonate, carbamate, urea, phosphate, phosphinate, phosphine, phosphite, phosphonate, phosphine oxide, phosphinite, phosphonite, silane, siloxane, sulfate, sulfenyl, sulfonyl, sulfonate, sulfoxide, sulfinate, and sulfonamide; wherein each alkyl, cycloalkyl, alkenyl, cycloalkenyl, alkynyl, heterocyclyl, aryl, heteroaryl, alkoxy, cycloalkoxy, alkenyloxy, cycloalkenyloxy, aryloxy, heterocyclyloxy, and heteroaryloxy, and any alkyl, cycloalkyl, alkenyl, cycloalkenyl, alkynyl, heterocyclyl, aryl, and heteroaryl present in any amino, amido, acylamino, acyl, acyloxy, carboxy, carbonate, carbamate, urea, phosphate, phosphinate, phosphine, phosphite, phosphonate, phosphine oxide, phosphinite, phosphonite, silane, siloxane, sulfate, sulfenyl, sulfonyl, sulfonate, sulfoxide, sulfinate, and sulfonamide is optionally substituted with one or more substituents selected from the group consisting of halogen, hydroxyl, thiol, unsubstituted amino, —NO₂, —CN, —NC, —CNO, —NCO, —OCN, —CNS, —NCS, —SCN, unsubstituted alkyl, unsubstituted alkoxy, unsubstituted cycloalkyl, unsubstituted cycloalkoxy, unsubstituted alkenyl, unsubstituted alkenyloxy, unsubstituted cycloalkenyl, unsubstituted cycloalkenyloxy, unsubstituted alkynyl, unsubstituted aryl, unsubstituted aryloxy, unsubstituted heterocyclyl, unsubstituted heterocyclyloxy, unsubstituted heteroaryl, and unsubstituted heteroaryloxy.

Various embodiments are described with reference to the Figures. The same reference numerals are used throughout to designate the same or similar components in various embodiments described.

The present invention advantageously provides a solid phase for oxidizing a substrate and a method employing the same. The solid phase comprises an oxidation catalyst. The catalyst is preferably immobilized on the surface of the solid phase, providing for oxidation of a substrate without the addition of free oxidation catalyst to the reaction. The solid phase further comprises a surface functionalised with a plurality of pendant groups having affinity for the substrate, providing for concentration of the substrate at the surface of the solid phase in proximity to the immobilised oxidation catalyst.

Accordingly, in one aspect, there is provided a method of oxidising a substrate, the method comprising:
(i) providing a substrate to be oxidised,
(ii) providing an oxidant, and
(iii) providing a solid phase comprising a plurality of pendant groups having affinity for the substrate, and an oxidation catalyst, and
(iv) contacting the substrate to be oxidised, the oxidant, and the solid phase to oxidize the substrate.

The method of the present invention utilizes a solid phase comprising an oxidation catalyst wherein the solid phase is functionalized to have affinity for a substrate.

The solid phase brings the substrate to be oxidized into close proximity with the oxidative catalyst such that oxidation of the substrate occurs at the solid phase.

The solid phase comprises a plurality of pendant groups that have affinity for a substrate. When the surface of the solid phase is exposed to a composition comprising a substrate, the affinity of the pendant groups for the substrate creates a first zone adjacent with a surface of the solid phase where the substrate concentrates or becomes localized.

An oxidation catalyst is immobilized on the solid phase.

Concentration of the substrate at the surface of the solid phase promotes contact of the substrate, an oxidant and the oxidation catalyst so that oxidization of the substrate occurs to produce an oxidized substrate. The substrate once oxidized preferably then diffuses away from or is released from the solid phase.

The immobilization of the oxidation catalyst on the solid phase during oxidation (for example, bleaching) reactions limits contamination of the products with catalyst.

A range of differently modified solid phases immobilizing a range of oxidation catalysts may readily be prepared.

The solid phase may be in any suitable form. In various embodiments the solid phase is in the form of a film, a membrane, a plurality of particles, such as powder or beads, or a body, such as continuous sheet.

In a preferred embodiment the solid phase is a membrane. The membrane may be isotropic or anisotropic.

The membrane may be porous. In various embodiments the membrane has a pore size of less than about 0.0005, 0.001, 0.0025, 0.005, 0.01, 0.025, 0.05, 0.075, 0.1, 0.25, 0.5, 0.75, 1, 2.5, 5, 7.5, 1, 2.5, 5, 7.5, or about 10 μm, and useful ranges may be selected from between any of these values, for example, about 0.0005 to about 10 μm, about 0.001 to about 10 μm, about 0.0025 μm to about 5 μm, or about 0.005 to about 1 μm.

In one embodiment, the membrane separates a source of the oxidant from a composition comprising the substrate to be oxidised. The membrane may comprise a first surface in contact with the oxidant source and a second surface in contact with the substrate, wherein the second surface comprises a plurality of pendant groups having affinity for the substrate and an oxidation catalyst.

The membrane is preferably permeable to the oxidant. The oxidant diffuses through the membrane and may create a zone on the surface of the solid phase comprising a high concentration of oxidant. It will be appreciated that localisation of the oxidant at the surface of the membrane where the oxidation reaction occurs may reduce the amount of excess oxidant that may be released into the substrate composition. The oxidation reaction can occur at the surface of a pore of the membrane in contact with the substrate. Such pores are of size sufficient to accommodate the oxidant and substrate.

The rate of diffusion of the oxidant through the membrane may be controlled. Pressure, for example hydrostatic pressure, may be applied to the oxidant to cause it to pass through the permeable membrane. In other embodiments, the rate of diffusion is controlled by creating electric fields across the membrane or providing different concentrations of dissolved material in the oxidant and/or substrate compositions.

The solid phase may comprise one or more polymers, preferably in the form of a polymer film. The polymer film may be a membrane.

The polymer may comprise one or more organic polymers or inorganic polymers. Preferably, the polymer comprises an organic polymer, preferably a synthetic polymer. The polymer may be a blend of two or more polymers, for example two or more organic polymers. Synthetic polymers include, but are not limited to, homopolymers, copolymers, terpolymers, and heteropolymers.

In one embodiment the organic polymer is selected from the group consisting of saturated or unsaturated polyesters, cellulose acetates, polyacrylonitriles, polyamides, polyolefins, polysulfones, aromatic polysulfones, aromatic polyphenylene-sulfones, aromatic polyethersulfones, polyamide polyethersulfones, bisphenols, polyether ketones, sulfonated polyether ketones, polyamide sulfones, polyvinylidene fluorides, polyvinylchlorides and other chlorinated polyethylenes, polystyrenes and polytetrafluorethylenes, polycarbonates, polyamines, phenolic polymers, polyamic acids, polyanhydrides, polyazomethines, polybenzimidazoles, polybenzoxazoles, polycarbodiimides, polycyanurates, polyethers, aromatic polyethers, polyhydrazides, polyionenes, polyisocyanurates, polyketones, polyphenyls, polyquinoxalines, polyurethanes, polysiloxanes, polysulfides, aromatic polysulfides, polysulfonamides, polythioesters, polythioethers, polyureas, polyethylenes, polyolefins, polystyrenes, vinyl polymers, acrylic polymers, fluoro polymers, chloro polymers, diene polymers, polyxylenes, poly(N-vinylcarbazoles), polyvinylbenzylchlorides, polyanilines, polypyrroles, polyacetylenes and polythiophenes, and copolymers, and combinations thereof.

In one embodiment, the organic polymer is selected from the group consisting of vinyl benzyl chloride polymers, copolymers thereof, and organic polymer blends thereof, for example vinyl benzyl chloride/styrene co-polymers, polyvinyl benzyl chloride/polystyrene blends, and polyvinyl benzyl chloride/polyaniline blends. In one embodiment, the organic polymer is selected from the group consisting of vinyl benzyl chloride polymers and vinyl benzyl chloride/styrene co-polymers. In one embodiment the solid phase is in the form of a film or membrane that comprises polyvinylbenzyl chloride.

The polymers may be prepared using any suitable methods of polymer synthesis known in the art. The polymers may be prepared by, for example, by polymerization using a solvent system, homopolymerisation, or emulsion polymerisation as described herein or electrochemical or oxidative polymerisation.

A polymer film may be formed from the polymer, by for example casting, extruding the polymer. Alternatively, a polymer film may be formed by electrochemically growing a film from a suitable monomer, for example pyrrole. Other method suitable methods for forming polymer films will be apparent to those skilled in the art.

In one embodiment the polymer film comprises two or more polymer layers. The multi-layer polymer film may be formed by providing a first polymer layer, casting a second polymer layer on to the surface of the first polymer layer, and optionally casting one or more additional layers successively. Other methods for forming multi-layer polymer films include, for example, co-extruding or laminating two or more polymer layers.

The polymer may be sprayed or painted or otherwise applied on to a surface to form a layer. Multiple layers may be applied to form a multi-layer polymer film.

The polymer film may comprise two or more polymer layers having the same composition and/or two or more layers having a different composition.

After forming the polymer film, the polymer film may be cured by heating at a temperature of, for example, about 85° C.

The solid phase comprises a plurality of pendant groups having affinity for the substrate to be oxidised.

The substrate to be oxidized may be concentrated or localized at one or more of the pendant groups. Once oxidized at or on the one or more pendant groups, the substrate may diffuse away from the pendant groups.

The pendant groups may define a first zone or zones adjacent the surface of the solid phase where the substrate is concentrated or localized. The plurality of pendant groups may define a hydrophobic zone having an affinity for hydrophobic substrates, or a hydrophilic zone having an affinity for hydrophilic substrates. In certain embodiments, the substrate is in an aqueous composition and the pendant groups are substantially hydrophobic.

In embodiments wherein the substrate is provided in a solution, concentration of the substrate at the solid phase may result in a higher concentration of the substrate at the solid phase compared to the concentration of the substrate in the solution.

The pendant groups may have greater affinity for particular target substrates than others in the same composition. For example, the pendant groups may have selective affinity for one or more substrates in a composition comprising two or more oxidisable substrates.

The pendant groups may have less affinity for the substrate that has been oxidised than for the substrate to be oxidized, thereby promoting diffusion or release of the substrate that has been oxidised from the pendant groups.

Where the pendant groups have a higher affinity for a substrate that has been oxidised, the substrate that has been oxidised may concentrate at the solid phase until equilibrium is reached with the solution. At that point, the substrate that has been oxidised begins to diffuse away from the solid phase, back into the solution.

The solid phase may comprise a plurality of two or more different pendant groups, each having a selective affinity for a different oxidisable substrate. Each different plurality of pendant groups are preferably located at different regions on the surface of the solid phase. Different pendant groups having affinity for different substrates may be arranged on different layers of a multi-layer polymer film, so that different substrates are localised to or concentrated at different areas on the surface of the polymer film.

The pendant groups of the solid phase may be selected based on their affinity for a particular substrate. The affinity of the pendant groups for a substrate can be determined using methods known in the art, such as by measuring the partition coefficient between the solid phase comprising the pendant groups and the composition comprising the substrate. For example, for solutions of substrate in contact with a functionalized catalytic polymer film of known volume, partitioning of the substrate between the liquid phase and the film can be calculated by measuring initial and final concentrations of substrate in solution when equilibrium between the solution and film has been reached. For a sample of the dye orange II (50 μM) in aqueous buffer (20 mL carbonate buffer, pH 9.5, 0.01M) in contact with a functionalized catalytic polymer film (circular disc 35 mm diameter) described in the Examples the partition coefficient was measured to be approximately 25.

Depending the substrate to be oxidized and the pendant groups used, the partition coefficient can range from about 1×10⁶ to 1×10⁻⁶, for example from 1×10⁵ to 1×10⁻⁵, 1×10⁴ to 1×10⁻⁴, 1×10³ to 1×10⁻³, or 1×10² to 1×10⁻². In certain embodiments where the substrate to be oxidized is hydrophobic and in aqueous composition and the pendant groups are hydrophobic, the partition coefficient can range from about 1×10⁶ to 1×10⁻², 1×10⁶ to 1×10⁻¹, 1×10⁶ to 0.5, 1×10⁶ to 1, 1×10⁵ to 1×10⁻², 1×10⁵ to 1×10⁻¹, 1×10⁵ to 0.5, 1×10⁵ to 1, 1×10⁴ to 1×10⁻², 1×10⁴ to 1×10⁻¹, 1×10⁴ to 0.5, 1×10⁴ to 1, 1×10³ to 1×10⁻², 1×10³ to 1×10⁻¹, 1×10³ to 0.5, 1×10³ to 1, 1×10² to 1×10⁻², 1×10² to 1×10⁻¹, 1×10² to 0.5, or 1×10² to 1.

Many different pendant groups may be suitable for use in the invention. A person skilled in the art will be able to select appropriate pendant groups based on, for example the nature of the target substrate, the immobilizing functional groups, or the oxidation catalyst. Pendant groups may be chosen based on their polarity. For example, hydrophobic pendant groups may be chosen to provide selective affinity for hydrophobic substrates, preferably in aqueous composition.

Pendant groups may be selected that have particular functional groups that contribute to the affinity of the pendant group for the substrate. For example, pendant groups may have one or more functional groups that selectively bind a substrate.

Similarly, a pendant group may be selected to provide for immobilization of the catalyst. For example, pendant groups having positively charged functional groups may be selected to immobilize a negatively charged oxidation catalyst.

The pendant groups can be a polymer brush or molecular brush. The polymer or molecular brushes are tethered at one end to the solid phase. Such brushes can provide a coating on the surface of the solid phase for concentrating the substrate to be oxidised. A polymer brush comprises a polymer, while a molecular brush can be non-polymeric. Preferably, the polymer comprises from 2 to 25 monomer units. Such polymers may be referred to as oligomers.

The pendant groups can comprise a tail group and head group. In such embodiments, the pendant groups are attached to the solid phase via the head group. The tail group can extend away from the solid phase. A polymer brush or molecular brush can comprise a tail group and a head group.

In certain preferred embodiments, the head group is hydrophilic and the tail group is hydrophobic. The hydrophilic head group can comprise a functional group capable of immobilising the oxidation catalyst. Pendant groups having such a configuration can define a first zone for concentrating hydrophobic substrates for oxidation and second zone disposed between the first zone and a surface of the solid phase for immobilising the catalyst.

In certain preferred embodiments, the head group comprises a quaternary ammonium group. The nitrogen atom of the quaternary ammonium group provides a cationic charge capable of immobilising an anionic oxidation catalyst for example. The tail group can comprise an organic group attached to the nitrogen atom of the quaternary ammonium group. For example, where the quaternary ammonium group is a long chain quaternary ammonium group such as a quaternary ammonium group comprising a C₈-C₂₀alkyl chain, the tail group can comprise the long alkyl chain.

In some embodiments, the pendant group can be covalently attached to the solid phase via the nitrogen atom of the quaternary ammonium group. In other embodiments, the pendant group is covalently attached to the solid phase via an organic group of the quaternary ammonium group, for example via a C₁-C₆alkylene chain.

In other embodiments, the quaternary ammonium group can be attached to the solid phase via a divalent linker group comprising one or more atoms covalently attached to the solid phase. For example, in certain embodiments the pendant group comprising a quaternary ammonium group is covalently attached to particles on or in the solid phase via a silicon based linker group such as —SiR^{x}R^{y}— wherein R^{x} and R^{y} are as defined herein. The linker group is optional. A linker group can be included where, for example, for ease of preparation of the pendant groups it is desirable having regard to the nature of the solid phase to which the pendant groups are attached. For example, where the pendant groups are attached to particles of titanium dioxide the linker can be a silicon based linker, as silicon bonds readily to hydroxyl groups on the surface of the TiO₂ particles.

In certain embodiments, the pendant group is of the formula -Q-G-NR¹R²R³⁺X⁻ or -Q-G-PR¹R²R³⁺X⁻. A head group can comprise the cationic nitrogen or phosphorus in such groups as well as Q and/or G when Q and/or G are not bonds.

The oxidation catalyst may be immobilized on a surface of the solid phase or on one or more pendant groups.

In a preferred embodiment, the catalyst is immobilised by one or more immobilizing functional groups. The catalyst may be immobilised covalently, non-covalently or by supramolecular interactions. Supramolecular interactions include hydrogen bonds, ionic bonds, van der Waals forces, coordinate bonds, aromatic interactions, and hydrophobic interactions, but do not include covalent bonds.

The one or more functional groups may define a second zone or zones adjacent the surface of the solid phase for immobilizing the catalyst. Preferably, a second zone or zones for immobilizing the catalyst is located between the surface of the solid phase and a first zone or zones having affinity for the substrate.

The first zone or zones may have a different polarity to the second zone or zones. In a preferred embodiment the first zone or zones having affinity for the substrate is less hydrophilic or more hydrophobic than the zone or zones for immobilizing the catalyst. The polarity of each zone typically complements the polarity of the catalyst and substrate. For example, the first zone may be hydrophobic for concentrating a hydrophobic substrate, and the second zone may be hydrophilic to immobilize a hydrophilic oxidation catalyst.

In one embodiment one or more functional groups on the surface of the solid phase immobilize the oxidation catalyst. In another embodiment one or more of the pendant groups comprise one or more functional groups that immobilize the oxidation catalyst.

The oxidation catalyst may be immobilized at any position along the length of the pendant groups. Preferably, the oxidation catalyst is immobilized at the proximal end of one or more of the pendant groups in close proximity to the surface of the solid phase.

In various embodiments the oxidation catalyst is immobilized by covalent bonding, electrostatic bonding, hydrogen bonding, supramolecular interactions or preferential solubility.

Preferably, the oxidation catalyst is immobilized on the surface of the solid phase such that the bulk of the oxidation catalyst is retained on the solid phase during oxidation of the substrate.

The pendant groups may be covalently attached to the solid phase. The pendant groups may be attached to the solid phase or to particles via one or more functional groups. The one or more functional groups may also be capable of immobilizing the catalyst.

The plurality of pendant groups may be attached to particles that are in or on the solid phase. The particles may be deposited on the surface of the solid phase, or embedded or partially embedded on or into the solid phase. The particles may at least partially cover the surface of the solid phase. In some embodiments, the particles coat a surface of the solid phase.

Preferably, the particles comprise one or more inorganic materials. Suitable materials include titania, silica, alumina, iron oxide (for example Fe₃O₄), and zirconium dioxide. A person skilled in the art will appreciate that other suitable inorganic materials known in the art may be used. In certain embodiments, the particles comprise silica, for example silica gel.

In various embodiments the particles have an average diameter of less than about 0.5, 1, 5, 10, 20, 25, 50, 75, 100, 200, 250, 300, 400, 500, 600, 700, 750, 800, 900 or about 1000 nm, and useful ranges may be selected from between any of these values, for example, from about 0.5 nm to about 1000 nm, about 1 to about 1000 nm, about 1 to about 500 nm, about 1 to about 100 nm, about 5 to about 1000 nm, about 5 to about 500 nm, or from about 5 to about 100 nm.

The particles may comprise a plurality of reactive functional groups to which the pendant groups may be attached. In various embodiments, the reactive functional groups are alkoxy, oxide, sulphide, thiol, or hydroxyl groups. Suitable methods for preparing particles comprising a plurality of reactive functional groups will be apparent to those skilled in the art.

In various embodiments, the particles are functionalised with the pendant groups prior to or after depositing or embedding the particles on or in the solid-phase.

Particles may be deposited or formed on a surface of the solid-phase by any suitable method. In one embodiment, a sol gel or process or hydrothermal crystallisation process is used.

A sol gel process comprises providing a sol in which the solid phase is immersed to coat the solid phase with the particles. Numerous processes for preparing sols are known in the art. The coated solid-phase may be heat treated following coating.

Following the deposition of the particles on the surface of the solid phase, the particles are functionalised with the pendant groups.

For example, the deposition of thin mesoporous coatings of TiO₂ nanoparticles onto membranes of varying pore sizes can be achieved through a low temperature hydrothermal process. Titania sol-gel particles are dip-coated onto the membrane. The coated membrane is then heated (ca 120° C. under vacuum for 16 hours), then treated with water (90° C. for 24 hours), and then treated with UV light (12 hours) to remove residual organic material. The membrane can be a polyethersulfone (PES) or polyvinylidene fluoride membrane, or any other suitable membrane. The TiO₂ particles attach directly onto the membrane polymer. The TiO₂ particles can be functionalised with pendant groups by treatment with with a suitable pendant group precursor, for example a reagent such as dimethyloctadecyl[3-(trimethoxysilylpropyl)]ammonium chloride.

Alternatively, the particles are functionalised with pendant groups prior to depositing the particles on the solid phase.

In other embodiments, the particles are blended with the material from which the solid phase is formed prior to forming the solid phase. In such embodiments, the particles may be dispersed, preferably uniformly, throughout the solid phase. The particles may be functionalised with the pendant groups prior to blending or may be functionalised after forming the solid phase comprising the particles.

For example, as described in the Examples below, particles of silica can be functionalised with pendant groups by treatment with a suitable pendant group precursor, and the particles then blended with polymers to form a membrane.

Solid phases having a plurality of pendant groups can be prepared by reacting a solid phase comprising a plurality of reactive functional groups with a suitable pendant group precursor. The pendant group precursor reacts with functional groups on the surface of the solid phase to form a covalent bond between the solid phase and the pendant group.

In one embodiment the solid phase is a polymer film comprising an organic polymer as described above.

The organic polymer may contain various groups capable of reacting with the pendant group precursor. Reactive functional groups can be introduced into polymers that would, otherwise, be unreactive by, for example, co-extruding a blend of the unreactive polymer with a polymer that possesses covalent attachment sites, chemically functionalising the surface of the unreactive polymer, or synthesizing new polymers that possess reactive groups. These methods have been used to prepare, amongst others, polypyrrole-coated polystyrene latex particles bearing reactive N-succinimidyl functional groups (see S. Bousalem et al., J. Mater. Chem., 2005, 15, pp. 3109-3116); polypyridylchlorides (see A. B. Sanghvi et al., Nature Materials, 2005, 4, pp. 496-502); poly(N-alkylpyrrole) with ester groups (see M.-L. Calvo-Munoz a et al., Journal of Electroanalytical Chemistry, 2005, 578, pp. 301-313); polypyrrole containing quaternary alkylammonium groups (see O. Reynes et al., Electrochimica Acta 2004, 49, pp. 3727-3735); polypyrrole films with viologen functions (see X. Liu et al., Biosensors and Bioelectronics, 2004, 19, pp. 823-834); surface modified and functionalized polyaniline (PANi) and polypyrrole(PPY) films (see E. T. Kang et al., Synthetic Metals, 1997, 84, pp. 59-60), and 4-vinyl benzyl chloride (VBC) polymers comprising chlorobenzyl groups (see Zhang Z, Shakhsher Z, Seitz W R. Microchimica Acta. 1995; 121(1-4):41-50).

A person skilled in the art will be able to select appropriate pendant group precursors, based on the nature of the solid phase, to provide a particular solid phase comprising a plurality of pendant groups without undue experimentation.

In some embodiments, the pendant group precursor comprises a reactive group that can react with the reactive functional groups on the solid phase to covalently link the solid phase to the pendant group. The nature of the reactive functional groups is not limited.

In one embodiment, the reactive group comprises a leaving group. Nucleophiles on the surface of the solid phase can displace the leaving group to form a covalent bond between the pendant group and the solid phase.

Suitable leaving groups include, but are not limited to, halogen anions, in particular chloride, bromide, and iodide; aryl sulfonates, such as p-toluenesulfonate; alkyl sulfonates, such as methanesulfonate; and alkoxy groups, such as methoxy and ethoxy.

In another embodiment the reactive group comprises a nucleophilic group that can displace leaving groups on the surface of the solid phase to form a covalent bond between the pendant group and the solid phase.

Suitable nucleophilic groups include, but are not limited to, alcohols and alkoxides; amines and amide anions; thiols and thiolates; phosphines and phosphine anions; and carbanions.

In another embodiment the reactive group comprises a free radical precursor. Homolytic cleavage of the free radical precursor provides a reactive free radical intermediate that can undergo, for example, free radical addition or substitution reactions with reactive functional groups on the surface of the solid phase to form a covalent bond between the pendant group and the solid phase. Suitable free radical precursors include, but are not limited to, halogen atoms, in particular bromine and iodine; thiols; sulfenyl halides; terminal alkenes; and terminal alkynes.

The pendant group precursor can be prepared from suitable starting materials using standard organic reactions well known in the art (see R. C. Larock, Comprehensive Organic Transformations: A Guide to Functional Group Preparations, 2^{nd} Ed., 1999, John Wiley & Sons, Inc., United States of America). Generally, but not always, the reactive group is installed at the end of the synthetic sequence. Where the reactive group is installed earlier in the synthetic sequence, the reactive group may need to be protected with a protecting group (see P. G. M. Wuts and T. W. Greene, Greene's Protective Groups in Organic Synthesis, 4^{th} Ed., 2006, John Wiley & Sons, Inc., New Jersey). The protecting group can be removed prior to or during reaction with the solid phase. In the case of simple pendant group precursors, the pendant group precursor may be commercially available.

Pendant group precursors comprising polymers, for example polymers comprising 2 to 25 monomer units, include but are not limited to tertiary amine functionalized polymers. Such polymers may be prepared by methods known in the art, for example Spinu, M.; McGrath, J. E. Journal of Polymer Science, Part A: Polymer Chemistry (1991), 29(5), 657-70; dell'Erba, I. E.; Williams, R. J. J. Journal of Thermal Analysis and Calorimetry (2008), 93(1), 95-100; Zhang, Qu; Zhang, Dawei; Li, Xiaodong; Liu, Xiaohui; Zhang, Wenjun; Han, Lei; Fang, Junfeng. Chemical Communications (Cambridge, United Kingdom) (2015), 51(50), 10182-10185; and Wang, Zhen; Beletskiy, Evgeny V.; Lee, Sungsik; Hou, Xianliang; Wu, Yuyang; Li, Tiehu; Kung, Mayfair C.; Kung, Harold H. Journal of Materials Chemistry A: Materials for Energy and Sustainability (2015), 3(4), 1743-1751.

The pendant group precursor may be reacted with the solid phase in the presence of, or, when the pendant group precursor is a liquid, in the absence of, a solvent. Where the reaction is carried out in the presence of a solvent, the solvent used will depend on the nature of the solid phase, pendant group precursor, and reactive groups.

In a preferred embodiment the pendant group precursor is a tertiary amine that is reacted with alkyl halides on the solid phase to provide quaternary ammonium groups. Such groups are useful for immobilizing anionic catalysts.

In one embodiment the solvent is water. In another embodiment the solvent is an aqueous acidic solution; aqueous alkaline solution; or an aqueous buffer solution.

In another embodiment the solvent is an organic solvent. Preferred organic solvents include, but are not limited to alcohols, such as methanol, ethanol, and isopropanol; ethers, such as dioxane, dimethyl ether, diethyl ether, and methyl tert-butyl ether; esters, such as ethyl acetate; ketones, such as 2-butanone; alkanes, such as pentane and hexane; cycloalkanes; alkenes; cycloalkenes; halogenated alkanes, such as dichloromethane, chloroform, and carbon tetrachloride; heterocyclic compounds, such as N-methyl 2-pyrolidinone and pyridine; aromatic compounds, such as benzene, toluene, and xylenes; amines, such as triethylamine; amides, such as dimethyl formamide; dimethyl sulfoxide; acetonitrile; and any mixture of two or more thereof.

In another embodiment the solvent is an ionic liquid, such as 1-hexyl-3-methylimidazolium bromide.

The reaction mixture may be heated or cooled, depending on the nature of the solid phase, pendant group precursor, and reactive groups. In some embodiments, the reaction is carried out at a temperature of about 85° C.

The time required for the reaction to proceed to completion or equilibrium as the case may be also depends on the nature of the solid phase support and pendant group precursor. Preferably the reaction time is less than about 12, 10, 8 or about 6 hours.

The concentration of the pendant group on the solid phase can vary.

Those skilled in the art will be able to determine appropriate pendant group precursor concentrations, solvents, reaction temperatures, and reactions times without undue experimentation.

The crude reaction mixture containing the solid phase may be used without any purification. Alternatively, if necessary, the solid phase may be isolated and/or purified.

Suitable methods for isolation and purification will be apparent to those skilled in the art.

In some embodiments the solid phase is in the form of a film or membrane comprising a polymer. In such embodiments the solid phase may be cross-linked following attachment of the plurality of pendant groups by treating the solid phase with a cross-linking agent, such as a diamine.

Any unreacted reactive functional groups on the solid phase following attachment of the pendant groups may be capped using a suitable reagent using methods known in the art.

The oxidation catalyst may be immobilized on the solid phase by contacting the solid phase with the oxidation catalyst. For example, the solid phase may be immersed in a composition comprising the oxidation catalyst. The composition may be in the form of a solution comprising the catalyst or a suspension or dispersion of particles of the catalyst, for example.

Following removal of the solid phase from the composition comprising the oxidation catalyst, the solid phase may be washed to remove free oxidation catalyst that is not immobilized on the solid phase, so that any leaching of the catalyst from the solid phase is minimized during use in the oxidation method.

The method can be used to produce fresh solid phase comprising immobilised catalyst or to regenerate solid phase that has lost activity through use.

The contacting step may be carried out in the presence of a solvent or a combination of solvents. In one embodiment the solvent is water. In another embodiment the solvent is an aqueous acidic solution, an aqueous alkaline solution, or an aqueous buffer solution. Preferably the solvent is water or an aqueous buffer solution.

In another embodiment the solvent is an organic solvent such as those described herein.

The conditions under which the contacting step is carried out can vary, depending on the nature of the oxidation catalyst. A person skilled in the art would be able to determine appropriate conditions without undue experimentation.

Preferably the catalyst and solid phase are contacted for a period of time of from about 24 hours to about 5 minutes.

The concentration of catalyst immobilised on the solid phase is determined by a number of factors, such as, the nature of the immobilizing functional groups; concentration of the immobilizing functional groups on the solid phase support and/or pendant groups of the solid phase support; time for and temperature at which the catalyst contacts; the degree and rate of mixing or agitation during the contacting step; the amounts of catalyst and modified solid phase used; and the solvent(s) in which the contacting step is carried out, if applicable. A person skilled in the art will be able to control the concentration of catalyst immobilised by varying one or more of these factors without undue experimentation.

The concentration of catalyst immobilised can be determined using methods well known in the art, such as measuring the rate of Orange II bleaching or by difference, as described in the Examples.

Many oxidation catalysts may be suitable. A person skilled in the art will be able to select an appropriate oxidation catalyst based on, for example, the nature of the substrate, the oxidant, the solid phase, or the reaction conditions, for example, the temperature or pH of the reaction, without undue experimentation.

Suitable oxidation catalysts may be organic, inorganic, organometallic, or a coordination complex. In certain preferred embodiments, the catalyst comprises a macromolecular metal complex, or a metal oxide or mixed metal oxide, preferably an oxometallate or polyoxometalate (POM).

In a preferred embodiment the oxidation catalyst is a macromolecular metal complex. The complex may comprise a tetradentate macrocyclic ligand coordinated to a transition metal.

In one embodiment the complex is a compound of the Formula (IA) as described above. Complexes of the Formula (IA) may be prepared from a tetradentate macrocyclic ligand of the general Formula (IB), wherein each of the variables indicated are as defined in the compound of Formula (IA), with the exception that when D is NX, X is selected from the group consisting of hydrogen, alkyl, alkenyl, alkynyl, aryl, alkoxy, phenoxy, halogen, haloalkyl, haloalkenyl, haloalkynyl, haloaryl, cycloalkyl, cycloalkenyl, and a saturated or unsaturated heterocyclic ring, preferably hydrogen.

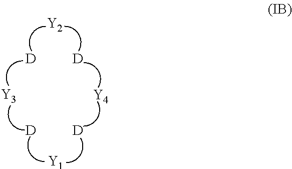

Similarly, preferred complexes of the Formulae (IIA) and (IIIA) may be prepared from the corresponding tetradentate macrocyclic ligands are of the general Formulae (IIB) and (IIIB), wherein each of the variables indicated are as defined in the compounds of Formula (IIA) and (IIIA), with the exception that D is NH.

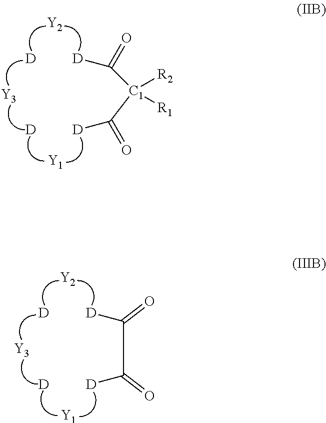

Preferred complexes of the formulae (IVA), (VA), (VIA), (VIIA), and (VIIIA) may be prepared from corresponding ligands, wherein D is NH. For example, a particularly preferred complex of the Formula (VIIA) may be prepared from the ligand of Formula (VIIB), wherein G¹, G², G³, and G⁴ are as defined in the compound of Formula (VIIB) and D is NH.

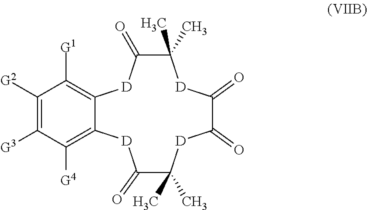

Tetradentate macrocyclic ligands and their manufacture are described in U.S. Pat. No. 7,115,549; U.S. Pat. No. 7,060,818; U.S. Pat. No. 6,992,184; U.S. Pat. No. 6,241,779; U.S. Pat. No. 6,136,223; U.S. Pat. No. 6,100,394; U.S. Pat. No. 6,054,580; U.S. Pat. No. 6,099,586; U.S. Pat. No. 6,051,704; U.S. Pat. No. 6,011,152; U.S. Pat. No. 5,876,625; U.S. Pat. No. 5,853,428; and U.S. Pat. No. 5,847,120, each of which are incorporated by reference herein.

A person skilled in the art will appreciate that the structure of a coordinated ligand may differ from the structure of the corresponding uncoordinated ligand. For example, D in the uncoordinated ligand of Formula (VIIB) is NH, but N in the coordinated complex of Formula (VIIA).

The complexes can be prepared by metallating the ligands in the presence of base.

In one embodiment the tetradentate macrocyclic ligand is dissolved in a suitable solvent, such as tetrahydrofuran, and treated with base. Any base capable of deprotonating the protons of D, when present, are suitable. Preferred bases include, but are not limited to, lithium bis-trimethylsilylamide; lithium diisopropylamide; tert-butyl lithium; n-butyl lithium; and phenyl lithium. Transition metal is then added to metallate the deprotonated ligand and provide the corresponding complexes. A particularly preferred transition metal is iron. In a preferred embodiment iron (II) chloride is used to metallate the deprotonated ligand.

A particularly preferred complex is the compound of Formula (VIIA) as described above.

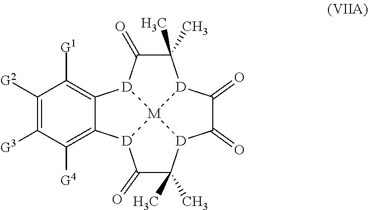

The oxidation state of M depends on the reaction conditions and oxidation state of the transition metal used to metallate the ligand. The oxidation state can be changed by treating the complex with oxidizing agents, such as silver (I) tetrafluoroborate and tert-butylhydroperoxide, or reducing agents using methods known to a person skilled in the art.

The complexes may include axial ligands that coordinate to M above and/or below the plane of the coordinated tetradentate macrocyclic ligand. The axial ligands are labile and capable of dissociating in solution. When the complex is used to catalyse an oxidation reaction the labile ligand can be replaced by the oxidant or a derivative thereof. Preferred labile ligands include, but are not limited to, halogen ions, in particular chloride; cyanide; nitriles; alcohols and alkoxides, including phenols and phenoxides; ammonia; amines; substituted amines; carboxylates; pyridine; ethers; sulfoxides; ketones; carbonates; hydroxide; and water.

In a preferred embodiment the complex comprises only one axial ligand. Preferably, the axial ligand is chloride or water. More preferably, the axial ligand is chloride.

A person skilled in the art will appreciate that the complex may comprise one or more counter ions. The counter ions may be anionic or cationic, depending on the oxidation state of M; nature of D; and the nature of axial ligands, when present.

Preferred cationic counter ions include lithium, sodium, potassium, and tetraethylammonium. Preferably, the cationic counter ion is tetraethylammonium.

Counter ions may be displaced or replaced on immobilisation of the complex on the solid phase.

In certain embodiments, the catalyst is oxometallate or polyoxometalate, preferably a molybdate, tungstate, vanadate, or tungstosilicic acid. In certain preferred embodiments, the catalyst is oxometallate or polyoxometalate, preferably a molybdate or tungstate.

Examples of suitable oxometalates include oxometallates of the transition metals from Groups V and VI of the periodic table. The oxometalate or polyoxometalate may be selected from mononuclear oxometalates, homopolynuclear oxometalates and heteropolynuclear oxometalates. Transition metal oxometalates include oxometalates of molybdenum (Mo), tungsten (W), vanadium (V), niobium (Nb), chromium (Cr) or tantalum (Ta).

Examples of mononuclear oxometalates include those of the formula [MOp]n-Z+, where M are high oxidation state early transition metals such as Cr, V, Mo, W, Nb, and Ta and Z is a charge balancing counter-ion. The charge balancing counter-ions include protons, tetraalkyl ammonium, and ammonium cations. Metal ions such as sodium or potassium may also be useful. One example of such a suitable mononuclear oxometalate is, for example, (NH4)2MoO4, where NH4+ is the charge balancing counter-ion and MoO4− is the oxometalate.

Examples of homopolynuclear oxometalates include those of the formula [MmOp]n-Z+, where M are high oxidation state early transition metals such as Cr, V, Mo, W, Nb, and Ta and Z is a charge balancing counter-ion. These may be formed from mononuclear oxometalates by condensation with acid. One example of a suitable homopolynuclear oxometalate is (NH4)6Mo7O24 where NH4+ is the charge balancing counter-ion and Mo7O24 6− homopolynuclear oxometalate. Examples of heteropolynuclear oxometalates include those of the formula [XxMmOp]n-Z+ where M are high oxidation state early transition metals such as Cr, V, Mo, W, Nb, and Ta; X is a heteroatom that can be either a transition metal or a main group element and Z is a charge balancing counter-ion. One example of a suitable heteropolynuclear oxometalate is H4SiW12O40, where H+ is the charge balancing counter ion, Si is the heteroatom X, and W is the early transition metal M.

Example of oxometalates or polyoxometalates that may be suitable for use include but are not limited to ammonium molybdate ((NH4)2MoO4), ammonium tungstate ((NH4)2WO4), tungstic acid (H2WO4), ammonium metavanadate (NH4VO3), ammonium heptamolydbate ((NH4)6Mo7O24), ammonium metatungstate ((NH4)6H2W12O40), paratungstate ((NH4)10H2W12O42), tetramethylammonium decavanadate ((TMA)4H2V10O28), tetramethylammonium decaniobate ((TMA)6Nb10O28), ammonium dichromate ((NH4)2Cr2O7), ammonium phosphomolybdate ((NH4)3PMo12O40, silicotungstic acid (H4SiW12O40), phosphotungstic acid (H3PW12O40), phosphomolybdic acid (H3PMo12O40), silicomolybdic acid (H4SiMo12O40), and molybdovanadophosphates (H₅PMo₁₀V₂O₄₀).

The solid phase may be in the form of a film or membrane comprising one or more polymer layers attached to a support. The support provides rigidity to the membrane, which may be useful in positioning the film or membrane in a system for carrying out oxidation of the substrate. In one embodiment, the support is porous and the film or membrane is also porous.

In various embodiments the support comprises an organic polymer, preferably a synthetic polymer. Suitable synthetic polymers are described herein. Other suitable support materials include polymers commonly used in the manufacture of membranes and that are known in the art. Suitable supports are readily available from commercial sources. Examples include Viledon® novatexx 2471 PP/PE or Crane Nonwoven™ CU 414.

The oxidant may be selected based on the nature of the composition comprising the substrate. A person skilled in the art will appreciate that some oxidants may be unsuitable for certain applications. For example, bromine and chlorine are generally considered unsuitable oxidants for water remediation.

In various embodiments, the oxidant is selected from an inorganic or organic peroxide; organic hydroperoxides; organic peroxyacids; hydrogen peroxide or a conjugate base thereof; oxygen; ozone; percarbonate; perborate; potassium monoperoxysulfate; nitrous oxide; bromine; iodine; chlorine; an oxide, oxyanion or the corresponding acid of an oxyanion of chlorine or any of the other halogens; or any combination of two or more thereof.

Preferred oxidants include, but are not limited to, hydrogen peroxide, tert-butylhydroperoxide, oxygen, percarbonate, perborate, and any mixture thereof. A particularly preferred oxidant is hydrogen peroxide.

The oxidant may be provided in any form. Preferably, the oxidant is provided in the form of a composition, preferably a liquid composition comprising the oxidant. Most preferably, the oxidant is provided in the form of an aqueous solution.

The oxidation catalyst can be easily recovered from soluble or liquid oxidants; soluble or liquid oxidation products; and solvents, where applicable, by removing the solid phase from the reaction.

In various embodiments, the substrate is oxidised by the oxidation catalyst to form a reduced or unactivated catalyst and the reduced or unactivated catalyst is oxidised by the oxidant.

The oxidation method can be carried out on a laboratory or industrial scale and as a batch, semi-batch or continuous process. In one embodiment, the method is used for oxidizing a substrate in an industrial process.

The oxidation method may be carried out at elevated temperature. It will be appreciated that a suitable temperature at which to carry out the method may be selected based on factors such as the nature of the oxidant, the oxidation catalyst or the composition comprising the substrate.

The composition comprising the substrate and the solid phase may be contacted in a turbulent flow or state, and optionally a composition comprising the oxidant. The turbulence may be provided by any suitable means known in the art, for example, agitation, mixing, or stirring. In some embodiments, a turbulent flow or state is provided using baffles, for example, or other barriers that may be inserted in the path of the flow to increase its turbulence, such as the inserts described below in the Examples. Other suitable methods for generating turbulent flow will be apparent to those skilled in the art.

A typical processing volume is dictated by the choice of reactor vessel.

In a batch process, the oxidant, substrate, and solid phase may be added to the vessel simultaneously or sequentially in any order. In a semi-batch process, the substrate and solid phase may be added batch-wise to the vessel, whilst the oxidant is added continuously.

In a continuous process, oxidant and substrate are continuously added. A continuous process may comprise continuous feed and bleeding of a feed stream of a source of oxidant and a feed stream of the substrate. The process may involve continuous feeding and bleeding or complete flow through of the feed streams.

The order in which the oxidant, substrate and solid phase are combined may be depend on the form of the solid phase and reactor vessel.

A solid phase in the form of a membrane may be fixed to the reactor vessel. The membrane may divide the vessel into a plurality of chambers. Where the membrane is permeable to the oxidant a source of oxidant may be added to one chamber and the substrate added to adjacent chamber such that oxidant diffuses or otherwise passes through the membrane into the chamber comprising the substrate.

Separation of the oxidant from the composition comprising the substrate allows for controlled release of oxidant across the membrane where it is accessible to the oxidation catalyst and the substrate. A high concentration of oxidant can be localized at the surface of the polymer in contact with substrate without the release of large amounts of oxidant into the composition comprising the substrate.

At large scale, mixing may be through recirculation. Heating, if necessary, may be achieved through heat exchangers passing thermal energy from hot outgoing process fluid to the colder incoming material.

In various embodiments, the solid phase is a membrane in one of the following configurations: spiral-wound, plate & frame, flat sheet, hollow fibre, spin-disc, or tubular. Examples thereof may conveniently be provided as a cassette or cartridge.

In other embodiments, the solid phase is a plurality of particles, such as in the configuration of a packed column, cassette, or cartridge, or a fluidised bed.

The method described herein can be carried out using a cross-flow apparatus or device. The use of a cross-flow apparatus enables the method to be carried as a continuous process. As described in the Examples, in such a system the composition comprising the substrate to be oxidised may flow across a membrane that separates the composition comprising the substrate from the source of the oxidant. The source of the oxidant may also flow across the membrane. Flow of the source of oxidant and the composition comprising the substrate may be concurrent or counter-current. Suitable compositions comprising substrates include bulk materials and liquids, such as soil or waste-water, and individual molecular targets, such as phenols or methyl bromide. Some compositions, such as an effluent stream, may comprise numerous molecular substrates for oxidation.

Many substrates may be oxidised using the method of the invention. Preferably, the substrate is an oxidisable organic compound or an inorganic compound, such as a sulphide or sulphite, or other sulphur containing ion.

In various embodiments the substrate comprises a pathogen, for example, a microorganism. The pathogen may comprise bacteria, viruses, moulds, fungi, or protozoa, or a toxin or other compound produced by a microorganism.

In various embodiments the substrate comprises a peptide, a hormone, a pesticide, or a pharmaceutical.

The method may be used for bleaching or oxidising waste-water, in particular waste-water containing dyes and coloured material produced in the dye industry and pulp and paper industry; bleaching solutions to be recycled in, for example, aluminium production and the dying industry; removing undesirable materials, such as phenol, formaldehyde, chlorinated organic material, and pharmaceuticals, from waste-water or water for recycling; removing sulfur from oil or coal; bleaching of wood pulp; destroying anthrax spores, nerve gas, pesticides, or methyl bromide and related materials; polymerizing phenol; purifying drinking water; remediation of soil contaminated with organic materials; selective oxidation in the manufacture of fine chemicals; manufacture of value-added chemicals from lignin; catalysis of wet-air oxidation; catalysis of carbene or nitrene transfer in, for example, the formation of cyclopropanes or aziridines; pre-oxidation treatment of organic material prior to microbial digestion; and bleaching dyes in solution to stop dye transfer in the use of washing powders/detergents.

The method may be used for other applications requiring oxidation of a substrate but where it is advantageous to avoid contaminating the composition comprising the resultant oxidized product with free catalyst. Such applications include the oxidation of intermediate compounds in the production of pharmaceuticals or oxidation of substances in the production of food grade products.

### EXAMPLES

The following non-limiting examples are provided to illustrate the present invention and in no way limit the scope thereof.

### I. Preparation of Catalytic Film

### 1. Synthesis of Polymers

### 1.1 Syntheses of Polyvinylbenzyl Chloride (PVBC)

### Method A

Syntheses of 4-vinyl benzyl chloride (VBC) polymers in a solvent system (Zhang Z, Shakhsher Z, Seitz W R. Aminated polystyrene membranes for a fiber optic pH sensor based on reflectance changes accompanying polymer swelling. Microchimica Acta. 1995; 121(1-4):41-50).

A typical membrane was prepared from 2% divinylbenzene (DVB) (mol DVB vs mol VBC) (mixture of isomers 80%, CAS 1321-74-0, from Sigma Aldrich), 2% Kraton G6932/G6945 (wt % vs VBC) (a styrene-ethylene, butylene-styrene triblock copolymer), 40% (v/v) diluent containing 2:1 by volume xylene:dodecane. The DVB level was calculated assuming 50% purity for the commercial product. A small quantity of benzoyl peroxide was used to initiate free-radical polymerization.

In a typical reaction Kraton G6945 (0.110 g) and benzoyl peroxide (BPO) (0.040 g) were dissolved in a mixture of VBC (5.0 mL), of DVB (0.2 mL), of xylene (2.3 mL) and of dodecane (1.1 mL) in a conical flask. The flask was plugged with cotton wool and the mixture heated in an oil bath at 85° C. until the viscosity reached 600-800 centipoise (as measured at 20° C. using a rheometer). In variations of this procedure, the percentages of Kraton were varied from 0.5% to 4%, BPO from 0.5% to 4%, and azobisisobutyronitrile (AIBN) was used in place of BPO.

### Method B

Syntheses of VBC polymers via a homopolymerization procedure.

In a typical procedure the inhibitor present in the VBC was first removed by treatment with aqueous NaOH. VBC (7.5 mL) was placed in a separating funnel and NaOH (7.5 mL, 0.5% w/w solution) added. The funnel was gently shaken, the NaOH solution removed and the treatment with the NaOH solution repeated two further times. The VBC was washed with deionized water until the water remained neutral. The inhibitor-free VBC was dried by standing over anhydrous K₂CO₃ and collected by filtration. The purified VBC (6.5 mL) was then added to a clean Schlenk tube which was placed under a nitrogen atmosphere and heated in an oil bath at 85° C. until the solution became viscous. In variations of this procedure, either the radical initiator AIBN (0.5% w/w vs VBC) alone, or DVB (0.5% w/w vs VBC) either alone or with AIBN (0.5% w/w vs VBC) was added to the inhibitor-free VBC before placing under a nitrogen atmosphere and heating. After cooling to ambient temperature, the viscous polymer was dissolved in methyl ethyl ketone (MEK) (5 mL) and then precipitated by addition of ethanol, or alternatively methanol.

### Method C

Syntheses of VBC polymers via an emulsion polymerization procedure.

VBC (60 g) and methyl acrylate (20 g) were weighed into a clean conical flask containing deionized water (175 mL), sodium lauryl sulfate (20 mL of 20% w/v aqueous solution), NaHCO₃ (9.6 mL of 5% aqueous solution), and K₂S₂O₈ (9.6 mL of 5% aqueous solution). In some syntheses DVB (0.05, 0.3 or 1.0% w/w vs VBC) was also added. The ingredients were then cooled in an ice bath for one hour after which time Na₂S₂O₅ (6.8 mL of 5% w/v aqueous solution) was added. The conical flask was then sealed with a septum and purged with nitrogen for 20 minutes while still in the ice bath. The conical flask was then slowly stirred with a magnetic stirrer (ca. 30-50 rpm) at 25° C. for 3 days.

The resulting polymer solution was applied to the backing materials by painting or spraying, with drying between applications of multiple coats, as described below.

### 1.2 Syntheses of VBC/Styrene Copolymers

### Method A

Syntheses of VBC/styrene copolymers using 1:1 mole ratio of VBC:styrene in a solvent system.

The inhibitors were first removed from the both styrene and VBC using the procedure detailed in Method B of section 1.1 above, except that 2.5% w/v aqueous NaOH solution was used to treat the styrene.

Inhibitor-free VBC (2.5 mL) and styrene (2.5 mL) were added to a conical flask, followed by dodecane (1.1 mL) and xylene (2.3 mL), and finally either AIBN (0.025 g) or BPO (0.025 g). The flask was plugged with cotton wool and the mixture heated in an oil bath at 85° C. until the viscosity reached 0.035 Pa·s (as measured at 20° C. using a rheometer). After cooling to ambient temperature, the viscous polymer was dissolved in MEK (5 mL) and then precipitated by addition of ethanol, or alternatively methanol.

### Method B

Syntheses of VBC/styrene copolymers using 1:1 mole ratio of VBC:styrene via a homopolymerization procedure.

The inhibitors were removed from both styrene and VBC using the procedure described in Method B of section 1.1 above. Inhibitor-free VBC (5 mL) and styrene (5 mL) were added to a clean Schlenk tube, placed under a N₂ atmosphere and heated in an oil bath at 85° C. until the solution became very viscous (the viscosity was about 0.035 Pa s at 85° C.). In variations of this procedure, the radical initiator AIBN (0.5% w/w vs VBC) alone, AIBN (0.5% w/w vs VBC) and DVB (0.5% vs VBC), or just DVB (0.5% w/w vs VBC) were added before heating. After cooling to ambient temperature, the viscous polymer (0.035 Pa·s at 20° C.), was dissolved in MEK (5 mL) and then precipitated by addition of ethanol, or alternatively methanol.

### 1.3 Characterization of Polymers

### Viscosity (Sheer Stress/Sheer Rate)

Viscosity was measured using a controlling stress Rheometrics S-5000 rheometer (Rheometrics Instruments, Piscataway, N.J.) equipped with a cone and plate geometry. The cone diameter was 20 mm and the cone angle was 4°. All polymer flake samples (0.2 g) were dissolved in NMP (2.0 mL) and measured for 30-45 min using a steady sweep mode at a temperature of 25±0.1° C. For details of the method, refer to the reference: da Cunha, C. R.; Alcantara, M. R.; Viotto, W. H. “Effect of the Type of Emulsifying Salt on Microstructure and Rheological Properties of “Requeijão Cremoso” Processed Cheese Spreads.” J. Food Sci. 2012, 77, E176-E181.

Rhometer model: Controlled-stress rheometer (Paar Physica MCR 301, Anton Paar GmbH, Graz, Austria-Europe).

Typical values for polymer products synthesised from pure VBC were ca. 0.108 Pa·s, and for polymer products synthesised from VBC/styrene with 0.5% DVB were ca. 0.0539 Pa·s.

### Chain Length (Gel Permeation Chromatography)

The chain length/size of the polymers was determined by gel permeation chromatography (GPC). A typical GPC/chromatogram procedure is as follows. The mobile phase solvent for GPC was pure THF filtered through a Teflon filter (TYPE FH, 0.5 μm, Millipore) with a glass filter apparatus. Polymer flakes (weight between 2-4.8 mg) were dissolved in 1 mL THF and filtered through a 0.22 μm nylon syringe filter before analysed on a GPC system consisting of an automatic sampler (Viscotek TDA max) with dual piston pump of the GPCmax, Tetra Detector Array (Viscotek) consisting of light scattering detector, viscometer detector, refractive index (RI) detector and UV detectors. The detectors were connected in a series with the RI following the viscometer because of back-pressure limitations on the RI flow cell. The mobile phase of THF was pumped through at 1.0 mL/min. Columns were 3× T600M column by Malvern Industries ltd (column size 300 mm L×7.8 mm ID, guard column 10 mm L×4.6 mm ID) operated at 35° C. Injection volume was 200 μL and the samples were run overnight before being analyzed using the Omnisec software v 4.70 package. Calibration was with polystyrene standards dissolved and run in THF. The results are shown in Table 1 below.

TABLE 1
Chain length and size of polymers

| | Homopolymer | Copolymer | VBC Homopolymer with |
|---|---|---|---|
| Samples | VBC | VBC/styrene | inhibitor not removed |
| Mw (Da) | 545,000-872,000 | 451,000 | 19,000 |

### 2. Casting Polymer Film and Curing

### 2.1 Backings Used for Casting Polymer Films

The polymer formed in section 1 above was cast onto the following backings.

Polypropylene: Novatexx PP 2471 nd (non-woven backing layer (PE/PP mixtures), 200 μm thick from Freudenberg filter, Germany)

Polyester: 100% Polyester Crane Nonwoven™ CU 414 (100% polyester nonwoven material grade, 150 μm thick from Cranemat USA)

### 2.2 Casting Method

The polymer formed using the procedures in section 1 above was either cast as a viscous liquid directly from the polymerization reaction (without precipitation from MEK solution by the addition of hexane), or by re-dissolving the precipitated polymer in a solvent such as N-methylpyrrolidone (NMP), casting it as a thin film of thickness 50 μm-250 μm on a backing and then removing excess solvent by immersion in a liquid such as water or hexane.

In a typical experiment the precipitated polymer (0.7 g) was dissolved in NMP (5 mL) and the viscous solution cast as a thin film (50 μm thick) onto a polypropylene backing sheet (15 cm by 15 cm) using an Elcometer 4340 motorised thin film applicator incorporating a 4340 doctor blade set at speed no 3 (20 mm s⁻¹). The film cast onto the backing was then immediately immersed in a bath containing n-hexane (150 mL) at ambient temperature and left to stand for 1 hour. After 1 hour the coated backing was removed from the hexane solution and the excess solvent allowed to evaporate.

In the case of the emulsion polymerised product, the solution was not viscous enough to apply using a thin film applicator and so the solution was painted or sprayed onto the backing instead. The coated backing was then cured by the method described below.

### 2.3 Curing Method

The polymer film was then cured by heat treatment. In a typical experiment the coated backing was placed between two glass sheets separated by a continuous silicone gasket and very lightly clamped together. The gasket, which was approximately 30 mm thick, completely enclosed the coated backing without touching it at any time. A preferred gasket consisted of silicon tubing (id 17 mm; od 20 mm) into which Teflon insulated copper wire (od 10 mm) was inserted. This allowed the gasket to be formed into the same shape as the coated backing. The gasket kept the two glass sheets sufficiently separated so that there was approximately (20 mm) space between the coated backing and the top sheet of glass. The assembly was then heated in an oven at 85° C. for 5 hours.

### 2.4 Multiple Coatings of Polymer

After heat-curing the polymer coating, the sheet may be coated again with another polymer film using the same technique described above. The coating and curing process may be carried out multiple times to build up the thickness of the cured film.

In a typical procedure, the backing was coated with a 50 μm thick polymer film and cured, and the coating and curing steps carried out a further four times to provide a 250 μm thick multilayer polymer film comprising five 50 μm thick polymer layers.

3. Functionalization of the Polymer with Molecular Brushes

The polymer film (single or multilayer coating) produced by the method described in section 2 above was functionalized by treating the chloromethyl groups with reagents that result in the formation of molecular brushes. These molecular brushes impart to the porous polymer film the ability to collect and concentrate target species from bulk solution. The molecular brushes may provide sites through which the catalyst can be anchored to the polymer.

In a typical experiment the polymer film is treated with a long-chain tertiary amine which reacts with chloromethyl groups converting them into quaternary ammonium groups capable of anchoring the catalyst. The reaction may be carried out at elevated temperature, using the reagent either neat or with added solvent, for a period of time from 2-8 hours.

In a typical experiment the polymer film is treated with dimethylhexadecylamine in 1,4-dioxane (20 v/v %) at 85° C. for 5 hours. In this way chloromethyl groups are converted to —[CH₂N(CH₃)₂C₁₆H₃₃]⁺ quaternary ammonium groups.

### 4. Cross-Linking Polymer Chains

For polymers prepared without using divinylbenzene in the polymerisation procedure in section 1 above, the polymer film produced by the method described in section 3 above was treated with a diaminoalkane was to further cross-link the polymer chains. The polymer film was treated with the diaminoalkane at elevated temperaturesin solvent for reaction times of 2-8 hours.

In a typical experiment the polymer film was treated with 1,6-diaminohexane in 1,4-dioxane (40 v/v %) at 85° C. for 5 hours.

### 5. Capping Unreacted Groups

Treatment of the polymer film produced by the method described in section 4 above with an amine was then carried out to functionalise (end cap) the remaining unreacted chloromethyl groups. The reaction was carried out at elevated temperature using the amine reagent either neat or with added solvent, for a reaction time of 2-8 hours. In a typical experiment the polymer film was treated with neat diethanolamine at 85° C. for 5 hours.

### 5.1 Characterization of Functionalized Polymer Films

To obtain an estimate of the relative number of the chloromethyl groups that were functionalised in the polychloromethyl styrene cast film during the functionalization, cross-linking and endcapping reactions, the backing and polymer film were accurately weighed at each stage of the process.

For this film, the expected weight of the functionalised polymer is calculated to be about 11.86 mg/cm² if all the chloromethyl groups were functionalised by N(Me)₂C₁₆H₃₃ groups.

The weight of the backing alone was 6.96 mg/cm²; of PVBC cast on to backing was 4.30 mg/cm²; and of the polymer after functionalisation 11.79 mg/cm². This result shows that the large majority of chloromethyl groups were functionalised by the long chain amine, and that only very minimal amounts of the polymer dissolved during the functionalisation process.

### 6. Catalysts

The backing and polymer film produced by curing, functionalising with molecular brushes, cross-linking and end-capping is referred to in the examples that follow as the solid phase film (SF).

The backing, and cast polymer film produced by curing, functionalising with molecular brushes, cross-linking, end-capping, and then treating with catalyst to immobilize the catalyst on the polymer film is referred to herein as the solid phase catalytic film (SCF).

### 6.1 Oxidation Catalysts Anchored to the Solid Phase Catalytic Film (SCF)

The following oxidation catalysts were immobilised on the polymer film: FeB* and FeB^{J} (see structures below in Scheme 1), ammonium molybdate, and sodium tungstate.

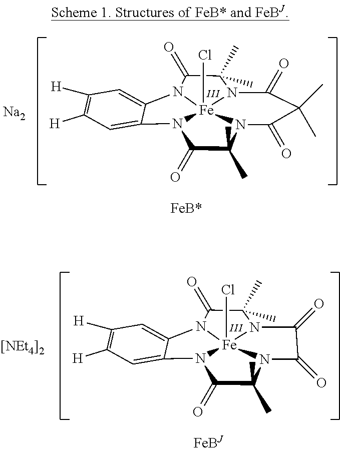

The following procedure may also be used to prepare FeB^{J}.

Synthesis of H₄B^{J}

Dry N,N′-(1,2-phenylene)bis(2-amino-2-methylpropanamide) (2.4424 g, 8.786 mmol) was added to a three-necked round bottom flask (500 mL) and fitted with a pressure-equalised dropping funnel (100 mL) under nitrogen. Dry tetrahydrofuran (300 mL) was added by syringe into the flask, followed by dry triethylamine (2.7 mL, 19.372 mmol). Dry tetrahydrofuran (100 mL) was added then to the dropping funnel, followed by oxalyl chloride (0.84 mL, 9.728 mmol). The solution of oxalyl chloride in tetrahydrofuran was then was added drop-wise to the N,N′-(1,2-phenylene)bis(2-amino-2-methylpropanamide)/triethylamine solution over one hour at room temperature. After all the oxalyl chloride had been added, the solution was left to stir for a further three hours. The white triethylamine hydrochloride salt that had formed was filtered off through Celite® and the filtrate was removed under vacuum. The off-white solid remaining was washed with deionised water (200 mL) to dissolve any remaining salts and the mixture was sonicated for ten minutes, and then filtered onto sintered glass filter. The solid was washed twice with deionised water (two 10 mL aliquots) followed by diethylether (5 mL).

Purification of the crude product was achieved with recrystallisation by dissolving the crude product (2.7831 g) in tetrahydrofuran (600 mL) and adding 1,2-dichloroethane (100 mL). Once ⅔ of the tetrahydrofuran had been removed precipitation started to occur. After standing the solution for 15 minutes, the resultant fine white needles were filtered of (0.3201 g, m.p. 303-305° C.). The filtrate was reduced further until another crop precipitated (0.0916 g, m.p. 300-302° C.). Once almost all the tetrahydrofuran had been removed, the main crop precipitated out (1.8973 g, m.p. 290-292° C.). On further recrystallisation of the main crop the melting point increases (1.6053 g, m.p. 303-305° C.). Total yield 2.017 g, 72%. Elemental analysis: H₄B^{J}.(H₂O)_{0.5}: Expected C=56.30, H=6.20, N=16.41; Observed C=56.55, H=6.11, N=16.32. H¹ NMR: (DMSO-d⁶) 9.77 (s, 1H, N—H), 9.03 (s, 1H, N—H), 8.85 (s, 1H, N—H), 8.17 (s, 1H, N—H), 7.30-7.20 (m, 4H, Ph-H), 1.84 (s, 3H, C—H₃), 1.43-1.39 (m, 9H, C—H₃). C¹³ NMR: (DMSO-d⁶) 173.20 (CO), 171.00 (CO), 164.81 (CO), 162.88 (CO), 132.08 (Ph), 131.57 (Ph), 127.95 (Ph), 126.33 (Ph), 125.76 (Ph), 58.45 (Cq), 56.90 (Cq) 29.37 (CH₃), 27.10 (CH₃), 26.62 (CH₃), 22.61 (CH₃). ESI Mass spectrometry (positive ion mode): (M+H) observed at 333.1557. The fragmentation pathway was consistent with formation of the desired product. IR spectrometry (cm⁻¹) v(N—H): 3284.64(m), 3062.80 (w), 2980.95 (w); v(NHCO): 1695.07 (s), 1683.52 (m), 1641.96 (s), 1602.271 (m); v(Ph): 1535.88 (m), 1516.83 (m). M.P. 303-305° C.

Synthesis of (NEt₄)₂[Fe(Cl)B^{J}]

H₄B^{J} (0.3047 g, 0.917 mmol) was placed in a stoppered two-necked round bottom flask (100 mL) and dried in vacuo for one hour. Under a flow of nitrogen, dry tetrahydrofuran (100 mL) was added by syringe and the flask was warmed on an oil bath at 40° C. Potassium tert-butoxide (0.618 g, 5.51 mmol) was rapidly added to the flask and allowed to stir for ten minutes. Anhydrous iron trichloride (0.163 g, 1.05 mmol) was then added, immediately causing the solution to turn dark brown. The solution was stirred for three hours, then neutralised by the drop wise addition of dilute hydrochloric acid (0.1 molL⁻¹). The solvent was removed under reduced pressure and then dried in vacuo, to provide a dark brown solid.

Isopropanol (50 mL) was added to dissolve the crude product and the insoluble salts were filtered off through Celite®. The isopropanol was then removed. The remaining brown solid was dissolved in deionised water (20 mL) and run through a Dowex 50W-X8 cation exchange resin (50.0 mL, 20-50 US mesh) that was prepared in the [NEt₄]⁺ form, eluting with deionised water. The eluted orange/brown fraction was collected in a round bottom flask. The volume was reduced to approximately 20 mL and purified using a C₁₈-silica column, eluting with a water 90%/methanol 10% mixture. The dark brown second band was collected, the water removed under reduced pressure and the solid dried in vacuo to provide a dark brown glassy solid of pure (NEt₄)₂[Fe(Cl)B^{J}] (0.2453 g, 39%). Elemental analysis: (NEt₄)₂[Fe(Cl)B^{J}].(H₂O)_{0.5}: Expected C=55.77, H=8.34, N=12.20; Observed C=55.80, H=8.64, N=12.15. ESI Mass spectrometry (negative ion mode): [FeB^{J}]⁻ observed at 384.0517 (calculated 384.0526). IR spectrometry (cm⁻¹) v(H₂O): 3404.04 (br, w); v(-NCO): 1637.18 (m), 1596.41 (s), 1562.84 (s); v(Ph): 1466.75 (m), 1448.21 (m).

### 6.2 Addition of Catalysts to Solid Phase Film to Produce Solid Phase Catalytic Films

The solid phase film (SF) was contacted with a solution of the catalyst (either with or without agitation/stirring of the solution or movement of the SF relative to the solution) for a predetermined period of time.

In a typical method, the catalyst was dissolved in water and the SF fully immersed in the solution which was agitated by being slowly stirred at ambient temperature for from 30 minutes to 24 hours. As a typical example, immersion of a circular sample of SF (3.5 cm diameter) in an aqueous solution of FeB* (20 mL of a 50 μM solution) at ambient temperature for 18 hours resulted in 97% of the FeB* being added to the SF to give a SCF. The amount of FeB* not adsorbed was determined by measuring the rate of orange II dye oxidation by the solution after the SCF was removed, as described in Raymond L G., New Bio-inspired Iron Oxidation Catalysts, PhD Thesis, University of Auckland, 2011.

The SCF was rinsed with distilled water and then immersed in buffer solution (20 mL, 0.01M sodium carbonate/bicarbonate, pH 9.5) for 6 hours. The amount of FeB* leached into the solution was 29 nmole. After rinsing with distilled water, the SCF was immersed in buffer solution again under the same conditions and this resulted in the leaching of 1.7 nmole FeB*. On repeating this process 0.44 nmole of FeB* was leached and on repeating again the amount of FeB* leached was so small it could not be measured. After this adsorption and multiple immersion (leaching) procedure, 96.9% of the FeB* in the original solution of FeB* was transferred to and remained on the SCF.

### 7. Characterisation of SCFs Produced by Two Casting Methods

A first film was formed by casting the viscous PVBC polymer solution as a thin film (150 μm thick) on to a polypropylene backing sheet using an Elcometer 4340 thin film applicator incorporating a 4340 doctor blade with a casting speed of 5.3 mm s⁻¹. The cast film and backing were then immediately immersed in a bath containing n-hexane (200 mL) at ambient temperature and left to stand for 30 min before being removed, briefly air dried and then transferred into a bath containing deionized water (200 mL) and left to stand for another 30 min. The film was removed and cured in an oven at 85° C. for 5 hours. The casting, immersion and curing process was repeated once to this same sample to form a film with a total nominal thickness of 300 μm.

A second film was formed by casting the viscous PVBC polymer solution as a thin film (50 μm thick) on to a polypropylene backing sheet using an Elcometer 4340 thin film applicator incorporating a 4340 doctor blade with a casting speed of 5.3 mm s⁻¹. The cast film and backing were immediately immersed in a bath containing n-hexane (200 mL) at ambient temperature and left to stand for 30 min before being removed, briefly air dried and then transferred into a bath containing deionized water (200 mL) where it was left to stand for another 30 min. The film was removed and cured in an oven at 85° C. for 5 hours. The casting, immersion and curing process was repeated four more times to this same sample to form a film with total nominal thickness of 250 μm.

The first and second films were functionalised, cross-linked and end-capped as described above. The maximum amount of FeB* catalyst that could be adsorbed on to each of the films was essentially the same, i.e. about 8.71 μmole per cm² of FeB*. Furthermore, each of the catalytic films containing this amount of FeB* performed essentially the same in catalytic oxidation reactions of dyes.

### II. Oxidation of Substrates Using Catalytic Film

### 1. Substrates and SCF Used for Oxidation Experiments

### 1.1 Surrogate Pollutants

Organic dyes that form colourless products on oxidation can be used to conveniently monitor the oxidation performance of SCFs. The following organic dyes that have been oxidised by the SCF described herein: (i) orange II, (ii) safranin O, (iii) pinacyanol chloride, and (iv) phenolphthalein. In alkaline solution dyes (i) and (iv) are negatively charged while dyes (ii) and (iii) are positively charged.

### 1.2 Real Pollutants

One application for the SCFs is the oxidative removal of low concentrations of pollutants in water. Pollutants that could be targeted by this system include endocrine disruptors, pesticides, herbicides, pharmaceutical ingredients, and flame-retardants. The following pollutants that have been oxidatively removed by the SCF described herein: 17-α-ethinylestradiol (EE2; 19-nor-17α-pregna-1,3,5(10)-trien-20-yne-3,17-diol), Bisphenol A (BPA; 4,4′-(propane-2,2-diyl)diphenol) and Triclosan (TCS; 5-chloro-2-(2,4-dichlorophenoxy)phenol).

### 1.3 SCFs Used in Oxidation Reactions

The SCFs used in the oxidation reactions described in the examples below was prepared by the following procedure.
1. The inhibitor present in the VBC was first removed by treatment with aqueous NaOH. VBC (7.5 mL) was placed in a separating funnel and NaOH (7.5 mL, 0.5% w/w solution) added. The funnel was gently shaken, the NaOH solution removed and the treatment with the NaOH solution repeated two further times. The VBC was washed with deionized water until the water remained neutral. The inhibitor-free VBC was then dried by standing over anhydrous K₂CO₃ and collected by filtration. The purified VBC (6.5 mL) was then added to a clean Schlenk tube which was placed under a nitrogen atmosphere and heated in an oil bath at 85° C. until the solution became viscous (0.035 Pa·s at 20° C.). After cooling to ambient temperature, the viscous polymer was dissolved in methyl ethyl ketone (MEK) (5 mL) and then precipitated by addition of ethanol.
2. The precipitated polymer (0.7 g) was dissolved in NMP (5 mL) and the viscous solution cast as a thin film (50 μm thick) onto a polypropylene backing sheet (PP 2471 nd which consists of a PE/PP mixture of non-woven Novatexx™ material, 200 μm thick) (15 cm by 15 cm) using an Elcometer 4340 thin film applicator incorporating a 4340 doctor blade. Once the film had been cast onto the backing it was then immediately immersed in a bath containing n-hexane (150 mL) at ambient temperature and left to stand for 1 hour. After this time the coated backing was removed from the hexane solution and the excess solvent allowed to evaporate.
3. The polymer film on the backing was then cured by heat treatment. The coated backing was placed between two glass sheets separated by a continuous silicone gasket and very lightly clamped together. The gasket, which was approximately 30 mm thick, completely enclosed the coated backing without touching it at any time. The gasket kept the two glass sheets sufficiently separated so that there was approximately (20 mm) space between the coated backing and the top sheet of glass. The assembly was then heated in an oven at 85° C. for 5 hours.
4. After heat-curing the polymer coating, the sheet was coated again with another polymer film using the same technique described above and cured as above. The coating and curing process was, if necessary, repeated to provide the desired number of polymer layers.
5. The resultant polymer film was functionalized by treating it with dimethylhexadecylamine in 1,4-dioxane (20 v/v %) at 85° C. for 5 hours.
6. The functionalised polymer film was treated with 1,6-diaminohexane in 1,4-dioxane (40 v/v %) at 85° C. for 5 hours.
7. The cross-linked polymer film was treated with neat diethanolamine at 85° C. for 5 hours to functionalise the remaining chloromethyl groups.

The steps 1-7 above were used to form the solid phase film (SF). The SCF was formed by treating the SF formed by steps 1-7 according to step 8.
8. Immersion of a circular sample of SF (3.5 cm diameter) in an aqueous solution of catalyst at ambient temperature for 18 hours resulted in the catalyst being added to the SF to give a SCF. The SCF was rinsed with distilled water and then immersed in buffer solution (20 mL, 0.01M sodium carbonate/bicarbonate, pH 9.5) for 6 hours. The SCF was removed from the buffer solution and rinsed with distilled water. The immersion in buffer solution and rinsing were repeated three more times.
   Unless indicated otherwise the amount of catalyst on the SCF indicated in each example below is the amount added to the SCF prior to the rinsing/immersion in buffer.

### 2. Configurations Used for Oxidation of Substrates Using the SCFs

### 2.1 Reactions in Beaker Apparatus

Oxidation reactions were carried out in a beaker containing an SCF immersed in a solution, as described below.

### 2.1.1 General Procedure

The general experimental procedure for the catalytic oxidation reactions carried out in a beaker with no separation of the oxidant from the substrate was as follows.

To a 150 mL beaker, a 15 mm Teflon-coated magnetic stir-bar was added, followed by buffer solution (20 mL of 0.01M solution), an aliquot of the substrate to give a substrate concentration of 50 μM, and an aliquot of hydrogen peroxide solution to give a hydrogen peroxide concentration of 1 mM. After mixing thoroughly with the stir-bar spinning at a constant rotation rate for 1 minute, the SCF supported by a teflon coated wire frame was added. This point was defined as time=0.

For the experiments with the dyes, at set time intervals a 3 mL aliquot of the solution was removed, the absorbance quickly measured at a pre-determined wavelength and the aliquot returned to the bulk solution.

For the experiments involving EE₂, BPA, and TCS a different monitoring procedure was used and this is described below.

### 2.1.2 Parameters Investigated

The following parameters in the general procedure described above were investigated.

Catalyst loading on the SCF (SCF circlular shape, diameter 35 mm): 0.10, 1.0, 10.0, 100, and 140 μmoles of catalyst, with the corresponding ratios of moles of anchored catalyst to moles of dye or pollutant in the 20 mL of solution used for each experiment being 1:10, 1:1, 10:1, 100:1, and 140:1, respectively.
Substrates: Orange II, Pinacynol chloride, Safranine O, Phenolphthalein, EE₂, BPA, and TCS.
Polymer layers: 1-5 coatings of polymer (50 μm each).
Polymer types: PVBC/1,6-diaminohexane crosslinked, PVBC/DVB crosslinked, and PVBC/Styrene/DVB crosslinked.
pH of buffer solutions: 6.0, 7.0, 9.5, 10.5 and 11.0. All 0.01M HCO₃⁻/CO₃²⁻ or phosphate buffer solutions.
Catalysts: FeB*, FeB³, sodium tungstate, and ammonium molybdate.
Backing for formation of SCF: PP (polypropylene) or PE (polyester).
Stirring rates: 100-1000 rpm.

### 2.1.3 Experiments Involving Oxidative Bleaching of Orange II

### (i) Blank Experiments

Blank experiments were carried out to determine the effects on the oxidative bleaching reactions (measured by absorbance) that the SCF alone or hydrogen peroxide alone have on the absorbance values. The results obtained show that the SCF alone or hydrogen peroxide alone has no significant effect on the absorbance of the dye in solution over the time periods measured.

### (ii) Catalytic Oxidative Bleaching of Orange II

The oxidative bleaching of orange II was carried out according to the general procedure described above in section 2.1.1. The solution volume was 20 mL, buffer was carbonate/bicarbonate (0.01M, pH 9.5 or 11.0), H₂O₂ concentration was 1.0 mM, orange II concentration was 50 μM, catalyst was FeB* (140 μmoles anchored on a circular SCF 35 mm in diameter), the SCF was prepared from five 50 μm coatings of a PVBC polymer cross-linked with 1,6-diaminohexane on a polypropylene backing as described in section 1.3 above, and the stirring speed was 750 rpm. Mole ratios of H₂O₂:orange II:FeB* were 20:1.0:140.

Time for complete bleaching at pH 9.5 was 4.0 minutes.

Time for complete bleaching at pH 11.0 was 10 seconds.

(iii) Multiple Bleaching Experiments with the Same SCF

Ten consecutive bleaching experiments as described in section (ii) above were carried out with the same SCF at pH 9.5 (5 minutes for each run) and pH 11.0 (one minute for each run), respectively. Absorbance vs time was plotted. At pH 9.5, the time for complete oxidation was not changed after 10 consecutive runs. At pH 11.0 the time for complete oxidation changed from 10 seconds to 40 seconds after 10 consecutive runs.

(iv) Multiple Bleaching Experiments with Reduced Amount of Catalyst

Multiple bleaching experiments were carried out at pH 9.5 and with the catalyst:orange II mole ratio 1:1. The solution volume was 20 mL, buffer was carbonate/bicarbonate (0.01M, pH 9.5), H₂O₂ concentration was 1.0 mM, orange II concentration was 50 μM, catalyst was FeB* (1.0 μmole anchored on a circular SCF 35 mm in diameter), the SCF was prepared from five 50 μm coatings of a PVBC polymer cross-linked with 1,6-diaminohexane on a polypropylene backing as described in section 1.3 above, and the stirring speed was 750 rpm. Mole ratios of H₂O₂:Orange II:FeB* were 20:1.0:1.0.

Time for complete bleaching at pH 9.5 was 12 minutes.

Ten consecutive bleaching experiments were carried out with the same SCF (12 minutes for each run). A plot of absorbance vs time shows the SCF has no loss in performance over this time.

The experiments were repeated using a different sample of the SCF that was prepared using the same synthetic method and exactly the same results were obtained for the 10 consecutive bleaching runs.

(v) Multiple Bleaching Experiments with FeB^{J} Instead of FeB*

The multiple bleaching experiments with the catalyst:orange II mole ratio of 1:1 described in section (iv) above were repeated using the catalyst FeB^{J} in place of FeB*. Ten consecutive bleaching experiments were carried out with the same SCF. A plot of absorbance vs time shows after four consecutive bleaching runs the performance of the SCF containing FeB^{J} is very similar to that containing an equivalent amount of FeB*, but that performance decreases with further runs (the time for complete bleaching increasing from about 4 minutes for run 1 to about 10 minutes for run 5).

(vi) Multiple Bleaching Experiments with Pinacyanol Chloride Instead of Orange II

Multiple bleaching experiments were carried out at pH 9.5 and with a catalyst:pinacyanol chloride mole ratio 1:1 according to the general procedure described above. The solution volume was 20 mL, buffer was carbonate/bicarbonate (0.01M, pH 9.5), H₂O₂ concentration was 1.0 mM, pinacyanol chloride concentration was 50 μM, catalyst was FeB* (1.0 μmole anchored on a circular SCF 3.5 cm in diameter), the SCF was prepared from five 50 μm coatings of a PVBC polymer cross-linked with 1,6-diaminohexane on a polypropylene backing as described in section 1.3 above, and the stirring speed was 750 rpm. Mole ratios of H₂O₂:pinacyanol chloride:FeB* were 20:1.0:1.0.

Time for complete bleaching at pH 9.5 was 5 minutes.

Ten consecutive bleaching experiments were carried out with the same SCF (6 minutes for each run). A plot of absorbance vs time shows the SCF had little loss in performance over this time.

(vii) Bleaching by Leached Catalyst

To demonstrate that the catalytic bleaching was carried out by the SCF, and not by catalyst leached into the solution from the SCF, oxidative bleaching runs were carried out in which the SCF was removed from solution at a set time during a bleaching run and then returned to the solution after a set period of time. The absorbance vs time of the solution was measured a set time intervals during this procedure and plotted.

An oxidative bleaching run was carried out as described in section (ii) above at pH 9.5, except that the SCF (140 μmoles FeB* anchored on the circular SCF 35 mm in diameter) was removed from solution at time 1 minute and then returned to the solution at time 3 minutes.

Another oxidative bleaching run was carried out as described in section (iii) above, except that the SCF (1.0 μmoles FeB* anchored on the circular SCF 35 mm in diameter) had already undergone 12 consecutive bleaching runs and was removed from solution at time 4 minutes and then returned to the solution at time 10 minutes.

In both cases, the plot for absorbance when the SCF was removed from the solution was substantially horizontal, but decreased when the film was in the solution. This shows that the catalytic oxidation is not being carried out by catalyst leached into the solution from the SCF.

As the SCF was immersed in these experiments in a solution which contains 0.01 mol L⁻¹ sodium carbonate/bicarbonate buffer solution, the observation that essentially no catalyst is leached shows the catalyst is not displaced from the SCF through a simple ion-exchange process.

(viii) Effect of Stirring Speed on Bleaching Time

Oxidation experiments were carried out to determine the effect of stirring speed on bleaching time. The solution volume was 20 mL, buffer was carbonate/bicarbonate (0.01M, pH 9.5), H₂O₂ concentration was 1.0 mM, orange II concentration was 50 μM, catalyst was FeB* (1.0 μmole anchored on a circular SCF 35 mm in diameter), the SCF was prepared from five 50 μm coatings of a PVBC polymer cross-linked with 1,6-diaminohexane on a polypropylene backing as described in section 1.3 above. Mole ratios of H₂O₂:Orange II:FeB* were 20:1.0:1.0.

The one parameter that was changed between experiments was the stirring speed, which was set at 100 rpm, 300 rpm, 550 rpm, 750 rpm and 1000 rpm for the different experiments. The plot of absorbance vs time for each stirring speed shows that as the stirring rate is increased the time for essentially complete bleaching decreases from 12 minutes at 100 rpm to ca. 5.5 minutes at both 750 and 1000 rpm. The similarity in bleaching rates for stirring speeds of 750 and 1000 rpm suggests that the rate of transport of the dye to the SCF is no longer the rate determining step under these conditions.

### (ix) Effect of Catalyst Loading

Oxidation experiments were carried out to determine the effect of catalyst loading on bleaching time. The solution volume was 20 mL, buffer was carbonate/bicarbonate (0.01M, pH 9.5), H₂O₂ concentration was 1.0 mM, orange II concentration was 50 μM, catalyst was FeB*, the SCF was prepared from five 50 μm coatings of a PVBC polymer cross-linked with 1,6-diaminohexane on a polypropylene backing as described in section 1.3 above, stirring rate was 750 rpm, and mole ratios of H₂O₂:orange II were 20:1.0.

The one parameter that was changed between experiments was the catalyst loadings on the SCF, which was changed from 1-100 μmole anchored on a circular SCF 35 mm in diameter. A plot of initial oxidation rate vs catalyst loading was made. Very little increase in rate was observed as the catalyst loading increased beyond 60 μmole on the 35 mm diameter SCF.

A similar plot was generated for the catalyst FeB^{J} by repeating the experiments using FeB^{J} instead of FeB*. In the case of FeB^{J} no increase in rate was observed as the catalyst loading increased beyond 20 μmole on the 35 mm diameter SCF. At this point the rate limiting step for oxidation was no longer the amount of catalyst present on the SCF.

(x) Replenishing the Membrane with New Catalyst

To investigate whether the catalyst on the SCF could be replenished after all the catalyst has decomposed, a catalytic bleaching experiment with orange II as described in section (ii) above was carried out using a sample of SCF (35 mm diameter) containing 140 μmoles of FeB*. The membrane was then immersed in excess hydrogen peroxide solution (0.64 mmol) for 48 hours to decompose the FeB* and remove the catalytic activity of the SCF.

Evidence that all the catalytic activity was removed was obtained by repeating the bleaching experiment using the resulting SF. A plot of absorbance vs time shows that almost no bleaching occurs over a three hour period, just as was observed for the blank experiments described above.

After thorough washing, the same SF was then immersed in FeB* solution in order to add 140 μmole of FeB* and regenerate the SCF. The regenerated SCF was then tested in an identical bleaching experiment and the absorbance vs time of the solution again plotted. The sequence of catalyst destruction and replenishment followed by bleaching was repeated three times. A plot of absorbance vs time shows each time the SCF was replenished it performed the same in the bleaching experiments as the original SCF.

### 2.1.4 Experiments Involving Oxidative Bleaching of Safranine O

Safranine O is a positively charged organic dye in alkaline solution. In homogeneous solution, FeB* catalyses the bleaching of safranine O with hydrogen peroxide at a slower rate than it does the bleaching of orange II.

The catalytic oxidative bleaching of safranine O was carried out according to the general procedure described above. The solution volume was 20 mL, buffer was carbonate/bicarbonate (0.01M, pH 9.5), H₂O₂ concentration was 1.0 mM, safranine O concentration was 50 μM, catalyst was FeB* (10 μmoles anchored on a circular SCF 35 mm in diameter), the SCF was prepared from two 50 μm coatings of a PVBC polymer cross-linked with 1,6-diaminohexane on a polypropylene backing as described in section 1.3, and the stirring speed was 750 rpm. Mole ratios of H₂O₂ safranine O:FeB* were 20:1.0:1.0.

Ten consecutive bleaching experiments were carried out using the same SCF. A plot of absorbance vs time shows the SCF had little change in activity over the ten runs.

The SCF was then used for an eleventh bleaching experiment using the same conditions, but in this case the SCF was removed from solution at time 2 minutes and returned at time 5 minutes. A plot of absorbance vs time shows essentially no bleaching occurs between 2-5 minutes when the SCF is not present in solution shows the bleaching is not caused by catalyst that has leached from the SCF.

(i) Multiple Bleaching Experiments with Safranine O

Multiple bleaching experiments were carried out at pH 9.5 and with a catalyst:Safranine O mole ratio of 10:1 according to the general procedure described above. The solution volume was 20 mL, buffer was carbonate/bicarbonate (0.01M, pH 9.5), H₂O₂ concentration was 1.0 mM, Safranine O concentration was 50 μM, catalyst was FeB* (10.0 μmole anchored on a circular SCF 3.5 cm in diameter), the SCF was prepared from five 50 μm coatings of a PVBC polymer cross-linked with 1,6-diaminohexane on a polypropylene backing as described in section 1.3 above, and the stirring speed was 750 rpm. Mole ratios of H₂O₂:Safranine O:FeB* were 20:1.0:10.0.

Time for complete bleaching at pH 9.5 was 16 minutes.

Ten consecutive bleaching experiments were carried out with the same SCF. A plot of absorbance vs time shows the SCF had little loss in performance over this time.

### (ii) Bleaching by Leached Catalyst

To demonstrate that the catalytic bleaching was carried out by the SCF, and not by catalyst leached into the solution from the SCF, oxidative bleaching runs were carried out in which the SCF was removed from solution at a set time during a bleaching run and then returned to the solution after a set period of time. The absorbance vs time of the solution was measured at set time intervals during this procedure and plotted.

A further oxidative bleaching run was carried out as described above (i) above, except that the SCF (10.0 μmoles FeB* anchored on the circular SCF 35 mm in diameter) had already undergone 10 consecutive bleaching runs and was removed from solution at time 10 minutes and then returned to the solution at time 20 minutes.

The plot for absorbance vs time when the SCF was removed from the solution was substantially horizontal, but decreased when the film was in the solution, indicating that essentially no bleaching occurred when the SCF was not in the solution. This shows that the catalytic oxidation is not being carried out by catalyst leached into the solution from the SCF.2.1.5 Experiments involving the oxidation of phenolphthalein

The bleaching of phenolphthalein with hydrogen peroxide using either ammonium molybdate or sodium tungstate as catalysts on the SCFs was investigated.

### (i) Blank Experiments

The plot of absorbance vs time for phenolphthalein (5 μM) in carbonate buffer (0.01M, pH 10.5) in the presence of hydrogen peroxide (1.0 mM) showed very little drop in absorbance occurs over 60 minutes.

Plot of absorbance vs time for phenolphthalein (5 μM) in carbonate buffer (0.01M, pH 10.5) containing hydrogen peroxide (1 mM) and in the presence of the SF showed a drop in absorbance of about 0.5 occurred over the first 60 minutes as some of the phenolphthalein is absorbed onto the SCF.

### (ii) Oxidation of Phenolphthalein

The catalytic oxidative bleaching of phenolphthalein was carried out according to the general procedure described above. The solution volume was 20 mL, buffer was carbonate/bicarbonate (0.01M, pH 10.5), H₂O₂ concentration was 1.0 mM, phenolphthalein concentration was 5 μM, catalyst was ammonium molybdate (0.1 μmole anchored on a circular SCF 35 mm in diameter), the SCF was prepared from two 50 μm coatings of a PVBC polymer cross-linked with 1,6-diaminohexane on a polypropylene backing as described in section 1.3 above, and the stirring speed was 500 rpm. Mole ratios of H₂O₂:phenolphthalein:ammonium molybdate were 200:1.0:1.0.

Two consecutive bleaching experiments were carried out using the same SFC. A plot of absorbance vs time shows it took approximately 40 minutes for the absorbance to drop to close to zero (cf. the blank dropped to 0.8 in 40 minutes) and the SCF showed little change in activity over the two runs. Similar results were observed when 10 consecutive bleaching experiments were carried out using the same SFC.

(iii) Sodium Tungstate as the Catalyst

The two consecutive bleaching experiments described in section (ii) above were repeated, except that sodium tungstate was used as the catalyst on the SCF instead of ammonium molybdate. A plot of absorbance vs time shows it took approximately 40 minutes for the absorbance to drop to close to zero (cf. the blank dropped to 0.8 in 40 minutes) and the SCF showed little change in activity over the two runs.

### (iv) Absorption of Phenolphthalein

To eliminate the effect of the phenolphthalein being removed from solution by adsorption rather than by oxidation, a SCF containing 0.1 μmole anchored on a circular SCF 35 mm in diameter was immersed in concentrated phenolphthalein solution until no further phenolphthalein was adsorbed from solution (i.e. there was no further drop in absorbance of the phenolphthalein solution). The SCF was then thoroughly rinsed and used for a catalytic bleaching experiment in which the solution volume was 20 mL, buffer was carbonate/bicarbonate (0.01M, pH 10.5), H₂O₂ concentration was 1.0 mM, phenolphthalein concentration was 5 μM, catalyst was ammonium molybdate (0.1 μmole anchored on a circular SCF 35 mm in diameter), the SCF was prepared from two 50 μm coatings of a PVBC polymer cross-linked with 1,6-diaminohexane on a polypropylene backing as described in section 1.3 above, and the stirring speed was 500 rpm. Mole ratios of H₂O₂ phenolphthalein:ammonium molybdate were 200:1.0:1.0.

A plot of absorbance vs time shows the time taken for nearly complete bleaching was slight longer (about 50 minutes for the absorbance to drop close to 0) compared experiments wherein the SCF was not pre-saturated with phenolphthalein, indicating that removal of phenolphthalein from solution by simple adsorption onto the SCF rather than by oxidation was minimal.

### (v) Bleaching by Leached Catalyst

To demonstrate that molybdate was not leached from the SCF during the catalytic oxidation runs and also to demonstrate that the bleaching of phenolphthalein was not catalysed by leached molybdate, a bleaching experiment was carried out as described in section (ii) above, except that the SCF was removed from the solution at 9 minutes and returned at 21 minutes. A plot of absorbance vs time shows a horizontal region between time 9 minutes through to time 21 minutes, showing that no detectable amount of molybdate was leached from the SCF during the oxidation experiment and that essentially all the catalytic oxidation was caused by the SCF. An essentially identical result was obtained for a SCF containing tungstate.

### (vi) Effect on Catalyst of Prolonged Exposure to Hydrogen Peroxide

An experiment was carried out to determine if there is an effect on the activity of the SCF containing molybdate catalyst if it is immersed in hydrogen peroxide solution for a prolonged period prior to carrying out a catalytic oxidation experiment.

A SCF (35 mm in diameter and prepared from two 50 μm coatings of a PVBC polymer cross-linked with 1,6-diaminohexane on a polypropylene backing as described in section 1.3 above) containing ammonium molybdate catalyst (0.1 μmole) was immersed in hydrogen peroxide solution (0.64 mol L⁻¹) for 24 hours. After thorough rinsing, the SCF was then used to carry out a bleaching experiment as described in section (ii) above. A plot of absorbance vs time shows that immersion of the SCF containing molybdate in hydrogen peroxide for an extended period prior to use does not adversely influence the performance of the SCF.

### 2.1.6 Experiments Involving Oxidative Destruction of EE2

The catalytic oxidative destruction of EE2 was carried out according to the general procedure described above. In a typical experiment the solution volume was 20 mL, buffer was carbonate/bicarbonate (0.01M, pH 9.5), H₂O₂ concentration was 1.0 mM, EE2 concentration was 2 ppm (6.76 μM), catalyst was FeB* (either 1.35 nmole or 4.05 μmole anchored on a circular SCF 35 mm in diameter), the SCF was prepared from five 50 μm coatings of a PVBC polymer cross-linked with 1,6-diaminohexane on a polypropylene backing as described in section 1.3 above. Mole ratios of H₂O₂:EE2:FeB* were either 20,000:135:1.35 or 200:1.35:40.5. The stirring speed was 750 rpm and the time of the reaction was either 30 minutes or 10 minutes.

After the set time, the SCF was removed, catalase (1 mg; CAS 9001-05-02 from Sigma) was added and the solution stirred for 30 minutes. Peroxide test strips were used to confirm all the hydrogen peroxide was destroyed after this time.

The solutions were then acidified to pH 3.5 by addition of 4M hydrochloric acid and left to stand a further 1 min. The solution was then filtered by GF 2 glass fibre filter paper and concentrated by solid phase extraction with a 200 mg hydrophilic-lipophilic balance (HLB) cartridge from Water Corp. The cartridges were preconditioned with 10 mL methanol followed by 10 mL milli-Q water before use. The solution was loaded onto the preconditioned cartridge at a flow rate of 10 mL/min. The cartridge was then eluted with 10 mL methanol at a flow rate of 4 mL/min. The eluate was collected and the organic solvent was evaporated to dryness by rotatory evaporation. Methanol (0.50 mL) was added to dissolve the residue and the solution made up to 1.00 mL with mili-Q water and filtered using a nylon membrane filter (0.22 μm pore size/13 mm diameter) and then analysed by HPLC.

### (i) Conditions for HPLC Analysis of EE₂

HPLC instrument used, Shimadzu LC-20AT HPLC with an SPL-20A UV-vis detector; Column (stationary Phase), Accucore XL C18, 150 mm×4.6 mm×4 μm; Guard Column, Accucore XL C18 4 UM; Mobile Phase, Solvent A: mili-Q water acidified with formic Acid (0.1%), Solvent D: mixture of methanol:acetonitrile (1:3); Column temperature, 30° C.; Detector, diode array detector (DAD) at 230 and 217 nm; Flow rate, 0.667 mL/min; Injection volume, 40 μL; Isocratic run, t=0 min (40% mobile phase D, 60% mobile phase A) t=21 min (40% mobile phase D, 60% mobile phase A) t=22 min, stop elution. The retention time for EE2 under these conditions was about 14.5 minutes.

### (ii) Blank Experiments

Blank 1: To test the recovery of EE2 by the SPE method, a solution of EE2 (6.76 μmol) in buffer (20 mL, 0.01M, pH 9.5) was collected by SPE and analysed as described above. After this treatment, 98% of the EE2 had been recovered.
Blank 2: EE2 (2 ppm) in carbonate buffer (20 mL, 0.01M, pH 9.5) was stirred with the SF alone for 30 min. After this treatment, 95% of the EE2 remained unchanged in solution.
Blank 3: EE2 (2 ppm) in carbonate buffer (20 mL, 0.01M, pH 9.5) was stirred with the SCF (containing 10.2 μmol FeB*) alone for 30 min. After this treatment, 85% of the EE2 remained unchanged in solution.
Blank 4: EE2 (2 ppm) in carbonate buffer (20 mL, 0.01M, pH 9.5) was stirred with hydrogen peroxide (1.0 mM) alone for 30 min. After this treatment, 95% of the EE2 remained unchanged in solution.
(iii) Oxidative Destruction of EE2

In one experiment the solution volume was 20 mL, buffer was carbonate/bicarbonate (0.01M, pH 9.5), H₂O₂ concentration was 1.0 mM, EE2 concentration was 2 ppm (6.76 μM), catalyst was FeB* (1.35 nmole anchored on a circular SCF 35 mm in diameter), the SCF was prepared from five 50 μm coatings of a PVBC polymer cross-linked with 1,6-diaminohexane on a polypropylene backing as described in section 1.3 above. Mole ratios of H₂O₂:EE2:FeB* were 20,000:135:1.35. The stirring speed was 750 rpm and the time of the reaction was 30 minutes.

After this treatment and using the analysis method described above, essentially no remaining EE2 was detected, i.e. oxidative destruction of EE2 was very close to 100%. In another experiment the solution volume was 20 mL, buffer was carbonate/bicarbonate (0.01M, pH 9.5), H₂O₂ concentration was 1.0 mM, EE2 concentration was 2 ppm (6.76 μM), catalyst was FeB* (4.05 μmole anchored on a circular SCF 35 mm in diameter), the SCF was prepared from five 50 μm coatings of a PVBC polymer cross-linked with 1,6-diaminohexane on a polypropylene backing as described in section 1.3 above. Mole ratios of H₂O₂:EE2:FeB* were 200:1.35:40.5. The stirring speed was 750 rpm and the time of the reaction was 10 minutes.

After this treatment and using the analysis method described above, essentially no remaining EE2 was detected, i.e. oxidative destruction of EE2 was very close to 100%.

### 2.1.7 Experiments Involving Oxidative Destruction of BPA

In a typical experiment the procedure described above for the oxidation and analysis of EE2 was followed with the following changes. BPA concentration was 2 ppm (8.76 μM), the amount of FeB* catalyst on the SCF was 17.5 nmole, and the time of reaction was 30 minutes. Mole ratios of H₂O₂:BPA:FeB* were 20,000:175:17.5. For the HPLC analysis the diode array detectors (DAD) were set to monitor at 230 and 280 nm. The retention time for BPA was about 10 minutes.

After this treatment, essentially no remaining BPA was detected, i.e. oxidative destruction of BPA was very close to 100%.

### 2.1.8 Experiments Involving Oxidative Destruction of TCS

In a typical experiment the procedure described above for the oxidation and analysis of EE2 was followed with the following changes. TCS concentration was 2 ppm (6.91 μM), the amount of FeB* catalyst on the SCF was 13.8 nmole, and the time of reaction was 30 minutes. Mole ratios of H₂O₂:BPA:FeB* were 20,000:138:13.8. For the HPLC analysis the diode array detector (DAD) was set to monitor at 280 nm; eluent conditions, gradient run, t=0 min (55% mobile phase D, 45% mobile phase A), t=22 min (55% mobile phase D, 45% mobile phase A), t=22 min, stop elution. The retention time for TCS was about 8 minutes.

After this treatment, essentially no remaining TCS was detected, i.e. oxidative destruction of TCS was very close to 100%.

### 2.2 Reactions in U Shaped-Tube Apparatus

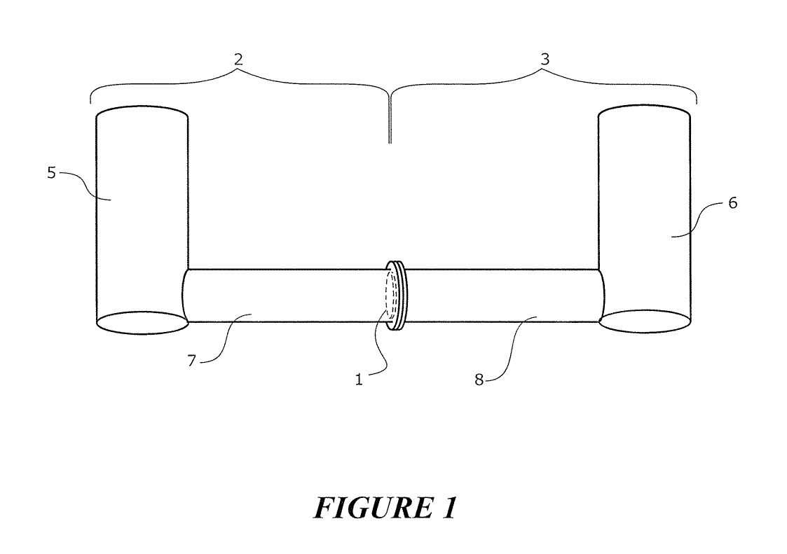

FIG. 1 below is a schematic diagram of a simple apparatus that can be used in the oxidation method described herein. In the apparatus the SCF (1) is used to catalytically oxidize substrates in solution B using oxidant in solution A without gross contamination of the substrate solution (solution B) with the catalyst, oxidant or other components of solution A. The SCF is clamped between two symmetrical arms (2 and 3) and sealed with an O-ring.

Each arm (2, 3) of the U-tube apparatus comprises a reservoir (5, 6) connected via a tube (7, 8) extending from the reservoir to the SCF. An oxidant is provided in the first arm (2). A composition comprising a substrate is provided in the second arm (3).

The SCF is permeable to but separates the source of the oxidant from the substrate to be oxidized. The SCF is oriented so that a surface comprising the immobilized oxidation catalyst and pendant groups having affinity for the substrate faces towards the second arm.

In use, the oxidant in the first reservoir diffuses, or is forced, for example by the application of pressure, for example, hydrostatic pressure, through the membrane.

The oxidant is then available at the surface of the membrane where the substrate is concentrated by the pendant groups and catalyst is immobilized.

In a typical experiment, a hydrogen peroxide solution (solution A) is contained in the first arm. The hydrogen peroxide solution contained hydrogen peroxide, water and the salts added to buffer the solution at the required pH (mixtures of sodium carbonate and sodium bicarbonate to give a total buffer concentration of 0.01 mol L⁻¹). The solution containing the substrate to be oxidised (solution B) is contained in the second arm. The two solutions are prevented from bulk mixing by the SCF. However, the SCF allows the hydrogen peroxide solution to slowly perfuse through it so the hydrogen peroxide reaches the catalyst anchored to the SCF. The rate of perfusion of the hydrogen peroxide solution through the SCF can be controlled by a pressure differential between the two solutions. Where the pressure applied to the hydrogen peroxide solution is higher, hydrogen peroxide solution slowly perfuses through the SCF. Typically in this apparatus the hydrogen peroxide solution in the reservoir of the first arm is maintained at a level above the level of the substrate solution in the reservoir of the second arm, so that the larger hydrostatic pressure of the hydrogen peroxide solution causes perfusion of this solution through the SCF. The U-shaped tube apparatus is designed so that the substrate solution can be stirred by a magnetic stir bar. Experiments were carried out with U-shaped tube apparatuses that had reservoirs for solution A and B of 2 cm, 3 cm or 7 cm in diameter. The 2 cm and 3 cm diameter reservoirs were connected to the membrane by arms 3 cm in diameter and the 7 cm diameter reservoirs connected by 4 cm diameter arms. Most experiments were carried out with the apparatus with 3 cm diameter tubes.

### 2.2.1 Parameters Investigated

The following parameters in the typical experiment described above were investigated.

Catalyst loading on the SCF (SCF circular shape, diameter 35 mm): from 0.15 through to 210 μmoles of catalyst, with catalyst:substrate ratios ranging from 1:10 through to 140:1.
Substrates: Orange II, Pinacynol chloride, Safranine O, Phenolphthalein, EE₂, BPA, and TCS.
Polymer layers: either 2 or 5 coatings of polymer (50 μm each).
Polymer types: PVBC/1,6-diaminohexane cross-linked, PVBC/DVB, and PVBC/Styrene/DVB.
pH of buffer solutions: 7.0, 9.5, 10.5 and 11.0. All 0.01M HCO₃⁻/CO₃²⁻ or phosphate buffer solutions.
Catalysts: FeB*,FeB^{J}, sodium tungstate, and ammonium molybdate.
Backing for formation of SCF: PP (polypropylene) or PE (polyester).
Stirring rates: 100-1000 rpm.
Hydrostatic pressure on SCF: Height differentials between solutions A and B of 140 mm and 50 mm, and 2-19 cm
Concentration of H₂O₂: 0.01 mM-10 mM

### 2.2.2 Experiments Involving Oxidative Bleaching of Orange II

### (i) Blank Experiments

1. No catalyst present. Solution B: 30 mL of orange II (50 μmol L⁻¹, distilled water, pH 7.0); Solution A: hydrogen peroxide (100 mL, 1.0 mmol L⁻¹, 0.01 mol L⁻¹ carbonate buffer pH 11.0), SF. Result: absorbance of orange II solution drops from 1.0 to 0.8 after 120 minutes.
2. No hydrogen peroxide present. Solution B: 30 mL of orange II (50 μmol L⁻¹, distilled water, pH 7.0); Solution A: buffer solution (100 mL, 0.01 mol L⁻¹ carbonate buffer pH 11.0), SCF incorporating 1.5 μmol of FeB*. Result: absorbance of orange II solution drops from 1.0 to 0.8 after 120 minutes.

### (ii) Oxidative Bleaching of Orange II

In a typical experiment the SCF (35 mm diameter circular shape) was clamped between the two halves of the U-shaped tube. The SCF was prepared from five 50 μm layers of PVBC (cross-linked with 1,6-diaminohexane) on a polypropylene backing as described above in section 1.3. 210 μmole of FeB* catalyst was incorporated on the SCF. The second arm of the U-shaped tube contained orange II solution (50 μM) (Solution B) in deionized water (pH 7.0, 30 mL) and the first arm of the U-shaped tube contained hydrogen peroxide (1.0 mM) in 0.01M buffer solution (pH 11, 100 mL) (Solution A). The mole ratio of orange II to FeB* anchored on the SCF was 1:140. The orange II solution was stirred at 1000 rpm. The absorbance of the orange II solution was monitored at set time intervals. A plot of absorbance vs time shows it took approximately 45 minutes for the absorbance to drop to essentially zero. After the reaction was complete (45 minutes) the pH of the solution that contained the orange II was measured. Due to perfusion of hydrogen peroxide and buffer (pH 11) solution through the SCF in this reaction, the pH of the solution that contained the orange II after completion of the reaction was greater than 7.0, but in all runs using these conditions, was less than 8.0.

(iii) Effect of pH

In another experiment the same conditions as above were used except both the orange II and hydrogen peroxide were dissolved in 0.01M buffer solution at pH 11. In this experiment it took 30 minutes for the absorbance to drop to essentially zero.

In hydrogen peroxide oxidation reactions of orange II that are catalysed by FeB* in homogeneous solution, the rate of oxidation of orange II at pH 11 is many orders of magnitude faster than reactions at pH 7.

In another experiment the same conditions as above were used except both the orange II and hydrogen peroxide were dissolved in 0.01M phosphate buffer solution at pH 7.0 and the mole ratio of FeB* to orange II was 80:1 (120 μmole of FeB* was incorporated into the SCF). In this instance after 30 minutes the absorbance dropped to 0.8, which was almost the same drop that was observed for the blank reaction in the U shaped-tube where Solution A was water (pH 7) and Solution B was orange II solution (50 μM, pH 7).

### 2.2.3 Oxidation of Safranine O

In a typical experiment the conditions were exactly as described above for orange II oxidation, except that the dye used was safranine O (50 μM solution).

Again, experiments were carried out with the substrate (dye) solution at pH 7.0 and the hydrogen peroxide solution at pH 11.0 as well as both solutions at pH 11.0. In both instances it took the same time (60 minutes) to achieve essentially complete bleaching.

### 2.2.4 Effect of Stirring Speed on Rate of Oxidation of Orange II

Experiments were carried out to determine the effect stirring speed has on rate of oxidation of orange II in the U shaped-tube experiments.

The SCF used was prepared from two 50 μm layers of PVBC (cross-linked with 1,6-diaminohexane) on a polypropylene backing as described in section 1.3 above. Incorporated in the SCF was 120 μmole of FeB* catalyst. The second arm of the U shaped-tube contained orange II solution (50 μM) in 0.01M buffer solution (pH 11.0, 30 mL) and the first arm of the U shaped-tube contained hydrogen peroxide (1.0 mM) in 0.01M buffer solution (pH 11, 100 mL). The substrate solution was stirred at speeds between 100 and 1000 rpm in separate experiments. The mole ratio of orange II to FeB* anchored on the SCF was 1:80. A plot of the time required for full bleaching at each stirring rate shows that the rate of oxidation increases with the stirring speed, but the effect noticeably levels off around a stirring speed of 1000 rpm. This indicates that the rate of transfer of the substrate to the SCF may impact on the oxidation rate at lower stirring speeds.

### 2.2.5 Effect of Hydrostatic Pressure by Solution A on the SCF

Experiments were carried out to determine the effect of varying hydrostatic pressure on the SCF on the rate of oxidation of orange II in the U shaped-tube experiments.

The SCF used was prepared from two 50 μm layers of PVBC (cross-linked with 1,6-diaminohexane) on a polypropylene backing as described in section 1.3 above. Incorporated in the SCF was 120 μmole of FeB* catalyst.

In a first experiment, a hydrogen peroxide solution (solution A: 100 mL, 1.0 mM, 100 μmole, made up in carbonate/bicarbonate buffer, pH 9.5, 0.01M) was contained in the first arm. The solution containing the Orange(II) substrate to be oxidised (solution B: 30 mL, 50 μM, 1.50 μmole, made up in phosphate buffer, pH 7.0, 0.01M) was contained in the second arm. Solution B was stirred at 1000 rpm.

The height differential between solutions A and B at the start of the experiment was 140 mm, reduced to 134 mm after 120 minutes (i.e. about 1.5 mL of hydrogen peroxide solution containing about 1.5 μmole H₂O₂ passed through the film). A plot of the time required for full bleaching shows that the Orange(II) solution was essentially fully bleached after about 135 minutes during the first run extending to >180 minutes for complete bleaching by the fourth run.

In a second experiment, the same conditions as the first experiment were used except the starting height differential between solutions A and B was 50 mm.

Almost complete bleaching was achieved after about 275 minutes. At this point the height differential between the two solutions was reduced to 44 mm, after about 1.5 mL of hydrogen peroxide solution (containing about 1.5 μmole H₂O₂) had passed through the film. The rate of oxidation of the dye was slower during the second experiment in which the rate of perfusion of oxidant was slower.

In further experiments, the same conditions were used except the height differential between solutions A and B was 20 mm, 80 mm or 190 mm.

Solution A comprised hydrogen peroxide in carbonate buffer (pH 9.5, 0.01M) and solution B comprised Orange(II) in phosphate buffer (30 mL, 0.01M, pH 7.0) was contained in the second arm.

All the results are summarised in Table 2.

TABLE 2
Effect on oxidative bleaching of orange (II) when the hydrostatic
head of the peroxide solution is varied.

| | | | Height | Time for complete |
|---|---|---|---|---|
| Run | Orange (II) | FeB* | difference | bleaching (minutes) |
| 1 | 1.5 μmole | 120.0 μmole | 2.0 cm | 280 |
| 2 | 1.5 μmole | 120.0 μmole | 5.0 cm | 275 |
| 3 | 1.5 μmole | 120.0 μmole | 8.0 cm | 190 |
| 4 | 1.5 μmole | 120.0 μmole | 14.0 cm | 135 |
| 5 | 1.5 μmole | 120.0 μmole | 19.0 cm | 130 |

2.2.6 Effect of Concentration of H₂O₂

Experiments were carried out to determine the effect of varying the concentration of H₂O₂ on the rate of oxidation of orange II.

The same conditions were used as described in 2.2.5 above except that the concentration of the H₂O₂ solution was reduced to 0.10 mM. Thus, one arm of the apparatus contained the Orange II solution (solution B: 30 mL, 50 μM, 1.50 μmole, made up in phosphate buffer, pH 7.0, 0.01M); and the other arm contained the H₂O₂ solution (solution A: 100 mL, 0.10 mM, 10 μmole, made up in carbonate/bicarbonate buffer, pH 9.5, 0.010M). Incorporated in the SCF was 120 μmole of catalyst (FeB*, 120.0 μmole adsorbed onto functionalised film, circle 35 mm diameter)). The magnetic stir-bar stirring speed in the Orange(II) solution was 1000 rpm.

The height differential between solutions in the two arms at the start was 140 mm and after about 300 minutes was 134 mm (i.e. about 1.5 mL of the solution containing the hydrogen peroxide passed through the film). The Orange(II) solution was fully bleached after about 300 minutes during the first run and this was reproduced during the second run indicating the catalyst underwent much less decomposition under these conditions.

Further experiments were carried out under the same conditions with the concentration of H₂O₂ varied as shown in Table 3. Solution A comprised varying concentrations of H₂O₂ made up in carbonate/bicarbonate buffer (pH 9.5, 0.01M). Solution B comprised orange(II) in phosphate buffer (pH 7.0, 0.01M).

The time to complete bleaching was determined by plotting absorbance over time. The results are shown in Table 3.

TABLE 3
Oxidative bleaching of orange (II) at different H₂O₂
concentrations.

| | | | | Time for complete |
|---|---|---|---|---|
| Run | Orange (II) | FeB* | H₂O₂ | bleaching (minutes) |
| 1 | 1.5 μmole | 120.0 μmole | 0.01 mM | 400 |
| 2 | 1.5 μmole | 120.0 μmole | 0.1 mM | 300 |
| 3 | 1.5 μmole | 120.0 μmole | 0.5 mM | 200 |
| 4 | 1.5 μmole | 120.0 μmole | 1.0 mM | 115 |
| 5 | 1.5 μmole | 120.0 μmole | 5.0 mM | 115 |
| 6 | 1.5 μmole | 120.0 μmole | 10.0 mM | 75 |

### 2.2.9 Bleaching of Phenolphthalein by SCF Containing Ammonium Molybdate

The oxidative bleaching of phenolphthalein was carried out in the U-shaped tube apparatus. In a typical experiment, the H₂O₂ concentration was 1.0 mM in buffer solution (carbonate/bicarbonate, 100 mL, 0.01M, pH 10.5) (solution A), phenolphthalein concentration was 5 μM in buffer solution (carbonate/bicarbonate, 30 mL, 0.01M, pH 10.5) (solution B), catalyst was ammonium molybdate (2.0 μmole anchored on a circular SCF 35 mm in diameter, the SCF was prepared from two 50 μm coatings of a PVBC polymer cross-linked with 1,6-diaminohexane on a polypropylene backing as described in section 1.3 above, and the stirring speed of the phenolphthalein solution was 1000 rpm. Mole ratio of phenolphthalein:ammonium molybdate was 1.0:13.3.

The absorbance of phenolphthalein slowly decreased over time.

### 2.2.10 Oxidative Destruction of EE2, BPA and TCS Using the U-Tube Apparatus

### (i) Blank Experiments

1. An experiment was set up in the 3 cm diameter U-tube. A SF (no catalyst present) was clamped between the two arms of the U-shaped tube apparatus. Buffer (30 mL, carbonate, 0.01M, pH 9.5) placed in the first arm and buffer (30 mL, carbonate, 0.01M, pH 9.5) containing EE2 (2 ppm, 6.67 μmol) was placed in the second arm and the EE2 solution stirred at 1000 rpm for 30 minutes. After this treatment, the EE2 was collected by SPE and analysed by HPLC as described above. Analysis showed 97% of the EE2 was recovered. Similarly, approximately 97% of BPA and TCS were recovered from solution from equivalent experiments.
2. An experiment was carried out using the same conditions above in 1 except a SCF containing FeB* (50 μM) was used. After collection, analysis showed 85% of the EE2 remained unchanged.
3. An experiment was carried out using the same conditions above in 2 except that BPA (2 ppm, 8.76 μM) was used in place of EE2. After collection, analysis showed 95% of the BPA remained unchanged in solution.
4. An experiment was carried out using the same conditions above in 2 except that TCS (2 ppm, 6.91 μM) was used in place of EE2. After collection, analysis showed 95% of the TCS remained unchanged in solution.

### (ii) Oxidative Destruction of EE2.

The oxidative destruction of EE2 was explored using the U-shaped tube apparatus. In a typical oxidative destruction experiment a SCF was fixed between the arms of the 3 cm diameter U-shaped tube. The SCF was prepared from five 50 μm coatings of a PVBC polymer cross-linked with 1,6-diaminohexane on a polypropylene backing as described in section 1.3 above and contained FeB* (20 nmole). The substrate solution volume was 30 mL and contained EE2 (2 ppm, 6.76 μM) in deionized water (pH 7.0). The oxidant solution contained H₂O₂(1.0 mM) in carbonate/bicarbonate buffer (100 mL, 0.01M, pH 11.0). The mole ratio of EE2 to FeB* was 1:10. The stirring speed of the substrate solution was 1000 rpm and the time of the reaction was either 30 or 10 minutes. After the treatment the substrate solutions were concentrated by SPE and analysed by HPLC as described above.

The HPLC trace for the 30 minute reaction shows that essentially no remaining EE2 was detected, i.e. oxidative destruction of EE2 was very close to 100%. For the experiment with a 10 minute reaction time, 66% of the EE2 remained unchanged.

(iii) Oxidative Destruction of BPA.

The oxidative destruction of BPA was explored using the U-shaped tube apparatus. In a typical experiment a SCF was fixed between the arms of the 3 cm diameter U-shaped tube. The SCF was prepared from five 50 μm coatings of a PVBC polymer cross-linked with 1,6-diaminohexane on a polypropylene backing as described above and contained FeB* (26 nmole). The substrate solution volume was 30 mL and contained BPA (2 ppm, 8.76 μM) in deionized water (pH 7.0). The oxidant solution contained H₂O₂(1.0 mM) in carbonate/bicarbonate buffer (100 mL, 0.01M, pH 11.0). The mole ratio of BPA to FeB* was 1:10. The stirring speed of the substrate solution was 1000 rpm and the time of the reaction was 30 minutes. After the treatment the substrate solutions were concentrated by SPE and analysed by HPLC as described above. The HPLC trace shows that practically all the BPA had been oxidatively destroyed after the 30 minute reaction time.

(iii) Oxidative Destruction of TCS.

The oxidative destruction of TCS was explored using the same U-shaped tube apparatus. In a typical experiment a SCF was fixed between the arms of the 3 cm diameter U-tube. The SCF was prepared from five 50 μm coatings of a PVBC polymer cross-linked with 1,6-diaminohexane on a polypropylene backing as described above and contained FeB* (21 nmole). The substrate solution volume was 30 mL and contained TCS (2 ppm, 6.91 μM) in deionized water (pH 7.0). The oxidant solution contained H₂O₂(1.0 mM) in carbonate/bicarbonate buffer (100 mL, 0.01M, pH 11.0). The mole ratio of TCS to FeB* was 1:10. The stirring speed was 1000 rpm and the time of the reaction was 30 minutes. After the treatment the substrate solutions were concentrated by SPE and analysed by HPLC as described above. The HPLC trace shows that practically all the TCS was oxidatively destroyed after the 30 minute reaction time.

### 2.3 Experiments Using Cross-Flow Device

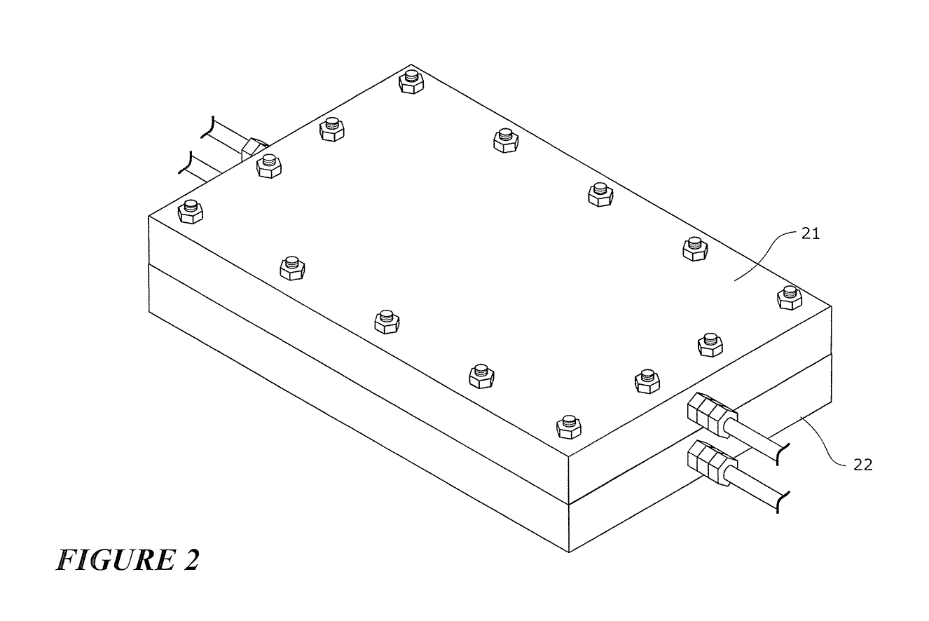

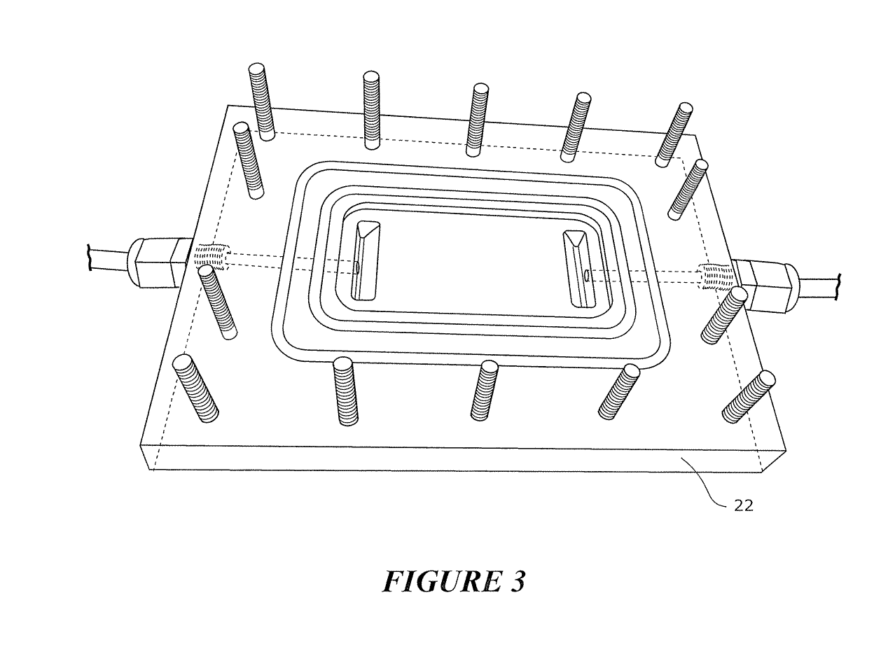

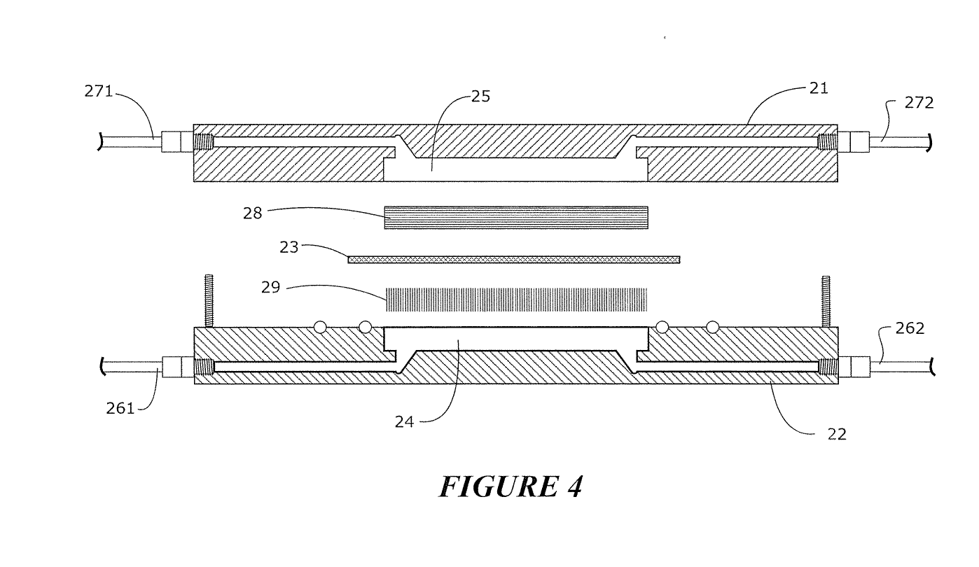

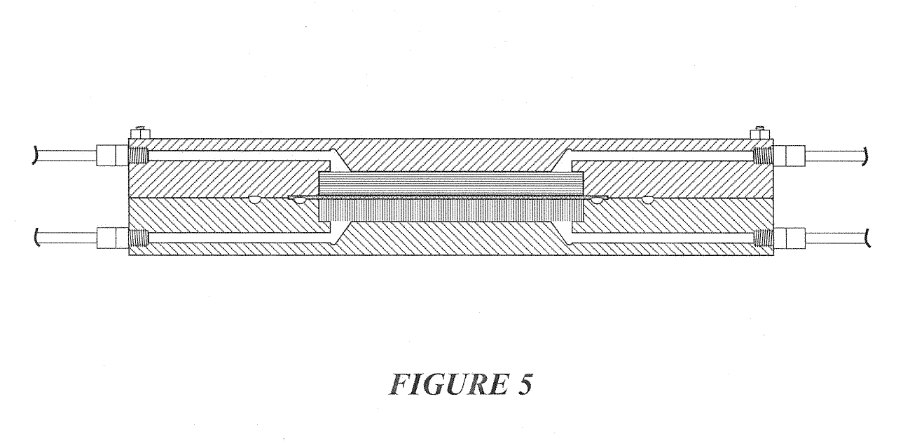

The oxidation of substrates was also carried out using the SCF in the cross-flow apparatus illustrated in FIGS. 2-5. In this apparatus the solution containing the substrate to be oxidised flows over the SCF while the solution containing the oxidant is held in a chamber beneath the film.

The apparatus comprises two parts (21, 22) that are fixed together to form the housing of the device.

A SCF in the form of a membrane (23) is used. The membrane is permeable to a composition comprising the oxidant.

The membrane is positioned in the apparatus between the two parts of the housing to separate a first chamber (24) and a second chamber (25). A seal is formed around the perimeter of the membrane by the housing. The membrane is oriented such that a surface of the membrane that comprises immobilized oxidation catalyst and pendant groups having affinity for the substrate faces towards the second chamber.

The first chamber comprises a composition comprising an oxidant (hydrogen peroxide in the examples below). The composition comprising the oxidant can be provided in the first chamber via an inlet (261) and removed via an outlet (262).

In use, a composition comprising one or more substrates to be oxidised enters the second chamber via inlet (271). The composition comprising the substrate is flowed over the membrane and exits the second chamber via outlet (272).

An insert (28), which may be in the form of a mesh, is positioned in the second chamber to increase the turbulence of the flowing substrate composition to increase the rate of transport of the substrate to the surface of the membrane.

Examples of inserts that may be used are described herein in the Examples.

A support (29) may be placed in the first chamber to support the membrane and maintain contact of the membrane with the insert.

The oxidant in the first chamber diffuses through the membrane. A pressure differential may be applied across the membrane to facilitate perfusion of the oxidant composition across the membrane to contact the oxidant, immobilised oxidation catalyst and the substrate. A composition comprising the oxidised substrate exits the device via outlet (272).

### 2.3.1 Oxidation of Orange II

In a typical experiment the SCF was clamped between the two halves of the cross-flow apparatus. The SCF was prepared as described in section 1.3 above from five 50 μm coatings of a PVBC polymer cross-linked with 1,6-diaminohexane on a polypropylene backing and contained FeB* (10 nmole). Hydrogen peroxide oxidant solution (1.0 mM) in carbonate/bicarbonate buffer (0.01M, pH 11.0) filled the bottom chamber of the cross-flow apparatus. This solution was placed under hydrostatic pressure by raising the reservoir of hydrogen peroxide solution 20 cm above the SCF. A solution containing orange II as the substrate (50 μM) in deionized water (pH 7.0) was then pumped at a rate of 5.0 mL/minute through the top chamber of the cross-flow apparatus. A plastic mesh (the second mesh described below) was placed in the flow path of the orange II solution to increase the turbulence of the flow. The dimensions of the SCF exposed to the flowing orange II solution was 4 cm×9 cm. Under these conditions the initial absorbance of the orange II solution was 1.05 and the absorbance of the solution exiting the apparatus was 0.15. This indicates that approximately 85% of the dye was oxidised during this one pass through the apparatus. Therefore, under these conditions, the 36 cm² SCF treated 5 mL of solution per minute.

In a blank run under the same conditions but with no catalyst present, the absorbance of the dye solution dropped about 10% over the first hour and then remained constant for the remaining 5 hours.

### 2.3.2 Oxidation of EE2

The catalytic experiment in section 2.3.1 above was repeated under the same conditions except that the substrate used was EE2 (2 ppm, 6.76 μM) in deionized water (pH 7.0). The solution exiting the apparatus was collected and analysed as described above. The HPLC trace obtained indicated that in the exiting solution no EE2 could be detected. Thus, under these conditions, essentially all of the EE2 was oxidatively destroyed.

### 2.3.3 Oxidation of Different Dyes

The catalytic experiment in section 2.3.1 above was repeated under the same conditions except that the substrate dye pinacynol chloride was used. The rate of oxidation of pinacynol chloride is much faster than the rate of orange(II) when catalysed by FeB* in homogeneous solution. However, in this case the flow-rate before the absorbance of the exiting dye solution became greater than 0.1 (absorbance of initial dye solution was 1.0) was 6 mL/min, whereas for orange (II) it was only slightly slower at 5 mL/min. This indicates that the rate of dye oxidation by the immobilised catalyst is not the slowest step in this process.

### 2.3.4 Different Amounts of Adsorbed Catalyst

The catalytic experiment in 2.3.1 above was repeated under the same conditions except that the amount of adsorbed catalyst was increased to 140 μmole (14 times more than in section 2.3.1 above). In this case the flow rate could be increased to 7 mL/min before the absorbance of the exiting dye solution became greater than 0.1 (absorbance of initial dye solution was 1.0). This shows that the rate of dye oxidation by the immobilised catalyst is only slightly increased by increasing the amount of catalyst 14 times and so the amount of catalyst is not the rate-determining factor. Exactly the same result was obtained when pinacynol chloride was used as the dye (i.e. a significant amount of unoxidised dye in the solution exiting the apparatus at a flow rate of 7 mL/min), again indicating that the rate of dye oxidation by the immobilised catalyst is not the slowest step in this process.

### 2.3.5 Different Mesh Geometries

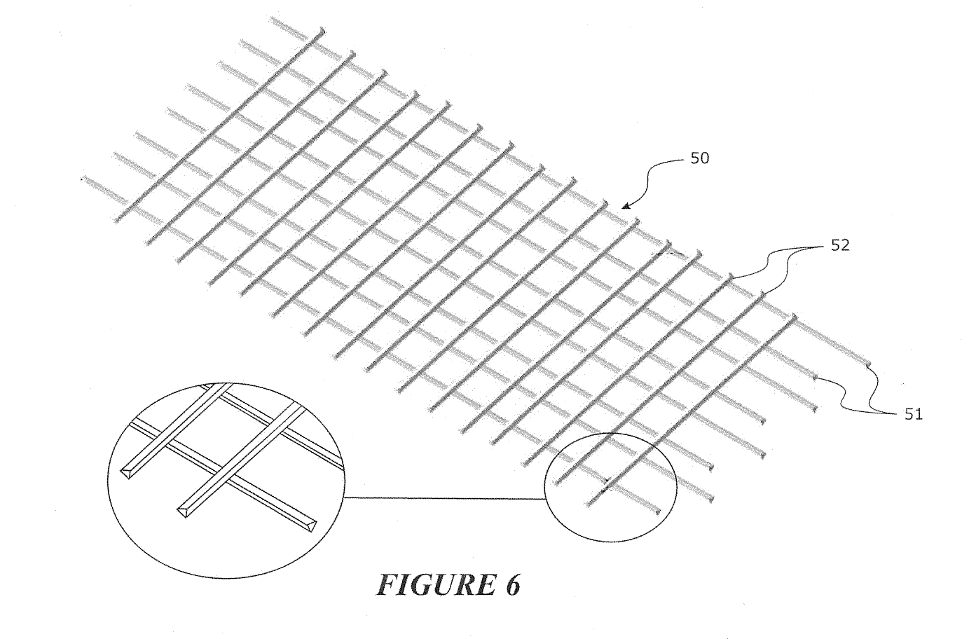

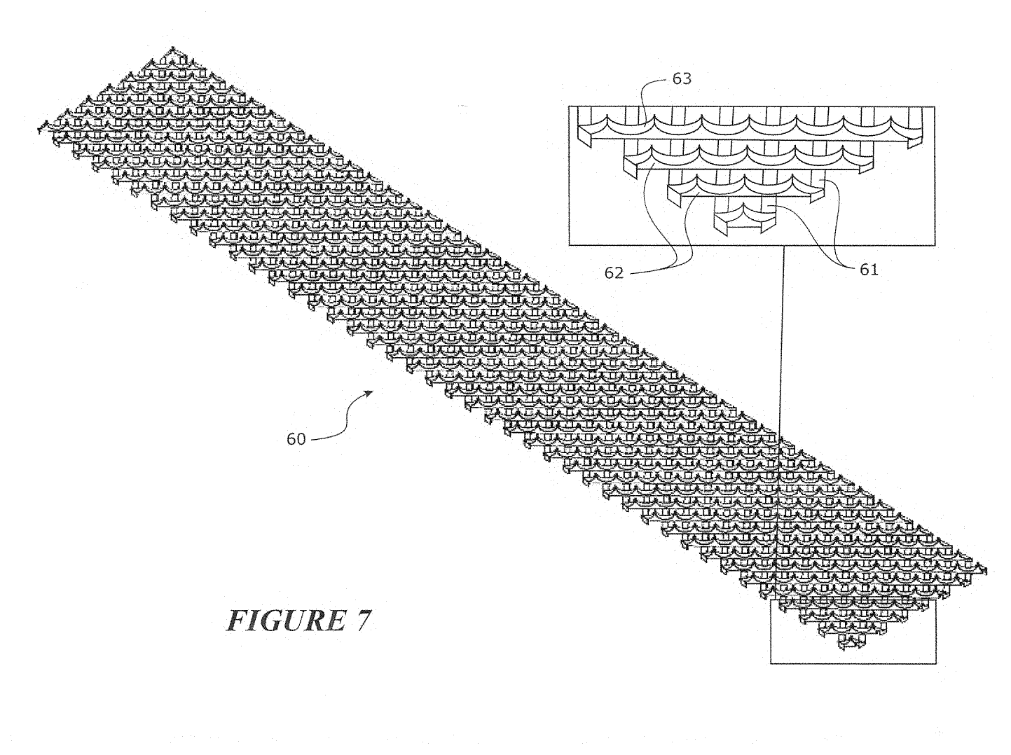

The catalytic experiment in section 2.3.1 above was repeated under the same conditions except that the second mesh was replaced by a first mesh or no mesh was used. The first mesh (50) and second mesh (60) are shown in FIGS. 6 and 7 respectively.

With no mesh the flow rate at which the absorbance of the exiting dye solution became greater than 0.1 (absorbance of initial dye solution was 1.0) was <0.5 mL/min.

With a first mesh, the flow rate at which the absorbance of the exiting dye solution became greater than 0.1 (absorbance of initial dye solution was 1.0) was >ca.3.0 mL/min

With a second mesh the flow rate at which the absorbance of the exiting dye solution became greater than 0.1 (absorbance of initial dye solution was 1.0) was >ca.7.0 mL/min.

The first mesh (50) comprises a net like structure comprising a first layer of regularly spaced rods (51) and second layer of regularly spaced rods (52) on top of and aligned perpendicular to the rods of the first layer. The shape of each rod of the first layer and each rod of the second layer is substantially the same. The rods of the first layer are longitudinally aligned with the direction of flow in the cross flow device.

The second mesh (60) comprises a first layer of regularly spaced rods (61) and second layer of regularly spaced rods (62) on top of and aligned perpendicular to the rods of the first layer. The rods of the second layer comprise regularly spaced scoops (63). The rods of first and seconds layers are aligned at about a 45 degree angle to the direction of flow in the cross flow device.

### 2.3.6 Increasing the Size of the Flow Chamber

A cross-flow device analogous to that described above, but having a flow chamber approximately two times longer and 25% narrower (3 cm×18.5 cm of membrane exposed to solutions) was constructed.

In a typical experiment using this device, the SCF was clamped between the two halves of the cross-flow apparatus as before. The SCF was prepared from five 50 μm coatings of a PVBC polymer cross-linked with 1,6-diaminohexane on a polypropylene backing as described in section 1.3 above and contained FeB* (160 μmole). Hydrogen peroxide oxidant solution (1.0 mM) in carbonate/bicarbonate buffer (0.01M, pH 9.5) filled the bottom chamber of the cross-flow apparatus. This solution was placed under hydrostatic pressure by raising the reservoir of hydrogen peroxide 20 cm above the SCF. A plastic mesh (the second mesh described above) was placed in the flow path of the orange II solution to increase the turbulence of the flow. The dimensions of the SCF exposed to the flowing orange II solution was 3 cm×18.5 cm. The solution containing the orange II substrate (50 μM) in deionized water (pH 7.0) was pumped at a range of rates through the top chamber of the cross-flow apparatus to determine the flow rate at which the absorbance of the exiting dye solution became greater than 0.1 (absorbance of initial dye solution was 1.0). This occurred at a rate of ca. 5.0 mL/minute.

### Different Mesh

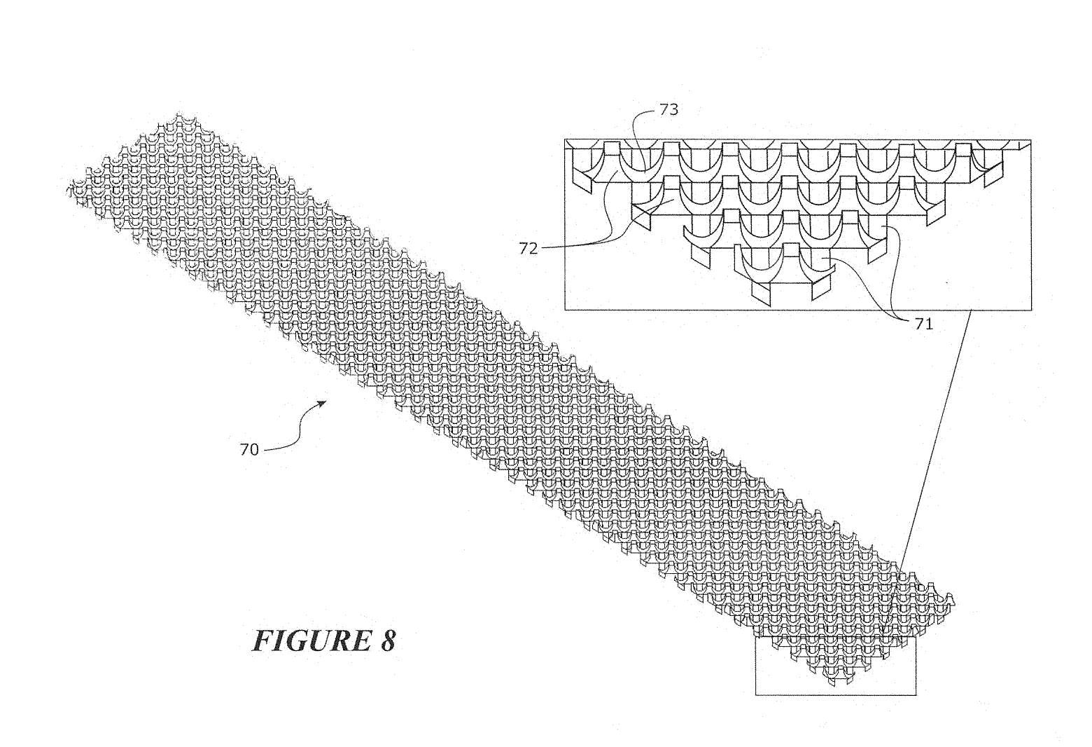

The experiment described in section 2.3.6 above was then repeated but with a third mesh, as shown in FIG. 8, in the flow path. In this case the absorbance of the exiting solution was less than 0.1 (absorbance of initial dye solution was 1.0) even at the faster pumping rate of 10 mL/min.

The third mesh (70) has a similar structure to the second mesh, comprising a first layer of regularly spaced rods (71) and second layer of regularly spaced rods (72) on top of and aligned perpendicular to the rods of the first layer. The rods of the second layer comprise regularly spaced scoops (73), but the scoops of the second mesh are deeper that the third mesh. The scoops of the third mesh are more oblate or elliptical in shape, such that the surface contacting the SCF was slightly larger.

The rods of first and seconds layers are aligned at about a 45 degree angle to the direction of flow in the cross flow device, but compared to the second mesh the rods in the third mesh are spaced closer together.

### 2.3.7 Different Catalysts

In repeating the experiments described above and in section 2.3.1 above using FeB^{J} as the catalyst rather than FeB*, almost no difference in performance was observed.

### 2.3.8 Volume of Dye Solution Bleached

The total volume of dye solution that can be bleached was found to depend on the pH of the hydrogen peroxide solution (greater volume of dye solution bleached at lower pH (ca. 8)), the concentration of the hydrogen peroxide (greater volume of dye solution bleached at lower concentration), the hydrostatic head (greater volume of dye solution bleached at lower head), and concentration of the dye (greater volume of dye solution bleached at lower concentration).

Results using hydrogen peroxide 0.01 mol L⁻¹ at a pH of 8.5, 1,400 μmol of FeB*, a hydrostatic head of ca. 30 cm and an Orange (II) dye concentration of 5 μM:
after passing through the device described in section 2.3.6 1000 mL of dye solution over a 3.3 hour period, ca 70% of the dye was still being bleached.

Changing the amount of adsorbed catalyst from 700 to 1,400 μmol had very little effect on the results.

### 2.3.9 Flow Rate

An experiment to determining the maximum flow rate before unbleached dye exits the cross-flow device described in section 2.3.6 was carried out. The amount of was FeB* 160 μmol, concentration of hydrogen peroxide was 1.0 mmol L⁻¹, concentration of orange(II) dye was 50 μmol L⁻¹⁻, pH of the dye was 7.0, pH of the hydrogen peroxide solution was 11 (0.01 mol L⁻¹ carbonate buffer). The first signs of unbleached dye appear at flow rate of about 7 mL/min.

### 2.3.10 Effect of Oxidant Concentration and pH

The concentration of hydrogen peroxide and the pH of the hydrogen peroxide influence the performance of the SCF.

The performance of SCF in the cross-flow device described in section 2.3.6 was then evaluated with orange(II) dye running through at 5 mL/min. The pH of the dye was 7.0, pH of hydrogen peroxide 8.5 (in 0.01 mol L⁻¹ carbonate/bicarbonate buffer solution), concentration hydrogen peroxide 0.01 mmol L⁻¹, concentration of orange(II) dye concentration is 5 μmol L⁻¹, amount of adsorbed catalyst 160 μmol. After passing 500 mL of solution the absorbance is about 0.01.

If the experiment is repeated, but the concentration of hydrogen peroxide used in the experiment is 0.1 mol L⁻¹ and the pH 8.0 then the absorbance of the exiting solution rises to 0.04 after passing only 500 mL of solution.

If the experiment is repeated, but the concentration of hydrogen peroxide used in the experiment is 0.1 mol L⁻¹ and the pH 9.5 then the absorbance of the exiting solution rises to 0.05 after passing only 500 mL of solution.

### III. Preparation of Catalytic Films Comprising Polymer Blends and Use of the Films for the Oxidation of Substrates

### 1. Films Comprising a Blend of Cross-Linked Polystyrene and Polyvinylbenzyl Chloride (1:1 by Weight).

### 1.1 Synthesis of Polymers

### 1.1.1 Synthesis of Cross-Linked Polystyrene

Inhibitor-free styrene (19.0 mL) was added to a Schlenk tube together with divinylbenzene (0.19 mL, 1%). The Schlenk tube was placed under a nitrogen atmosphere and heated in an oil bath at 85° C. until the solution became viscous (ca. 0.035 Pa s, usually after about 16 hours). After cooling to ambient temperature, the viscous liquid was dissolved in NMP (10 mL) and then excess ethanol added to precipitate the polymer as a white powder which was collected by filtration.

### 1.1.2 Synthesis of Polyvinylbenzyl Chloride (PVBC)

PVBC was produced as described in section 11.1.3 above.

### 1.2 Preparation of Catalytic Film

### 1.2.1 Casting and Curing Film

The cross-linked polystyrene (0.70 g) and polyvinylbenzyl chloride (0.70 g) were dissolved in NMP (10 mL) and the solution stirred for 2 days. The resulting viscous solution was then cast as a thin film (150 μm thick) on to a polypropylene backing sheet (15 cm by 15 cm) using an Elcometer 4340 thin film applicator incorporating a 4340 doctor blade at a casting speed of 5.3 mm s⁻¹. The cast film and backing were immediately immersed in a bath containing n-hexane (200 mL) at ambient temperature and left to stand for 30 min before being removed, briefly air dried and then transferred into a bath containing deionized water (200 mL) where it was left to stand for another 30 min.

The film was removed and cured in an oven at 85° C. for 5 hours. The casting, immersion and curing process was repeated once more to this same sample to form a film with a total nominal thickness of 300 μm.

1.2.2 Functionalization of the Polymer with Molecular Brushes

The cast film of the polymer blend was functionalized as follows.

The film on the polypropylene backing was first immersed and heated in a solution of N,N-dimethylhexadecylamine (60 v/v %) in 1,4-dioxane at 85° C. for 5 hours to convert the majority of the chloromethyl groups to quaternary ammonium groups [—CH₂N(CH₃)₂C₁₆H₃₃]⁺. The film was removed, washed with water and dried.

### 1.2.3 Cross-Linking PVBC Polymer Chains

The quaternized cast film was immersed in a solution of 1,6-diaminohexane (40 v/v %) in 1,4-dioxane and heated at 85° C. for 5 hours to cross-link some of the PVBC chains. The film was removed, washed with water and dried.

### 1.2.4 Capping Unreacted Groups

The resulting cast film was immersed in diethanolamine (30 mL) and heated at 85° C. for 5 hours to functionalise (end cap) any remaining chloromethyl groups. The film was removed, washed with water and dried to produce a solid phase film (SF).

### 1.2.5 Addition of Oxidation Catalysts to the SF to Produce the Solid Phase Catalytic Film (SCF)

The solid phase film was treated with the catalyst FeB* (described in section (I) 6.1 above) to immobilise the catalyst on the polymer film to form a solid phase catalytic film (SCF).

A sample of the dry, cast and functionalised SF (a circle of diameter 35 mm) was immersed in a gently stirred solution of FeB* (20 mL of a 0.5 mM solution made up in 0.01M carbonate/bicarbonate buffer, pH 9.5) for 12 hours to form the SCF. The SCF was removed, washed with deionised water and immersed in 20 mL of 0.01M carbonate/bicarbonate buffer solution (pH 9.5) for 30 minutes (repeated three times).

The amount of FeB* remaining in the original FeB* solution after removal of the film, and the amount of FeB* leached from the film on each subsequent immersion in the buffer solutions was measured. No measurable amount of FeB* (<ca 0.1 nM FeB* in leaching buffer solution) leached into the fourth buffer solution. The total amount of FeB* that either did not adsorb onto the film or subsequently leached from the film upon standing in the buffer solutions was 0.074 μmole (ca. 0.74% of that present in the original solution).

### 1.3 Oxidation of Substrates Using SCF

### 1.3.1 Reactions in Beaker Apparatus

Oxidation reactions were carried out in a beaker containing an SCF of 111.1.2.5 immersed in a solution, according to the method described in section 11.2.1 above.

The oxidative bleaching of orange II was carried out according to the general procedure described above in section 11.2.1.1 above.

The solution volume was 20 mL, buffer was carbonate/bicarbonate (0.01M, pH 9.5), H₂O₂ concentration was 1.0 mM, orange II concentration was 50 μM, catalyst was FeB* (10 μmoles anchored on a circular SCF 35 mm in diameter). Mole ratios of H₂O₂:orange II:FeB* were 20:1.0:10.

Multiple bleaching experiments were performed as described in section II.2.1.3(iii) above.

Time for complete bleaching at pH 9.5 was 8 minutes for the first few runs, increasing to about 12 minutes after 10 consecutive runs.

### (i) Bleaching by Leached Catalyst

To demonstrate that the catalytic bleaching was carried out by the SCF, and not by catalyst leached into the solution from the SCF, oxidative bleaching runs were carried out in which the SCF was removed from solution at time four minutes during the 11^{th} bleaching run and then returned to the solution at time 14 minutes.

Bleaching was determined as described in II.2.1.3(vii) above. The plot for absorbance vs time when the SCF was removed from the solution was substantially horizontal, indicating that no bleaching took place. This result demonstrates that only catalyst on the film catalysed the bleaching reaction.

### 1.3.2 Reactions in U Shaped-Tube Apparatus

Oxidation reactions were carried out in a U shaped-tube apparatus, according to the method described in section 11.2.2 above. A hydrogen peroxide solution (solution A: 100 mL, 1 mM, 100 μmole, made up in carbonate/bicarbonate buffer, pH 9.5, 0.01M) was contained in the first arm. The solution containing the Orange(II) substrate to be oxidised (solution B: 30 mL, 50 μM, 1.50 μmole, made up in phosphate buffer, pH 7.0, 0.01M) was contained in the second arm. The two solutions were prevented from bulk mixing by an SCF of 111.1.2.4 (30.0 μmole FeB* adsorbed onto functionalised film, circle 35 mm diameter).

The height differential between solutions A and B at the start was 140 mm, and 134 mm after 110 minutes. Solution B was stirred at 1000 rpm.

The absorbance of solution B was monitored at set time intervals. A plot of absorbance vs time shows it took approximately 110 minutes for the absorbance to drop to essentially zero.

### 2. Films Comprising a Blend of Polyvinylbenzyl Chloride (PVBC) and Polyaniline (PANI) (ca. 70:30 by Weight).

For this film, the PVBC is pre-functionalised before blending with PANI to form the film.

### 2.1 Synthesis of Polymers

### 2.1.1 Synthesis of PANI

Polyaniline (PANI) was synthesised according to the method described in Chapman et al., 2008.

Chapman, P.; Loh, X. X.; Livingston, A. G.; Li, K.; Oliveira, T. A. C., Polyaniline membranes for the dehydration of tetrahydrofuran by pervaporation. Journal of Membrane Science. 2008, 309, (1-2), 102-111).

Dark blue PANI powder (0.30 g) was slowly added to a stirred (280 rpm) solution of NMP (2.7 g, 90 wt %) over a period of 5 minutes at room temperature and the solution was left to stir for a further 30 minutes. After this time diaminohexane (DAH) (20 μL) was added and the viscous solution stirred for a further 15 minutes at room temperature.

### 2.1.2 Synthesis of Polyvinylbenzyl Chloride (PVBC)

PVBC was produced by the method described in section 11.1.3 above.

(i) Functionalisation of PVBC with Molecular Brushes

PVBC was functionalised according to the method described in Vengatesan et al., 2015.

Vengatesan, S.; Santhi, S.; Sozhan, G.; Ravichandran, S.; Davidson, D. J.; Vasudevan, S., Novel cross-linked anion exchange membrane based on hexaminium functionalized poly(vinylbenzyl chloride). RSV Adv. 2015, 5, 27365-27371.

PVBC polymer, solid PVBC (0.40 g, GPC, MW=367,300 Da, Mn=246,300 Da, PDI=1.49) was dissolved in NMP (4.0 mL) and the solution stirred for 30 minutes at room temperature. This produced a colourless viscous solution (shear rate=0.155 Pa s). N,N-dimethylhexadecylamine (0.20 mL) was mixed with methanol (1.00 mL) and 0.90 mL of this solution was added to 1.0 mL of the PVBC polymer solution and stirred (300 rpm) at 60° C. for 3 hours to produce a colourless homogenous mixture.

Quaternization of the —CH₂Cl groups was monitored by observing reduction of the C—Cl stretching band in the IR spectrum and 849 cm⁻¹.

### 2.1.3 Preparation of Polymer Blend

The PANI solution (0.3 mL) and pre-functionalised PVBC solution (0.7 mL) were combined with stirring (300 rpm) for 1 hour at 70° C. to synthesise a polymer blend of PANI and functionalised PVBC in a ca 30:70 by weight ratio. The blend was in the form of a viscous solution.

### 2.2 Preparation of Catalytic Film

### 2.2.1 Casting and Curing Film

The polymer blend solution was cast as a thin film (120 μm thick) on to a polypropylene backing sheet (15 cm by 15 cm), using an Elcometer 4340 thin film applicator incorporating a 4340 doctor blade at a casting speed of 5.3 mm s⁻¹.

The film and backing was immediately placed in an oven and heated at 85° C. for 18 hours. During this time the film changed in colour from dark blue to green. The casting and curing process was repeated a second time to give a solid phase film (SF) of nominal thickness 240 μm.

### (i) Conductivity of Polymer Blend

The conductivity of the polymer blend was measured using a Jandel Multi Height Microposition Four-Point Probe with RM300 Test unit. The conductivity measured was 0.00504 S/cm.

### (ii) Flow Rate Through SF

The rate at which water flows through the SF was measured with the film clamped in a U-tube apparatus. A circular disk (35 mm diameter) was preconditioned in deionised water one day and then used for the permeability tests.

The perfusion rate for the undoped polymer blend was 0.01 mL/min if the hydrostatic head was 5 cm. The film was then deliberately doped by soaking in 5M HCl solution for 5 minutes. The resulting perfusion rate then became faster at 1.6 mL/min. This indicates the permeability of the film is pH dependent and may be controllable by changing the pH.

### 2.2.2 Addition of Oxidation Catalysts to the SF to Produce the Solid Phase Catalytic Film (SCF)

The solid phase film was treated with the catalyst FeB* (described in section (I) 6.1 above) to immobilise the catalyst on the polymer film to form a solid phase catalytic film (SCF).

A sample of the dry, cast and functionalised SF (a circle of diameter 35 mm) was immersed in a buffer solution (20 mL, 0.010M carbonate buffer, pH 9.5) containing FeB* (50 μM, 1.0 μmole FeB*) for 18 hours to from the SCF. The SCF was removed, washed with deionised water and immersed in 20 mL 0.01M carbonate/bicarbonate buffer solution (pH 9.5) for 30 minutes (repeated three times).

The amount of FeB* remaining in the original solution of FeB* after removal of the film, and the amount of FeB* leached from the film on each subsequent immersion in the buffer solutions was measured. No measurable amount of FeB* (<ca 0.1 nM FeB* in the 20 mL leaching buffer solution) leached into the fourth buffer solution.

The total amount of FeB* that either did not adsorb on to the film or subsequently leached from the film upon standing in the buffer solutions was 0.163 μmole. A total of 0.837 μmole of Fe—B* (83.7%) remained adsorbed on the membrane film.

### 2.3 Oxidation of Substrates Using SCF

Oxidation reactions were carried out in a beaker containing an SCF of 111.2.2.2 immersed in a solution, according to the method described in section 11.2.1 above.

The oxidative bleaching of orange II was carried out according to the general procedure described above in section 11.2.1.1 above. The solution volume was 20 mL, buffer was carbonate/bicarbonate (0.01M, pH 9.5), H₂O₂ concentration was 1.0 mM, orange II concentration was 50 μM, catalyst was FeB* (0.84 μmoles anchored on a circular SCF 35 mm in diameter). Mole ratios of H₂O₂:orange II:FeB* were 20:1.0:0.84.

Multiple bleaching experiments were performed as described in II.2.1.3(iii) above.

Time for complete bleaching at pH 9.5 was less than 25 minutes for the first run, increasing to about 45 minutes for the second run and over 120 minutes for the third run.

When the film was placed in deionised water for 7 days and then used again for the same bleaching experiments, complete oxidation of Orange (II) occurred in about 20 minutes on the first run, increasing to about 45 minutes on the second run.

### IV. Preparation of a Catalytic Film Comprising a Copolymer and Use of the Film for the Oxidation of Substrates

### 1. Synthesis of PVBC/Polystyrene Copolymer

PVBC/polystyrene co-polymer was prepared according to Method B described in section 1.1.2 above.

### 2. Preparation of Catalytic Film

### 2.1 Casting and Curing Film

The copolymer (0.70 g) was dissolved in NMP (5 mL) and stirred for at least 4 hours. The viscous solution was cast as a thin film (150 μm thick) on to a polypropylene backing sheet (15 cm by 15 cm) using an Elcometer 4340 thin film applicator incorporating a 4340 doctor blade at a casting speed of 5.3 mm s⁻¹. The cast film and backing were immediately immersed in a bath containing n-hexane (200 mL) at ambient temperature and left to stand for 30 min before being removed, briefly air dried and transferred into a bath containing deionized water (200 mL) where it was left to stand for another 30 min.

The film was removed and cured in an oven at 85° C. for 5 hours. The casting, immersion and curing process was repeated once more to this same sample to form a film with total nominal thickness of 300 μm.

### 2.2 Functionalisation, Crosslinking and Capping Unreacted Groups on the Polymer

The film prepared according to 1.2.1 above was functionalised, cross-linked and end-capped using the procedures described in 111.1.2.2, 111.1.2.3 and 111.1.2.4. respectively.

### 2.3 Addition of Oxidation Catalysts to the SF to Produce the Solid Phase Catalytic Film (SCF)

The catalyst FeB* (described in section 1.6.1 above) was adsorbed on to the polymer film according to the method described in section 111.1.2.5 above.

The amount of FeB* remaining in the original solution of FeB* after removal of the film, and the amount of FeB* leached from the film on each of three subsequent immersions in the buffer solutions was measured to be 0.11 μmole FeB* (11%).

No measurable amount of FeB* (<ca 0.1 nM FeB* in leaching buffer solution) leached into the fourth buffer solution.

### 3. Oxidation of Substrate Using SCF

An oxidation reaction was carried out in a beaker containing an SCF as described in 1.2.3 above, according to the method described in section 11.2.1 above.

The oxidative bleaching of orange II was carried out according to the general procedure described above in section 11.2.1.1 above.

The solution volume was 20 mL, buffer was carbonate/bicarbonate (0.01M, pH 9.5), H₂O₂ concentration was 1.0 mM, orange II concentration was 50 μM, catalyst was FeB* (10 μmoles anchored on a circular SCF 35 mm in diameter). Mole ratios of H₂O₂:orange II:FeB* were 20:1.0:10.

Multiple bleaching experiments were performed as described in section II.2.1.3(iii) above.

Time for complete bleaching at pH 9.5 was about 7 minutes for the first few runs, increasing to about 10 minutes after 10 consecutive runs.

### (i) Bleaching by Leached Catalyst

To demonstrate that the catalytic bleaching was carried out by the SCF, and not by catalyst leached into the solution from the SCF, oxidative bleaching runs were carried out in which the SCF was removed from solution at time four minutes during the 11^{th} bleaching run and then returned to the solution at time 14 minutes.

Bleaching was determined as described in section II.2.1.3(vii) above. The plot for absorbance when the SCF was removed from the solution was substantially horizontal, indicating that no bleaching took place. This result demonstrates that only catalyst on the film catalysed the bleaching reaction.

### V. Catalyst Displaced from Functionalised Catalytic Film by Adsorption of Negatively Charged Dye Orange (II)

FeB* (100.0 μmole) was adsorbed onto a functionalised film circular disc 35 mm diameter prepared according to the method described in section 11.1.3. The film was immersed for 2 hours in a solution of orange (II) (20 mL, 50.0 μM, 1.0 μmole of dye) in buffer solution (pH 9.5, carbonate buffer, 0.01M). The film was removed and hydrogen peroxide added to an aliquot of the dye solution to make the H₂O₂ concentration 1.0 mM.

Based on the rate of bleaching of orange (II) determined by plotting absorbance over time, the concentration of FeB* leached into the 20 mL of dye solution was 0.155 μM and so the amount of catalyst displaced from the film by the dye and buffer was 3.1 nmoles (i.e. 0.003%).

### VI. Catalytic Properties of Films with Different Molecular Brushes

### 1. Preparation of Catalytic Films

### 1.1 Preparation of Solid Phase Films

PVBC solid phase films were cast, cured, functionalised and end-capped as described in section 11.1.3 above except that in place of the amine N(CH₃)₂(C₁₆H₃₃), equivalent amounts of the amines N(CH₃)₂(C₁₄H₂₉), N(CH₃)₂(C₈H₁₇) or N(C₂H₅)₃ were used.

### 1.2 Preparation and Characterisation of Solid Phase Catalytic Films (SCFs)

1.2.1 Films Functionalised with N,N-dimethyltetradecylamine to Provide —N(CH₃)₂(C₁₄H₂₉)⁺ Brushes

The solid phase PVBC film (circular disc 35 mm diameter) was immersed in 20 mL of solution containing 1.0 μmole FeB* catalyst (pH 9.5 carbonate buffer, 0.01M). 0.12 μmole of catalyst (12%) was either not adsorbed or was leached during five consecutive immersions in the buffer solution. Only on the fifth immersion was the amount of leached FeB* not measurable (<0.01 nmole in 20 mL).

### (i) Oxidation of Orange (II)

Oxidation reactions were carried out in a beaker containing the N,N-dimethytetradecylamine functionalised film (circular disc 35 mm diameter) containing 0.88 μmole of FeB* catalyst according to the method described in section 11.2.1 above.

The oxidative bleaching of orange II was carried out according to the general procedure described above in section 11.2.1.1 above.

Total solution volume was 20 mL comprising carbonate/bicarbonate buffer (pH 9.5, 0.01M); H₂O₂ concentration 1 mM (20 μmole); and Orange (II) concentration 50 μM (1.0 μmole).

Time for bleaching to absorbance of about 0.1 was about 8 minutes for the first run, slowly increasing to about 10 minutes after 5 consecutive runs.

During the 6th bleaching run essentially no discernible amount of bleaching continued when the film was removed from the solution at time 4 minutes, consistent with essentially no FeB* being displaced from the film during the bleaching run.

After exposing this catalytic film to hydrogen peroxide solution alone (1.0 mM, pH 10.5) for one hour, the time for a subsequent bleaching run under the same conditions increased to 14 minutes, indicating that some catalyst was decomposed by exposure to hydrogen peroxide alone.

1.2.2 Films Functionalised with N,N-dimethyloctylamine to Provide —N(CH₃)₂(C₈H₁₇)⁺ Brushes

### (i) FeB* Catalyst

### Addition of Catalyst to Solid Phase Film

The solid phase PVBC film (circular disc 35 mm diameter) was immersed in 20 mL of solution containing 10 μmole FeB* catalyst (pH 9.5 carbonate buffer, 0.01M). 0.32 μmole of catalyst (3.2%) was either not adsorbed or was leached during five consecutive immersions in the buffer solution. Only on the fifth immersion was the amount of leached FeB* not measurable (<0.01 nmole in 20 mL).

### Oxidation of Orange (II)

Oxidation reactions were carried out in a beaker containing the N,N-dimethyloctylamine functionalised film (circular disc 35 mm diameter) containing 0.97 μmole of FeB* catalyst according to the method described in section 11.2.1 above.

The oxidative bleaching of orange II was carried out according to the general procedure described above in section 11.2.1.1 above.

Total solution volume was 20 mL comprising carbonate/bicarbonate buffer (pH 10.5, 0.01M); H₂O₂ concentration 1 mM (20 μmole); and Orange (II) concentration 50 μM (1.0 μmole).

Time for complete bleaching was about 8 minutes for the first run, slowly increasing to about 10 minutes after 5 consecutive runs.

During the 6th bleaching run a very small but just discernible amount of bleaching continued when the film was removed from the solution at time 4 minutes, consistent with a very small amount of FeB* being displaced from the film during the bleaching run.

After exposing this catalytic film to hydrogen peroxide solution alone (1.0 mM, pH 10.5) for one hour, the time for a subsequent bleaching run under the same conditions increased to 12 minutes, indicating that some catalyst was decomposed by exposure to hydrogen peroxide alone.

### (ii) Tungstosilicic Acid Catalyst

### Addition of Catalyst to Solid Phase Film

The solid phase PVBC film (circular disc 35 mm diameter) was immersed in 20 mL of solution containing 10 μmole tungstosilicic acid catalyst (pH 9.5 carbonate buffer, 0.01M). 0.36 μmole of catalyst (3.6%) was either not adsorbed or was leached during four consecutive immersions in the buffer solution. On the fourth immersion, the amount of leached tungstosilicic acid was not measurable.

### Oxidation of Orange (II)

Oxidation reactions were carried out in a beaker containing the N,N-dimethyloctylamine functionalised film (circular disc 35 mm diameter) containing 9.64 μmole of tungstosilicic acid catalyst according to the method described in section 11.2.1 above.

The oxidative bleaching of orange II was carried out according to the general procedure described above in section 11.2.1.1 above.

Total solution volume was 20 mL comprising carbonate/bicarbonate buffer (pH 10.5, 0.01M); H₂O₂ concentration 10 mM (200 μmole); and Orange (II) concentration 50 μM (1.0 μmole).

Time for essentially complete bleaching was about 35 minutes for the first run, increasing to about 40 minutes after 5 consecutive runs.

During the 6th bleaching run no discernible amount of bleaching continued when the film was removed from the solution at time 4 minutes, consistent with essentially no catalyst being displaced from the film during the bleaching run.

After the sixth run, the catalytic film was exposed to hydrogen peroxide solution alone (1.0 mM, pH 10.5) for one hour. The time for a subsequent bleaching run under the same conditions increased to 55 minutes, indicating that some catalyst was decomposed by exposure to hydrogen peroxide alone.

1.2.3 Films Functionalised with Triethylamine to Provide —N(C₂H₅)₃⁺ Brushes

### (i) FeB* Catalyst

### Addition of Catalyst to Solid Phase Film

The solid phase PVBC film (circular disc 35 mm diameter) was immersed in 20 mL of solution containing 10 μmole FeB* catalyst (pH 9.5 carbonate buffer, 0.01M). 0.29 μmole of catalyst (2.9%) was either not adsorbed or was leached during four consecutive immersions in the buffer solution. Only on the fifth immersion was the amount of leached FeB* not measurable (<0.01 nmole in 20 mL).

By way of comparison, a PVBC film with —N(CH₃)₂(C₁₆H₃₃)⁺ brushes was immersed in the same catalyst solution. 0.31 μmole of catalyst (3.1%) was either not adsorbed or was leached during four consecutive immersions in the buffer solution. On the fifth immersion the amount of leached FeB* was not measurable.

### Oxidation of Orange (II)

Oxidation reactions were carried out in a beaker containing the trimethylamine functionalised film (circular disc 35 mm diameter) containing 9.72 μmole of FeB* catalyst according to the method described in section 11.2.1 above.

The oxidative bleaching of orange II was carried out according to the general procedure described above in section 11.2.1.1 above.

Total solution volume was 20 mL comprising carbonate/bicarbonate buffer (pH 10.5, 0.01M); H₂O₂ concentration 1 mM (20 μmole); and Orange (II) concentration 50 μM (1.0 μmole).

Time for complete bleaching was about 4 minutes for each of 5 consecutive runs. A very small but discernable amount of bleaching continued when the film was removed from the solution consistent with a very small amount of FeB* being displaced from the film during the bleaching runs.

After exposing this catalytic film to hydrogen peroxide solution alone (1.0 mM) for one hour, the time for a subsequent bleaching run under the same conditions increased to 5 minutes, indicating that some catalyst was decomposed by exposure to hydrogen peroxide alone.

### (ii) Tungstosilicic Acid Catalyst.

### Addition of Catalyst to Solid Phase Film

The solid phase PVBC film (circular disc 35 mm diameter) was immersed in 20 mL of solution containing 10 μmole tungstosilicic acid catalyst (pH 9.5 carbonate buffer, 0.01M). 1.16 μmole of catalyst (11.6%) was either not adsorbed or was leached during four consecutive immersions in the buffer solution. On the fourth immersion, the amount of leached tungstosilicic acid was not measurable.

By way of comparison, a PVBC film with —N(CH₃)₂(C₁₆H₃₃) brushes was immersed in the same catalyst solution. 1.28 μmole of catalyst (12.8%) was either not adsorbed or was leached during four consecutive immersions in the buffer solution. On the fifth immersion the amount of leached FeB* was not measurable.

### Oxidation of Orange (II)

Oxidation reactions were carried out in a beaker containing trimethylamine functionalised film (circular disc 35 mm diameter) containing 9.64 μmole of tungstosilicic acid catalyst according to the method described in section 11.2.1 above.

The oxidative bleaching of orange II was carried out according to the general procedure described above in section 11.2.1.1 above.

Total solution volume was 20 mL comprising carbonate/bicarbonate buffer (pH 10.5, 0.01M); H₂O₂ concentration 10 mM (200 μmole); and Orange (II) concentration 50 μM (1.0 μmole).

Time for bleaching to an absorbance of 0.2 (from initial value of 1.0) was about 45 minutes for the first run, increasing to about 60 minutes after 4 consecutive runs.

### VII. Preparation of a Catalytic Film Comprising Functionalised Silica Gel and Use of the Film for the Oxidation of Substrates

### 1. Synthesis of Silica Gel Surface Modified by Long Alkyl Chain Quaternary Ammonium Groups.

### 1.1 Preparation of Modified Silica Gel (MSG)

Davisil® chromatographic silica media LC60A 40-63 micron (5.0 g) was washed with conc. HCl/H₂O (1:1, 50 mL) for one hour, collected by filtration, washed with deionized water until the filtrate was neutral, and dried in an oven at 85° C. for 24 hours.

A sample of the silica gel (1.50 g) was added to a 10% v/v aqueous solution (36 mL) of dimethyloctadecyl[3-(trimethoxysilylpropyl)]ammonium chloride (42 wt % in methanol, Sigma Aldrich), and stirred at 75° C. for 2 hours. The resulting modified silca gel (MSG) was collected by filtration, washed with water (ca 80 mL) and Acetone AR (ca 80 mL), and dried in an oven at 85° C. for 24 hours.

An elemental analysis of the MSG showed that it comprised 21.5% C, 4.17% H, and 1.0% N.

### 1.2 Addition of Catalyst to MSG

To adsorb FeB* onto the MSG, a sample of MSG (0.12 g) was stirred in 0.01M carbonate buffer (20 mL, pH 9.5) for 1 hour, then FeB* (6 μmole) was added to the solution and the stirring continued for another 2 hours. The MSG with adsorbed FeB* was then collected by filtration and washed with water. By monitoring the amount of FeB* not adsorbed initially or subsequently leached on washing, the amount of FeB* anchored onto the sample of MSG was determined to be 5.86 μmole.

### 2. Preparation of Catalytic Film Comprising MSG

PVBC produced as described in section 11.1.3 above (0.60 g) was fully dissolved in NMP (3.6 mL), and MSG containing FeB* (0.12 g) as described above was added to the viscous polymer solution.

The resulting PVBC-MSG(FeB*) mixture was cast with a nominal thickness of 120 μm onto standard polypropylene backing material using an Elcometer 4340 thin film applicator with a casting speed of 5.3 mm s⁻¹. The PVBC/MSG(FeB*) film and backing were immersed in n-hexane for 1 hour. The film and backing was removed, air dried and cured in an oven at 85° C. for 5 hours. The casting and curing steps were repeated once more to make a film with nominal thickness of 240 μm.

2.1 Leaching of Catalyst from Film

A circular disc (35 mm diameter) of the film was immersed in carbonate buffer solution (20 mL, pH 9.5, 0.01M) for one hour. This was repeated 9 times. The total amount of FeB* leached during this procedure was about 5 nmoles.

### 3. Oxidation of Orange (II)

Oxidation reactions were carried out in a beaker containing the PVBC/MSG(FeB*) film (circular disc 35 mm diameter, comprising 19.5 mg PVBC and 4.0 mg MSG(FeB*) with 0.19 μmole FeB* adsorbed on the polypropylene backing) according to the method described in section 11.2.1 above.

The oxidative bleaching of orange II was carried out according to the general procedure described above in section 11.2.1.1 above.

Total solution volume was 20 mL comprising carbonate buffer (pH 10.5, 0.01M); H₂O₂ concentration 1 mM (10 μmole); and Orange (II) concentration 50 μM (1.0 μmole).

Time for complete bleaching was about 60 minutes.

### VIII. Characterisation of Catalyst Loading on Polymer Films

The amount of ammonium molybdate tetrahydrate adsorbed on to a solid phase film prepared as described above in section 11.1.3 was determined by measuring the rate of oxidation of an ammonium molybdate solution after adsorption and comparing this with a calibration curve of oxidation ate vs ammonium molybdate concentration. The amount of ammonium molybdate tetrahydrate adsorbed on to the solid phase film was 6.22 μmoles per cm².

On immersing a 4×4 cm film in 20 mL of ammonium molybdate tetrahydrate solution (0.10 mM) and then sitting in 20 mL buffer solution for 1 hour three separate times, the total amount of ammonium molybdate tetrahydrate that was not absorbed or leached out was 0.49 μmole (0.49%).

The amount of tungstosilicic acid hydrate adsorbed on to a solid phase film was determined by measuring the rate of oxidation of an tungstosilicic acid hydrate solution after adsorption and comparing this with a calibration curve of oxidation ate vs tungstosilicic acid hydrate concentration. The amount of tungstosilicic acid hydrate adsorbed on to the solid phase film was 6.20 μmoles per cm².

On immersing a 4×4 cm film in 20 mL of tungstosilicic acid hydrate solution (0.10 mM) and then sitting in 20 mL buffer solution for 1 hour three separate times, the total amount of tungstosilicic acid hydrate that was not absorbed or leached out was 0.79 μmole (0.79%).

The following numbered paragraphs relate to aspects and embodiments of the invention:
1. A method of oxidising a substrate, the method comprising:
   (i) providing a substrate to be oxidised,
   (ii) providing an oxidant, and
   (iii) providing a solid phase comprising a plurality of pendant groups having affinity for the substrate, and an oxidation catalyst, and
   (iv) contacting the substrate to be oxidised, the oxidant, and the solid phase to oxidize the substrate.
2. The method of paragraph 1, wherein the solid phase is a film, membrane, plurality of particles, or body.
3. The method of paragraph 1 or 2, wherein the solid phase is a membrane permeable to the oxidant.
4. The method of paragraph 2 or 3, wherein the membrane separates a source of the oxidant from the substrate to be oxidised.
5. The method of any preceding paragraph, wherein one or more of the pendant groups define a first zone or zones adjacent a surface of the solid phase for concentrating the substrate, wherein the first zone or zones comprise at least a portion of the one or more pendant groups.
6. The method of any preceding paragraph, wherein the catalyst is immobilised on a pendant group.
7. The method of any one of paragraphs 1 to 5, wherein the catalyst is immobilised on surface of the solid phase.
8. The method of any preceding paragraph, wherein the pendant groups are covalently attached to the solid phase.
9. The method of any preceding paragraph, wherein the pendant groups are attached to particles on or in the solid phase.
10. The method of paragraph 9, wherein the particles comprise an inorganic material.
11. The method of paragraph 10, wherein the particles comprise titania, silica or alumina.
12. The method of any preceding paragraph, wherein a surface of the solid phase or the pendant groups comprises one or more functional groups capable of immobilizing the catalyst.
13. The method of paragraph 12, wherein the one or more functional groups define a second zone or zones adjacent a surface of the solid phase for immobilizing the catalyst.
14. The method of paragraph 13, wherein the second zone or zones are disposed between a surface of the solid phase and the first zone.
15. The method of paragraph 13 or 14, wherein the second zone is less hydrophilic than the first zone.
16. The method of any preceding paragraph, wherein the pendant groups are attached to the solid phase or to particles on or in the solid phase via one or more functional groups capable of immobilizing the catalyst.
17. The method of any preceding paragraph, wherein the catalyst comprises a metal or metal ion.
18. The method of any preceding paragraph, wherein the catalyst comprises a macromolecular metal complex, a metal oxide, a metal chalcogenide or a metal pnictogenide.
19. The method of paragraph 18, wherein the complex is an iron-tetraamido macrocyclic ligand (TAML) complex.
20. The method of paragraph 18, wherein the metal oxide is molybdate, tungstate, or a polyoxometalate (POM).
21. The method of any preceding paragraph, wherein the catalyst is immobilised by supramolecular bonding interactions.
22. The method of any one of paragraphs 12 to 21, wherein the functional group capable of immobilizing the catalyst is a non-polar, polar or ionic group.
23. The method of paragraph 22, wherein the functional group is a cationic group and the catalyst is anionic or the functional group is anionic and the catalyst is cationic.
24. The method of paragraph 22 or 23, wherein the functional group is a polar or ionic group comprising at least one oxygen, nitrogen, sulfur, phosphorus, boron, or halogen atom.
25. The method of any preceding paragraph, wherein the pendant group comprises a substituted or unsubstituted linear chain of covalently linked atoms selected from the group consisting of hydrogen, boron, carbon, nitrogen, oxygen, halogen, silicon, phosphorus, and sulfur that comprises one or more carbon atoms and optionally one or more boron, nitrogen, oxygen, halogen, silicon, phosphorous, or sulfur atoms or any combination of any two or more thereof.
26. The method of any preceding paragraph, wherein the pendant groups are a polymer or molecular brush.
27. The method of any preceding paragraph, wherein the pendant groups comprise a hydrophobic tail group and hydrophilic head group.
28. The method of any preceding paragraph, wherein the substrate is an oxidisable organic compound.
29. The method of any preceding paragraph, wherein the substrate is provided in a composition comprising one or more additional substrates to be oxidised.
30. The method of paragraph 29, wherein the pendant groups have a greater affinity for one or more substrates than for one or more other substrates in the composition.
31. The method of any preceding paragraph, wherein the solid phase comprises a plurality of two or more different pendant groups.
32. The method of any preceding paragraph, wherein the oxidant is hydrogen peroxide or a conjugate base thereof.
33. The method of any preceding paragraph, wherein the substrate is provided as a solution and/or the oxidant is provided as a solution.
34. The method of paragraph 33, wherein the solution is an aqueous solution.
35. The method of any preceding paragraph, wherein the method is for oxidising one or more oxidisable organic pollutants in water.
36. The method of any one of paragraphs 1 to 19 or 21 to 35, wherein the pendant groups are hydrophobic, the oxidant is hydrogen peroxide, and the catalyst is an iron-tetraamido macrocyclic ligand (TAML) complex.
37. The method of any preceding paragraph, wherein the solid phase is a film or membrane attached to a support.
38. A solid phase comprising a plurality of pendant groups having affinity for a substrate to be oxidised, and an oxidation catalyst.
39. A membrane comprising a plurality of pendant groups having affinity for a substrate to be oxidised, and an oxidation catalyst.
40. Use of a solid phase comprising a plurality of pendant groups having affinity for a substrate to be oxidised, and an oxidation catalyst, or a membrane comprising comprising a plurality of pendant groups having affinity for a substrate to be oxidised, and an oxidation catalyst for oxidising the substrate.
41. A composition comprising an oxidised substrate produced by a method of any one of paragraphs 1 to 36.
42. A method for preparing a solid phase comprising a plurality of pendant groups having affinity for a substrate to be oxidised, and an oxidation catalyst, the method comprising:
   (i) providing a solid phase comprising a plurality of pendant groups having affinity for the substrate, and
   (ii) immobilizing a catalyst on the solid phase.
43. A system for oxidizing a substrate, the system comprising:
   (i) a source of a substrate to be oxidised,
   (ii) a source of an oxidant, and
   (iii) a solid phase comprising a plurality of pendant groups having affinity for the substrate, and an oxidation catalyst.

Although the invention has been described by way of example and with reference to particular embodiments, it is to be understood that modifications and/or variations may be made without departing from the scope of the invention.

1. A method of oxidising a substrate, the method comprising:
(i) providing a substrate to be oxidised,
(ii) providing an oxidant, and
(iii) providing a solid phase comprising a plurality of pendant groups having affinity for the substrate, and an oxidation catalyst, wherein the solid phase is a film or membrane, and
(iv) contacting the substrate to be oxidised, the oxidant, and the solid phase to oxidize the substrate.

2. The method of claim 1, wherein the solid phase is a membrane permeable to the oxidant.

3. The method of claim 1 or 2, wherein the membrane separates a source of the oxidant from the substrate to be oxidised.

4. The method of any preceding claim, wherein one or more of the pendant groups define a first zone or zones adjacent a surface of the solid phase for concentrating the substrate, wherein the first zone or zones comprise at least a portion of the one or more pendant groups.

5. The method of any preceding claim, wherein the catalyst is immobilised on a pendant group.

6. The method of any one of claims 1 to 4, wherein the catalyst is immobilised on a surface of the solid phase.

7. The method of any preceding claim, wherein the pendant groups are covalently attached to the solid phase.

8. The method of any preceding claim, wherein the pendant groups are attached to particles on or in the solid phase.

9. The method of claim 8, wherein the particles comprise an inorganic material.

10. The method of claim 9, wherein the particles comprise titania, silica or alumina.

11. The method of any preceding claim, wherein a surface of the solid phase or a pendant group comprises one or more functional groups capable of immobilizing the catalyst.

12. The method of claim 11, wherein the one or more functional groups define a second zone or zones adjacent a surface of the solid phase for immobilizing the catalyst.

13. The method of claim 12, wherein the second zone or zones are disposed between a surface of the solid phase and the first zone.

14. The method of claim 12 or 13, wherein the second zone or zones is less hydrophilic than the first zone.

15. The method of any preceding claim, wherein the pendant groups are attached to the solid phase or to particles on or in the solid phase via one or more functional groups capable of immobilizing the catalyst.

16. The method of any preceding claim, wherein the catalyst comprises a metal or metal ion.

17. The method of any preceding claim, wherein the catalyst comprises a macromolecular metal complex, a metal oxide or mixed metal oxide, a metal chalcogenide or mixed metal chalcogenide, or a metal pnictogenide or mixed metal chalcogenide.

18. The method of claim 17, wherein the complex is an iron-tetraamido macrocyclic ligand (TAML) complex.

19. The method of claim 17, wherein the metal oxide or mixed metal oxide is an oxometalate or a polyoxometalate (POM).

20. The method of claim 17, wherein the metal oxide or mixed metal oxide is molybdate, tungstate, vanadate, or a polyoxometalate.

21. The method of claim 17, wherein the metal oxide or mixed metal oxide is molybdate, tungstate, or a polyoxometalate.

22. The method of claim 17, wherein the polyoxometalate is tungstosilicic acid.

23. The method of any preceding claim, wherein the catalyst is immobilised by supramolecular bonding interactions.

24. The method of any one of claims 11 to 23, wherein the functional group capable of immobilizing the catalyst is a non-polar, polar or ionic group.

25. The method of any one of claims 11 to 24, wherein the functional group is a polar or ionic group selected from a quaternary ammonium, phosphate, sulfonate, tetraorganophosphonium ion, or carboxy group.

26. The method of any one of claims 11 to 25, wherein the functional group is a cationic group.

27. The method of any one of claims 11 to 26, wherein the functional group is a quaternary ammonium or tetraorganophosphonium group.

28. The method of any one of claims 11 to 27, wherein the functional group is a quaternary ammonium group.

29. The method of any one of claims 11 to 28, wherein the functional group is a cationic group and the catalyst is anionic or the functional group is anionic and the catalyst is cationic.

30. The method of any preceding claim, wherein the pendant group comprises a substituted or unsubstituted linear chain of covalently linked atoms selected from the group consisting of hydrogen, boron, carbon, nitrogen, oxygen, halogen, silicon, phosphorus, and sulfur that comprises one or more carbon atoms and optionally one or more boron, nitrogen, oxygen, halogen, silicon, phosphorous, or sulfur atoms or any combination of any two or more thereof.

31. The method of claim 30, wherein the linear chain comprises 2 to 150 atoms.

32. The method of any preceding claim, wherein the pendant groups are a polymer or molecular brush.

33. The method of any preceding claim, wherein the pendant groups comprise a head group and a tail group.

34. The method of claim 33, wherein the tail group is hydrophobic.

35. The method of any preceding claim, wherein the pendant groups comprise a hydrophobic tail group and hydrophilic head group.

36. The method of any one of claims 33 to 35, wherein the head group is hydrophilic and comprises one or more functional groups capable of immobilising the oxidation catalyst.

37. The method of any one of claims 33 to 36, wherein the tail group comprises a polymer.

38. The method of any one of claims 32 to 37, wherein the polymer comprises from 2 to 25 monomeric units.

39. The method of claim 33 or 38, wherein the tail group is hydrophobic and comprises a C₂-C₂₀alkyl group.

40. The method of any preceding claim, wherein the pendant groups have a molecular weight from about 0.5 to about 1 kDa.

41. The method of any preceding claim, wherein the pendant group comprises, consists essentially of, or is a quaternary ammonium or tetraorganophosphonium group comprising at least one C₂-C₂₀alkyl group.

42. The method of any preceding claim, wherein the pendant group is of the formula -Q-G-NR¹R²R³⁺X⁻ or -Q-G-PR¹R²R³⁺X⁻; wherein R¹, R², and R³ are each independently alkyl, wherein at least one of R¹, R², and R³ is C₂-C₂₀alkyl; X⁻ is a suitable anion; Q is a linker group covalently attached to the solid phase or a bond, and G is C₁-C₆alkylene or a bond.

43. The method of any preceding claim, wherein the pendant groups are of the formula —NR¹R²R³⁺X⁻, wherein R¹, R², and R³ are each independently alkyl; and X⁻ is a suitable anion.

44. The method of claim 43, wherein at least one of R¹, R², and R³ is C₂-C₂₀alkyl.

45. The method of any one of claims 39, 41, 42, and 44, wherein the C₂-C₂₀alkyl group is a C₈-C₂₀alkyl group.

46. The method of any preceding claim, wherein the substrate is an oxidisable organic compound.

47. The method of any preceding claim, wherein the substrate is provided in a composition comprising one or more additional substrates to be oxidised.

48. The method of claim 47, wherein the pendant groups have a greater affinity for one or more substrates than for one or more other substrates in the composition.

49. The method of any preceding claim, wherein the solid phase comprises a plurality of two or more different pendant groups.

50. The method of any preceding claim, wherein the oxidant is hydrogen peroxide or a conjugate base thereof.

51. The method of any preceding claim, wherein the substrate is provided as a solution and/or the oxidant is provided as a solution.

52. The method of claim 51, wherein the solution is an aqueous solution.

53. The method of any preceding claim, wherein the method is for oxidising one or more oxidisable organic pollutants in water.

54. The method of any preceding claim, wherein the solid phase is a film or membrane attached to a support.

55. The method of any one of the preceding claims, wherein a composition comprising the substrate is contacted with the solid phase in a turbulent flow or state.

56. The method of any one of the preceding claims, wherein less than about 1% of the oxidation catalyst is leached from the solid phase during the oxidation reaction.

57. A membrane comprising a plurality of pendant groups having affinity for a substrate to be oxidised, and an oxidation catalyst.

58. Use of a membrane comprising comprising a plurality of pendant groups having affinity for a substrate to be oxidised, and an oxidation catalyst for oxidising the substrate.

59. A composition comprising an oxidised substrate produced by a method of any one of claims 1 to 56.

60. A method for preparing a solid phase comprising a plurality of pendant groups having affinity for a substrate to be oxidised, and an oxidation catalyst, the method comprising:
(i) providing a solid phase comprising a plurality of pendant groups having affinity for the substrate, wherein the solid phase is a film or membrane, and
(ii) immobilizing a catalyst on the solid phase.

61. A system for oxidizing a substrate, the system comprising:
(i) a source of a substrate to be oxidised,
(ii) a source of an oxidant, and
(iii) a solid phase comprising a plurality of pendant groups having affinity for the substrate, and an oxidation catalyst, wherein the solid phase is a film or membrane.
